(19) United States
(12) Patent Application Publication
(10) Pub. No.: US 2006/0132914 A1
(43) Pub. Date: Jun. 22, 2006

(54) Method and system for displaying an informative image against a background image

(76) Inventors: Victor Weiss, Rehovot (IL); Joseph Gurwich, Beer-Sheva (IL)

Correspondence Address: BROOKS KUSHMAN P.C., 1000 TOWN CENTER, TWENTY-SECOND FLOOR, SOUTHFIELD, MI, 48075, US

(21) Appl. No.: 10/560,561

(22) PCT Filed: Jun. 9, 2004
(86) PCT No.: PCT/IL04/00494

§ 371 Date: Dec. 12, 2005

(30) Foreign Application Priority Data
Jun. 10, 2003 (US) 60477699

(51) Int. Cl. G02B 27/22

(52) U.S. Cl. 359/462

(57) ABSTRACT

Incident image displaying device for displaying at least one incident image against a scene image of a scene, the incident image displaying device including at least one light guide, at least one input beam transforming element, at least one output beam transforming element and a scene image reflector, each of the input beam transforming element and the output beam transforming element being incorporated with a respective light guide, the scene image reflector being located behind the light guide, the input beam transforming element receiving incident light beams respective of the incident image from a respective one of at least one image source, the output beam transforming element being associated with a respective input beam transforming element, the scene image reflector reflecting the scene image through at least a portion of the output beam transforming element, wherein the input beam transforming element couples the incident light beams into the respective light guide as a set of coupled light beams, the set of coupled light beams is associated with the respective input beam transforming element, wherein the output beam transforming element receives from the respective light guide and decouples as decoupled light beams, the set of coupled light beams, thereby forming a set of output decoupled images, and wherein each output decoupled image of the set of output decoupled images is representative of a sensor fused image of the incident image.

### FIELD OF THE DISCLOSED TECHNIQUE

The disclosed technique relates to optical devices in general, and to methods and systems for displaying an informative image against a background image, in particular.

### BACKGROUND OF THE DISCLOSED TECHNIQUE

The use of holographic optical elements (HOE) for conveying light in a transmissive substrate is known in the art. Usually light enters an input HOE, propagates through the substrate by total internal reflection toward an output HOE and exits the substrate. The source of the light is usually a light emitting diode (LED). The emitted light is usually detected by a charge-coupled device (CCD) or a viewer.

U.S. Pat. No. 6,172,778 issued to Reinhorn et al., and entitled “Compact Optical Crossbar Switch”, is directed to a planar optical crossbar switch. The crossbar switch includes an input substrate and an output substrate. A first negative holographic cylindrical lens is recorded onto or attached to the input substrate. A first positive holographic cylindrical lens is recorded onto or attached to the input substrate, at a location distant from the first negative holographic cylindrical lens. A linear array of light emitting diodes is located above the first negative holographic cylindrical lens. The first negative holographic cylindrical lens couples the light emitted by each source of the LED array. The light is trapped in the input substrate by total internal reflection, reaches the first positive holographic cylindrical lens and couples out of the input substrate.

A second negative holographic cylindrical lens is recorded onto or attached to the output substrate. A second positive holographic cylindrical lens is recorded onto or attached to the output substrate, at a location distant from the second negative holographic cylindrical lens. The input substrate is placed on the top of the output substrate, such that the first positive holographic cylindrical lens is located on top of the second positive holographic cylindrical lens, but rotated by 90 degrees. A planar pixelated spatial light modulator (SLM) is located between the first positive holographic cylindrical lens and the second positive holographic cylindrical lens. A linear output detector array is located below the second negative holographic cylindrical lens.

The light from a particular row element of the LED array spreads out across a particular row of the SLM matrix. The second positive holographic cylindrical lens and the second negative holographic cylindrical lens converge the light from a particular column of the SLM matrix to a particular column of the linear output detector.

U.S. Pat. No. 6,185,015 issued to Reinhorn et al., and entitled “Compact Planar Optical Correlator”, is directed to a device for transmitting light through a cascaded set of optical substrates and holographic lenses. The device includes a first substrate, a second substrate, a first holographic lens, a second holographic lens, a third holographic lens, a fourth holographic lens, a filter and a two-dimensional detector.

The first holographic lens and the second holographic lens are located on the first substrate. The third holographic lens and the fourth holographic lens are located on the second substrate. The filter is located between the second holographic lens and the third holographic lens. The two-dimensional detector is located below the fourth holographic lens. The filter is a holographic filter, which deflects the light from the second holographic lens in a direction normal to the third holographic lens.

An incident monochromatic beam is inputted to the first holographic lens. The monochromatic beam propagates through the first substrate by total internal reflection and reaches the second holographic lens. The filter transmits the monochromatic beam from the second holographic lens to the third holographic lens. The monochromatic beam propagates through the second substrate by total internal reflection and reaches the fourth holographic lens. The monochromatic beam couples out of the second substrate and into the two-dimensional detector.

U.S. Pat. No. 5,966,223 issued to Friesem et al., and entitled “Planar Holographic Optical Device” is directed to a wavelength division demultiplexing system. The system includes a light transmissive substrate having an emulsion coating thereon. The emulsion coating links between a source fiber and a receiving fiber. A first HOE and a second HOE are recorded on the emulsion coating. The first HOE is identical with the second HOE. The first HOE collimates the light emerging from a source fiber into a plane wave. The plane wave is then trapped inside the substrate by total internal reflection. The second HOE focuses the collimated wave onto a receiving fiber.

The system can include a central HOE and a plurality of receiving holographic optical elements. The central HOE receives light from a source fiber containing a plurality of different communication channels. The central HOE focuses each communication channel to a respective HOE and each receiving HOE directs the respective communication channel to the respective receiving fiber.

The system is utilized for providing a holographic three-dimensional display. The display device includes a source hologram and a display hologram. The display hologram couples the image wave of the source hologram to the exterior of the system, so as to form a virtual image of a three-dimensional object. Parts of the surfaces of the substrate are covered with opaque layers, in order to avoid extraneous light of the zero order or from undesired reflection, to reach the system.

Further disclosed is a holographic beam expander. The beam expander includes a first holographic lens and a second holographic lens located on a light-submissive substrate. The first holographic lens diffracts a normally impinging light beam, having a first radius, to an off-axis spherical wave. The diffracted light propagates toward the second holographic lens, to obtain an output beam having a second radius. The second lens collimates the light beam and diffracts the light outward.

Still further disclosed is a holographic doublet visor display (HDVD). The HDVD includes a holographic collimating lens and a linear grating, both of which are recorded on the same substrate. The collimating lens transforms light from a two-dimensional display into an angular spectrum of plane wavefronts, and diffracts these wavefronts inside the substrate. The substrate traps the wavefronts therein, and the linear grating diffracts the wavefronts outward, toward an observer.

PCT Publication WO 99/52002, entitled “Holographic Optical Devices”, is directed to a holographic display device. The device includes a first HOE, a second HOE and a third HOE located on a substrate. A light source illuminates the first HOE. The first HOE collimates the incident light from the light source, and diffracts the light into the substrate. The substrate traps the diffracted light therein, so that the light propagates through the substrate by total internal reflection along a first axis toward the second HOE.

The second HOE has the same lateral dimension as the first HOE along a second axis normal to the first axis. The lateral dimension of the second HOE along the first axis is substantially larger than the lateral dimension of the first HOE. The diffraction efficiency of the second HOE increases gradually along the first axis.

The second HOE diffracts the light into the substrate. The substrate traps the light therein, so that the light propagates through the substrate by total internal reflection, toward the third HOE along the second axis. The third HOE has the same lateral dimension as the second HOE along the first axis. The third HOE has the same lateral dimensions along the first and the second axes. The diffraction efficiency of the third HOE increases gradually along the second axis. The sum of the grating functions of the first, second and third axes, is zero.

U.S. Pat. No. 5,631,638, issued to Kasper et al., and entitled “Information System in a Motor Vehicle” is directed to a rear-view mirror with data display. The rear-view mirror includes a mirror frame, which holds a mirror glass. The mirror glass has two glass tops. An electrochrome substance is contained between the two glass tops. An electronic control carries voltage corresponding to the light conditions under the control of a central processor over a wire pair to the electrochrome substance, in order to make the mirror glass reflect strongly or weakly. The electrochrome substance includes composable numbers and letters.

Each composable number is made of seven segments. The front seven segment electrodes are linked via electric conductor paths to seven junctions on the edge of the mirror glass. The seven rear segment electrodes are linked to a contact point. A central processor controls a segment driver, which is linked to the contact points in order to have the desired number or letter series appear in the mirror glass.

U.S. Pat. No. 5,724,163 issued to David and entitled “Optical System for Alternative or Simultaneous Direction of Light Originating from Two Scenes to the Eye of a Viewer”, is directed to a system for viewing two scenes, alternately or simultaneously. The system includes first and second lenses, positioned beside one another in front of the eye of a viewer, and an optical arrangement.

The optical arrangement includes a holographic plate, a first input HOE, a second input HOE and an output holographic optical element. The first input HOE and the second input HOE are intended for permitting light, having passed through the respective lens, to enter the holographic plate. The output HOE is intended for permitting light to leave the holographic plate and reach the eye of the viewer.

### SUMMARY OF THE DISCLOSED TECHNIQUE

It is an object of the disclosed technique to provide a novel method and system for displaying an incident image, which overcomes the disadvantages of the prior art.

In accordance with the disclosed technique, there is thus provided an incident image displaying device for displaying at least one incident image against a scene image of a scene. The incident image displaying device includes at least one light guide, at least one input beam transforming element, at least one output beam transforming element and a scene-image reflector. Each of the input beam transforming element and the output beam transforming element is incorporated with a respective light guide. The scene-image reflector is located behind the light guide.

The input beam transforming element receives incident light beams respective of the incident image from a respective one of at least one image source. The output beam transforming element is associated with a respective input beam transforming element. The scene-image reflector reflects the scene image through at least a portion of the output beam transforming element. The input beam transforming element couples the incident light beams into the respective light guide as a set of coupled light beams.

The set of coupled light beams is associated with the respective input beam transforming element. The output beam transforming element receives from the respective light guide and decouples as decoupled light beams, the set of coupled light beams, thereby forming a set of output decoupled images. Each output decoupled image of the set of output decoupled images is representative of a sensor fused image of the incident image.

In accordance with another aspect of the disclosed technique, there is thus provided an incident image displaying device for displaying at least one incident image. The incident image displaying device includes at least one light guide, at least one input beam transforming element, at least one output beam transforming element and an opaque shield. Each of the input beam transforming element and the output beam transforming element is incorporated with a respective light guide.

The input beam transforming element receives incident light beams respective of the incident image from a respective one of at least one image source. The output beam transforming element is associated with a respective input beam transforming element. The opaque shield has a substantially dark hue and is located behind the light guide.

The input beam transforming element couples the incident light beams into the respective light guide as a set of coupled light beams. The set of coupled light beams is associated with the respective input beam transforming element. The output beam transforming element receives from the respective light guide and decouples as decoupled light beams, the set of coupled light beams, thereby forming a set of output decoupled images. Each output decoupled image of the set of output decoupled images is representative of a sensor fused image of the incident image.

In accordance with a further aspect of the disclosed technique, there is thus provided an incident image displaying device for displaying at least one incident image. The incident image displaying device includes at least one light guide, at least one input beam transforming element, a plurality of output beam transforming elements and at least one intermediate beam transforming element for each of the output beam transforming elements. Each of the input beam transforming element and the output beam transforming elements, is incorporated with a respective light guide.

The input beam transforming element receives incident light beams respective of at least one incident image from a respective one of at least one image source. The intermediate beam transforming element is incorporated with the respective light guide, and associated with a respective input beam transforming element.

The input beam transforming element couples the incident light beams into the respective light guide as a set of coupled light beams. The set of coupled light beams is associated with the respective input beam transforming element. The intermediate beam transforming element spatially transforms the set of coupled light beams into a set of coupled light beams. Each of the output beam transforming elements receives from the respective light guide and decouples as decoupled light beams, a set of coupled light beams spatially transformed by the intermediate beam transforming element, thereby forming a set of output decoupled images. Each output decoupled image of the set of output decoupled images is representative of a sensor fused image of the incident image.

In accordance with another aspect of the disclosed technique, there is thus provided an incident image displaying device for displaying at least one incident image. The incident image displaying device includes at least one light guide, a plurality of input beam transforming elements, a plurality of intermediate beam transforming elements and an output beam transforming element. Each of the input beam transforming elements, the intermediate beam transforming elements, and the output beam transforming element is incorporated with a respective light guide.

A respective input beam transforming element receives incident light beams respective of at least one incident image from a respective one of at least one image source. One or more of the intermediate beam transforming elements are associated with one or more input beam transforming elements. The output beam transforming element is associated with the intermediate beam transforming elements.

The respective input beam transforming element couples the incident light beams into the respective light guide as a set of coupled light beams. The set of coupled light beams is associated with the respective input beam transforming element. Each of the intermediate beam transforming elements spatially transforms the set of coupled light beams into a set of coupled light beams. The output beam transforming element receives from the respective light guide and decouples as decoupled light beams, a set of coupled light beams spatially transformed by the intermediate beam transforming elements, thereby forming a set of output decoupled images. Each output decoupled image of the set of output decoupled images is representative of a sensor fused image of the incident image.

In accordance with a further aspect of the disclosed technique, there is thus provided an incident image displaying device for displaying at least one incident image against a scene image of a scene. The incident image displaying device includes at least one light guide, at least one input beam transforming element incorporated with the light guide, and at least one output beam transforming element incorporated with the light guide and associated with the input beam transforming element. The input beam transforming element receives incident light beams respective of the incident image from a respective one of at least one image source.

The input beam transforming element includes a first input beam transforming element and a second input beam transforming element. The output beam transforming element includes a first output beam transforming element and a second output beam transforming element. The first input beam transforming element and the first output beam transforming element are incorporated with a first light guide, thereby forming a first displaying module. The second input beam transforming element and the second output beam transforming element are incorporated with a second light guide, thereby forming a second displaying module.

The second input beam transforming element is located below the first input beam transforming element. The first output beam transforming element is located on one side of the first input beam transforming element and the second input beam transforming element. The second output beam transforming element is located on the other side of the first input beam transforming element and the second input beam transforming element. The first input beam transforming element transmits the incident light beams to the second input beam transforming element.

The input beam transforming element couples the incident light beams into a respective light guide as a set of coupled light beams, wherein the set of coupled light beams is associated with the input beam transforming element. The output beam transforming element receives from the respective light guide and decouples as decoupled light beams, the set of coupled light beams, thereby forming a set of output decoupled images. Each output decoupled image of the set of output decoupled images is representative of a sensor fused image of the incident images.

In accordance with another aspect of the disclosed technique, there is thus provided a method for displaying at least one incident image against a reflected scene image of a scene. The method includes the procedures of coupling a set of light beams respective of the incident image, into a respective light guide, thereby forming at least one set of coupled light beams, and decoupling a set of coupled light beams out of the respective light guide, as decoupled light beams, thereby forming a set of output decoupled images. The method further includes the procedure of reflecting a scene image of the scene, through at least a portion of the respective light guide, and at least a portion of at least one output beam transforming element. Each output decoupled image of the set of output decoupled images, is respective of a sensor fused image and a pupil expanded representation of the incident image.

In accordance with a further aspect of the disclosed technique, there is thus provided a method for displaying at least one incident image. The method includes the procedures of coupling a set of light beams respective of the incident image, into a respective one of at least one light guide, as sets of coupled light beams, and spatially transforming the sets of the coupled light beams, by a plurality of intermediate beam transforming elements. The method further includes the procedure of decoupling a set of coupled light beams out of the respective light guide, as decoupled light beams, by at least one output beam transforming element, thereby forming a set of output decoupled images. Each output decoupled image of the set of output decoupled images, is respective of a sensor fused image and a pupil expanded representation of the incident image.

### BRIEF DESCRIPTION OF THE DRAWINGS

The disclosed technique will be understood and appreciated more fully from the following detailed description taken in conjunction with the drawings in which:

FIG. 1A is a schematic illustration in perspective, of a projected-image displaying device for displaying a projected image against a reflection of a background scene, constructed and operative in accordance with an embodiment of the disclosed technique;

FIG. 1B is a schematic illustration of a top view of the device of FIG. 1A;

FIG. 2 is a schematic illustration of a system for displaying a projected image at a selected output angle, against a reflection of a background scene, constructed and operative in accordance with another embodiment of the disclosed technique;

FIG. 3 is a schematic illustration of a system for displaying a combination of two projected images, against a reflection of a background scene, constructed and operative in accordance with a further embodiment of the disclosed technique;

FIG. 4A is a schematic illustration of a system for displaying a projected image, against a reflection of a background scene, constructed and operative in accordance with another embodiment of the disclosed technique;

FIG. 4B is a schematic illustration of a detailed view of the input BTE of the system of FIG. 4A, coupling an incident light beam into the light guide of the system, in a reflective mode;

FIG. 5A is a schematic illustration of a system for displaying a projected image, against a reflection of a background scene, constructed and operative in accordance with a further embodiment of the disclosed technique;

FIG. 5B is a schematic illustration of a detailed view of the input BTE of the system of FIG. 5A, coupling an incident light beam into the light guide of the system, in a transmissive mode;

FIG. 6 is a schematic illustration of a front-coated device, for displaying a projected image against a reflection of a background scene, constructed and operative in accordance with another embodiment of the disclosed technique;

FIG. 7 is a schematic illustration of a back-coated device, for displaying a projected image against a reflection of a background scene, constructed and operative in accordance with a further embodiment of the disclosed technique;

FIG. 8A is a schematic illustration of a device, for displaying a projected image against an opaque coating, constructed and operative in accordance with another embodiment of the disclosed technique;

FIG. 8B is a schematic illustration of the light paths within the light guide, the input BTE, the left intermediate BTE, the right intermediate BTE, the left output BTE and the right output BTE of the device of FIG. 8A;

FIG. 9 is a schematic illustration of a device for displaying a projected image against a background scene, constructed and operative in accordance with a further embodiment of the disclosed technique;

FIG. 10 is a schematic illustration of a device, for displaying a superimposition of a plurality of images, constructed and operative in accordance with another embodiment of the disclosed technique;

FIG. 11 is a schematic illustration of a device, for displaying an image constructed and operative in accordance with a further embodiment of the disclosed technique;

FIG. 12 is a schematic illustration of a device, for displaying an image constructed and operative in accordance with another embodiment of the disclosed technique;

FIG. 13 is a schematic illustration of a device, constructed and operative in accordance with a further embodiment of the disclosed technique;

FIG. 14 is a schematic illustration of a device, for displaying an image constructed and operative in accordance with another embodiment of the disclosed technique;

FIG. 15 is a schematic illustration of a device, for displaying an image constructed and operative in accordance with a further embodiment of the disclosed technique;

FIG. 16 is a schematic illustration of a device, for displaying an image, constructed and operative in accordance with another embodiment of the disclosed technique;

FIG. 17A is a schematic illustration of a device, for displaying a superimposition of two images, constructed and operative in accordance with a further embodiment of the disclosed technique;

FIG. 17B is a schematic illustration of a graph of the variation of decoupled intensities of the output BTE of the device of FIG. 17A, respective of two counter-propagating light beams within the light guide of the device of FIG. 17A, along the output BTE;

FIG. 18 is a schematic illustration of a device, for displaying a superimposition of two images constructed and operative in accordance with another embodiment of the disclosed technique;

FIG. 19 is a schematic illustration of a device, for displaying a superimposition of a plurality of images, constructed and operative in accordance with a further embodiment of the disclosed technique;

FIG. 20 is a schematic illustration of a device, for displaying a superimposition of a plurality of images, constructed and operative in accordance with another embodiment of the disclosed technique;

FIG. 21 is a schematic illustration of a device, for displaying an image for two observers, constructed and operative in accordance with a further embodiment of the disclosed technique;

FIG. 22 is a schematic illustration of a device, for displaying an image for an observer whose range of movement is substantially large, constructed and operative in accordance with another embodiment of the disclosed technique;

FIG. 23A is a schematic illustration of a device, for displaying an image at an extended field of view (EFOV), constructed and operative in accordance with a further embodiment of the disclosed technique;

FIG. 23B is a schematic illustration of light beams entering and emerging out of a first displaying module of the two displaying modules of the device of FIG. 23A;

FIG. 23C is a schematic illustration of light beams entering and emerging out of a second displaying module of the two displaying modules of the device of FIG. 23A;

FIG. 24 is a schematic illustration of a displaying module, for displaying an image on a visor of a helmet, constructed and operative in accordance with another embodiment of the disclosed technique;

FIG. 25 is a schematic illustration of a displaying module, for displaying an image on a viewer of an underwater viewing device, constructed and operative in accordance with a further embodiment of the disclosed technique;

FIG. 26 is a schematic illustration of a spectacle, which includes a displaying module for displaying an image against a background scene, constructed and operative in accordance with another embodiment of the disclosed technique;

FIG. 27 is a schematic illustration of a method for operating a projected-image displaying device, operative in accordance with a further embodiment of the disclosed technique;

FIG. 28 is a schematic illustration in perspective, of a cascaded projected-image displaying device for displaying a projected image, operative in accordance with another embodiment of the disclosed technique; and

FIG. 29 is a schematic illustration in perspective, of a projected-image displaying device for displaying a projected image, operative in accordance with a further embodiment of the disclosed technique.

### DETAILED DESCRIPTION OF THE EMBODIMENTS

The disclosed technique overcomes the disadvantages of the prior art by providing a device which transforms and displays a plurality of virtual images, derived from an informative image source, against a background scene image. The eyes of an observer detect a superposition of these images, as the observer moves relative to the device. The images can be perceived from two light transforming elements located relative to the eyes, such that each eye perceives an image from the respective light transforming element, and thus the observer perceives a biocular view of the informative image, as well as of the background scene image. This biocular view is similar to a far-away view of an object by the naked eye, wherein the eyes are minimally stressed. The background scene image can be reflected toward the eyes by a reflector, through the light transforming elements.

The term “beam transforming element” (BTE) herein below, refers to an optical element which transforms an incident light beam. Such a BTE can be in form of a single prism, refraction light beam transformer, diffraction light beam transformer, and the like. A refraction light beam transformer can be in form of a prism, micro-prism array, Fresnel lens, gradient index (GRIN) lens, GRIN micro-lens array, and the like. A micro-prism array is an optical element which includes an array of small prisms on the surface thereof. Similarly, a GRIN micro-lens array is an optical element which includes an array of small areas having an index profile similar to a saw tooth thereby acting similar to a micro-prism array. The periodicity of a diffraction BTE is usually greater than that of a refraction BTE.

The term “coupling efficiency” herein below, refers to the ratio of the amount of light transmitted from a first BTE to a second BTE, to the amount of light which strikes the first BTE. The optimal coupling efficiency of a refraction beam transformer is generally greater than that of a diffraction light beam transformer. The term “throughput efficiency” herein below, refers to the ratio of the amount of light which leaves the device, to the amount of light which enters the device.

It is noted that in the description herein below, the relative and absolute values of different parameters, such as light intensity, angle, parallelism, perpendicularity, direction, location, position, geometrical shapes, size, image resolution, similarity of different parameters of images, equivalency of the values of a parameter, surface roughness, flatness, flexibility, variation of a parameter throughout a BTE (such as uniformity of non-uniformity of frequency or groove depth), colors, length, relative movement, coupling throughput, coupling efficiency, brightness, and the like, are approximate values and not precise values.

A diffraction light beam transformer can be in form of a diffraction optical element, such as hologram, kinoform, and the like, surface relief grating, volume phase grating, and the like. A surface relief grating is much finer (having a grating spacing of the order of the incident wavelength, and having periodic forms such as a saw tooth, sinusoid or slanted sinusoid) than a Fresnel lens or a micro-prism (having spacings of the order of hundreds of micrometers). A volume phase grating is a BTE constructed of a plurality of optical layers, each having a selected index of refraction, which together provide a diffraction grating effect. Thus, the surface of volume phase grating is smooth.

The term “light guide” herein below, refers to a transparent layer within which a plurality of BTEs are located. Alternatively, one or more BTEs are located on the surface of the light guide. The light guide can be made of plastic, glass, quartz crystal, and the like, for transmission of light in the visible range. The light guide can be made of infrared amorphous or crystalline materials such as, germanium, zinc-sulphide, silver-bromide, and the like, for transmission of light in the infrared range. The light guide can be made of a rigid material, as well as a flexible material.

The BTE is characterized by different parameters, such as the depth of the individual gratings, shape of the individual gratings, the frequency of the grating (herein below referred to as “spatial frequency”), the overall pattern of the grating, microgroove direction, and the like. The individual gratings can be in form of a kinoform, equilateral triangular saw tooth, right angle triangular saw tooth, truncated sine wave, square wave, and the like.

The depth of the individual gratings refers to the so called peak-to-peak amplitude of the grating. The overall pattern of the grating can be either symmetric or asymmetric (i.e., slanted, tilted or blazed grating). A symmetric pattern can for example be generated by holographic recording, by directing two coherent light beams (i.e., laser) towards the BTE, at equal incidence angles, thereby recording the resultant interference pattern. Similarly, an asymmetric pattern is generated by directing the two coherent light beams at different incidence angles.

The shape and depth of the individual grating features dictate the angular bandwidth (i.e., the field of view) and the spectral bandwidth (i.e., the wavelength range) of the image transformed by the BTE. The spatial frequency of the BTE dictates the angle of diffraction relative to the incidence angle, for which the BTE can efficiently collect the incoming light within some bandwidth.

The depth of the individual gratings dictates the diffraction efficiency and by this the transformation efficiencies, such as coupling efficiency, deflection efficiency and decoupling efficiency. At regions of the BTE in which the depth of the gratings is greater up to a certain degree, more light is either collected by the BTE, deflected or coupled out of the BTE. Thus, those regions of the BTE, which are expected to receive less light, are imparted with deeper gratings than the regions which are expected to receive more light, thereby causing the BTE to transform the light uniformly, throughout the entire area thereof. This light enters the BTE either from a light source external to the device, or from another BTE.

The microscopic pattern of the grating dictates the characteristics of the beam transform and the relative portions of light which the BTE transforms into the various directions, also termed “diffraction orders”. For example, a symmetric and thin sinusoidal surface relief BTE may direct a similar amount (e.g. about 30%) of the incoming beam power (not accounting for losses such as reflection, and the like), to each of three main directions, of one side thereof (+1 order), of the other side thereof (−1 order) and of the undeflected direction (zero order).

An asymmetric BTE directs different portions of light to the three different directions thereof. The asymmetries between the first order beams preferred for the disclosed technique would be as large as possible, and may range for surface relief gratings in the order of 2:1 to 10:1. The asymmetry in a thick volume phase grating can reach larger values such as 100:1 or even 1000:1, depending on its thickness. However, in this case the field of view respective of the BTE is restricted. Various microscopic structures of the gratings can be applied to BTEs, which influence the properties of the BTEs, as discussed herein below. For example, equilateral triangular saw tooth, truncated symmetric sine wave and square wave, impart a symmetric behavior to the BTE, whereas a right triangular saw tooth and elongated truncated sine wave (i.e., falling sine wave), impart asymmetric characteristics and operation to the BTE.

The term “microgroove direction” herein below, refers to the longitudinal direction of the microgrooves of a BTE. The microgroove direction of a first BTE relative to the microgroove direction of an adjacent second BTE, dictates the amount of rotation of the optical axis from the first BTE to the second BTE.

The BTE can be made by holographic interferometry, binary grating (i.e., preparing a binary code version of the pattern of the grating and producing the grating according to the binary code), by scanning a laser beam, an electron beam, or by lithography (through a mask), multilevel lithography, and the like.

The replication of the BTEs can be made by electroless plating (i.e., removing material from an electrically conductive material by applying an electric potential across the material), compression molding (where the plastic material is introduced into a molding machine in the form of pellets or sheet and pressed between two movable platens), injection molding (where molten resin is forced into a mold), injection-compression molding or coining (where molten resin is injection molded in a temperature controlled and loosely clamped mold, and at the curing stage the mold is fully closed while controlling the temperature), hot embossing, diamond turning, laser ablation, reaction ion etching (where the surface is coated by forming an ion plasma on the surface), and the like.

The above replication methods are well established for single element BTEs, but may cause severe surface property degradation for light-guided applications, where a number of BTEs are integrated on the same substrate surface, as in the present disclosure. The BTEs are replicated according to a novel replication technique, referred to as “soft nanolithography”. To replicate BTEs by soft nanolithography, a curable polymer material is cast onto a master BTE assembly, so as to serve the tool for producing the replica BTE assembly. The tool carries a negative shape of the master BTE assembly. The replica are then formed by casting another curable polymer onto the tool, so as to form the positive replica at high surface flatness and microscopic BTE structure fidelity. The polymerization may be induced by thermal curing or photopolymerization (i.e., polymerizing a material by directing light at a selected wavelength and energy).

The terms “light coupling” and “light-coupled” herein below, refer to input of light by a BTE, into the light guide to be trapped by either total internal reflection (TIR) or partial internal reflection (PIR). The latter PIR may be achieved by adding a reflection coating. Thus, the input BTE coupler converts the incident light from free space mode to guided mode. The amount of light can be measured by either a photometric method (i.e., sensitivity of an eye to light) or a radiometric method (i.e., absolute values of light). The parameters measured by photometry are luminous flux in units of lumens, luminous flux density in lumen/m², illuminance or lux in lumen/m², luminance or nit (nt) in candela/m²/steradian, and luminous intensity in candela (lumen/steradian), and the like. The parameters measured by radiometry are radiant flux in Watts, radiant energy in joules, radiant flux density in Watts/m², radiant intensity in Watts/steradian, and radiance in Watts/steradian/m², and the like.

The term “scene” herein below refers to one or a plurality of real objects. The term “projected image” herein below refers to an image which provides information to a viewer related to the scene. For example, in case of a driver who looks at an image of a vehicle driving behind, the rear-view mirror, the projected image can be the instantaneous distance between the two vehicles.

The term “incident projected image” herein below, refers to an image which an image projector projects toward an input BTE. The term “output decoupled image” herein below, refers to a projected image emerging out of an output pupil, which is transformed from the incident projected image by all the BTEs and the light guide. The term “input pupil” herein below, refers to an aperture through which an incident light beam respective of an incident projected image enters an input BTE from an image projector. The term “output pupil” herein below, refers to an aperture through which a light beam decoupled by an output BTE exits the output BTE. The term “pupil expanded” herein below, refers to a ratio of greater than one, of the output pupil and the input pupil. The term “decoupled intensity” herein below, refers to the amount of light respective of an output decoupled image, which reaches the eyes of an observer, from a certain location on an output BTE.

The term “image projector” herein below, refers to a device which produces the incident projected image. The source of an image projector (i.e., the image source) can be a near infrared (NIR) image intensifier tube (i.e., either a still image camera or a video camera), charge coupled device (CCD) camera, mid-to-far infrared image camera (i.e., thermal forward-looking infrared—thermal FLIR camera), computer, light emitting diode, organic light emitting diode, laser, laser scanner, fluorescent light element, incandescent light element, liquid crystal display, cathode ray tube display, flat panel display, visible light video camera, still image projector (slides, digital camera), cinematographic image projector, starlight scope, spatial light modulator (i.e., a device which alters the magnitude, phase, or polarization of the incident light on a pixel-by-pixel basis, in a binary fashion according to electrical input), and the like. The image projector can produce the incident projected image either in gray scale (i.e., black and white or shades of gray against a white background), or in color scale.

The term “input field of view” (input FOV) herein below, refers to a range of angles of light beams of the incident projected image, emerging from an image projector, wherein the center of the input field of view is referred to as the “input principle ray”. The term “output field of view” (output FOV) herein below, refers to a range of angles of light beams of the output decoupled image, emerging from the light guide, wherein the center of the output field of view is referred to as the “output principle ray”. The term “incidence angle” herein below, refers to the angle between the input principle ray and a normal to the surface of the light guide. The term “output angle” herein below, refers to the angle between the output principle ray and a normal to the surface of the light guide.

The term “light beam” herein below, refers to a set of light beams. Furthermore, the term “light beam” when used herein below in conjunction-with an incident projected image or an output decoupled image, refers to a set of light beams about the principle ray, within the input FOV or the output FOV, respectively.

The term “optical assembly” herein below, refers to either a single optical element or a collection of optical elements, such as lens, beam splitter, reflector, prism, light source, light detector, waveguide, polarizer, light resonator, BTE, and the like. The optical assembly can include also electronic, electrooptic, photonic, optomechanic, microelectromechanic, or electric elements.

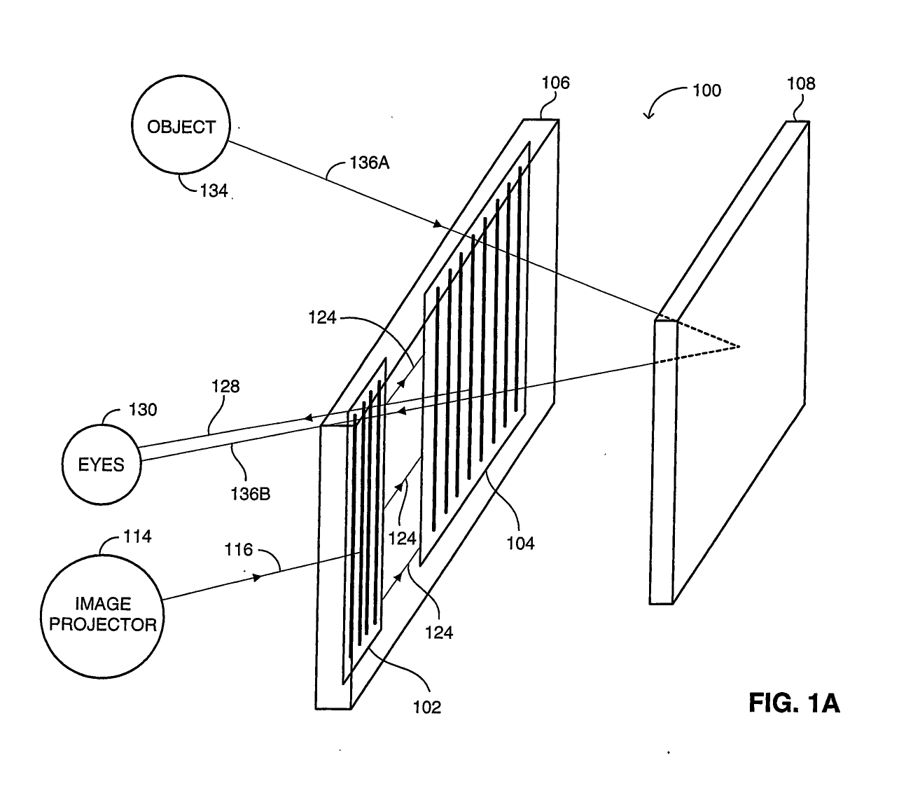

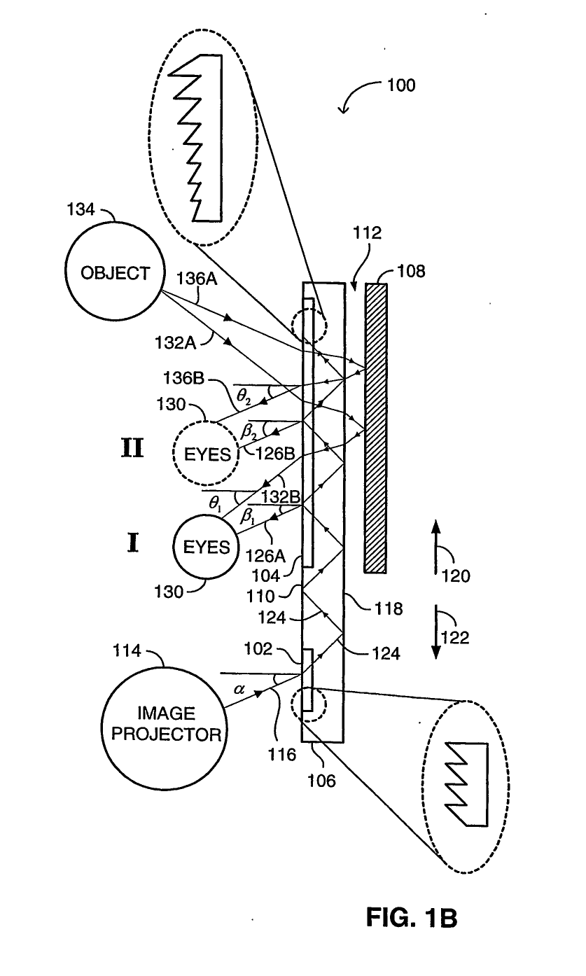

Reference is now made to FIGS. 1A and 1B. FIG. 1A is a schematic illustration in perspective, of a projected-image displaying device for displaying a projected image against a reflection of a background scene, generally referenced 100, constructed and operative in accordance with an embodiment of the disclosed technique. FIG. 1B is a schematic illustration of a top view of the device of FIG. 1A.

Device 100 includes an input BTE 102, an output BTE 104, a light guide 106 and a scene-image reflector 108. Input BTE 102 and output BTE 104 are located on a front surface 110 of light guide 106. Alternatively, input BTE 102 and output BTE 104 can be located on a rear surface 118, opposite to front surface 110. Furthermore, input BTE 102 and output BTE 104 may be embedded within light guide 106. In this case, input BTE 102 and output BTE 104 are of the thin volume grating or Fresnel micro-prism type. The contour of input BTE 102 is rectangular.

The contour of output BTE 104 is a rectangle whose side facing the input BTE 102 is equal or larger than the length of the adjacent side of the rectangle of input BTE 102. At least one corner of the contour, of each of input BTE 102 and output BTE 104, can be rounded. The surface area of output BTE 104 is greater than that of input BTE 102. Input BTE 102 and output BTE 104 are located relative to one another in such position, that the microgroove direction of output BTE 104 is parallel with that of input BTE 102. This arrangement of input BTE 102 and output BTE 104 is herein below referred to as “doublet”. Scene-image reflector 108 is located behind light guide 106, facing rear surface 118.

Scene-image reflector 108 is made of a material such as glass, polymer, plastic, beryllium, and the like, whose back surface is coated with a reflective material, such as chrome, mercury, aluminum, silver, and the like (i.e., back-coated mirror). In this case, scene-image reflector 108 is separated from rear surface 118 by an air gap. For this purpose, a peripheral spacer (not shown) is located between light guide 106 and scene-image reflector 108, in the periphery of light guide 106 and scene-image reflector 108, wherein the thickness of the peripheral spacer is about 5 to a several hundreds of micrometers. Alternatively, the air gap can be maintained by the insertion of micro-spheres of diameters of about 4 to 25 micrometers.

Further alternatively, scene-image reflector 108 is in form of a dielectric film separated from rear surface 118 by an air gap. Alternatively, scene-image reflector 108 is in form of a metallic film attached to rear surface 118 by an index matched adhesive. Further alternatively, scene-image reflector 108 is in form of a metallic coating directly applied to rear surface 118.

Alternatively, scene-image reflector 108 is an active element which varies the light intensity of a reflected image of the background scene, such as the variable reflector described in PCT application number PCT/IL 03/00111 which is herein incorporated by reference, and the like.

It is noted that instead of air gap 112, an intermediate layer (not shown) which is transparent and whose index of refraction is much lower than that of the light guide, can be placed between the scene-image reflector and the light guide. Due to the large difference between the index of refraction of the intermediate layer and that of the light guide, light beams are coupled and trapped within the light guide to obey TIR conditions within the light guide. Furthermore, the larger the difference between the index of refraction of the intermediate layer and that of the light guide, the smaller the critical angle for TIR, thereby increasing the range of angles for the internal reflections of the light beams within the light guide, and thereby increasing the possible input field of view of device 100.

An image projector 114 is located in front of device 100, facing front surface 110. Image projector 114 directs an incident light beam 116 respective of an incident projected image (not shown), toward input BTE 102 through an input pupil (not shown), at an oblique incidence angle α relative to a normal to front surface 110 (i.e., the projection of the incident projected image on input BTE 102, by image projector 114, is off-axis). The incidence angle α refers to the input principle ray at a given input field of view, wherein this input principle ray is within the input field of view. Hence, the range of the incidence angles respective of the incident projected image, is within the input field of view. The incidence angle α can be either zero or different from zero. The portion of incident light beam 116 which emerges from input BTE 102 in a direction referenced by an arrow 120 is referred to as the “+1 order” and another portion of incident light beam 116 which emerges from input BTE 102 in a direction referenced by an arrow 122 is referred to as the “−1 order”.

Input BTE 102 is an asymmetric BTE. Input BTE 102 couples incident light beam 116 into light guide 106. Input BTE 102 transforms incident light beam 116 to a coupled light beam 124 (i.e., “+1 order”) which propagates by TIR. Coupled light beam 124 strikes output BTE 104. Output BTE 104 decouples a portion (not shown) of coupled light beam 124 and transforms the portion into a decoupled light beam 126A. A second portion (not shown) of coupled light beam 124 continues to propagate within light guide 106 by TIR, and again strikes output BTE 104. Output BTE 104 transforms the remaining portion of coupled light beam 124 to a decoupled light beam 126B. The above process continues and repeats several times, wherein remaining portions of coupled light beam 124 continue to strike output BTE 104 several times and additional decoupled light beams (not shown) are decoupled by output BTE 104.

For coupled light beam 124 to be propagated through light guide 106 by TIR, input BTE 102 has to deflect coupled light beam 124 at an angle greater than the critical angle specified for light guide 106. According to the grating equation,
λ=d sin α+n₁d sin ψ (1)
where λ is the wavelength of incident light beam 116, n₁ is the index of refraction of the input BTE 102, d is the grating spacing (lateral dimension of microgrooves) of input BTE 102 (i.e., the quotient of spatial frequency), α is the incidence angle, and ψ is the internal diffraction angle at which coupled light beam 124 deflects from input BTE 102 inside light guide 106. For a light beam to propagate through light guide 106 by TIR, the deflection angle of this light beam has to be greater than the critical angle specified for light guide 106. The critical angle is derived from Snell's law, and therefore we derive that

$$ψ \geq arc sin \frac{{n}_{2}}{{n}_{1}} \qquad ( 2 )$$

where n₂ is the refractive index of the medium adjacent to the light guide. Thus, the spatial frequency (1/d) of input BTE 102 to cause TIR to take place is derived from Equations (1) and (2). The spatial frequencies of BTEs 102 and 104 are chosen to be identical so as to prevent spectral aberrations for light sources of finite bandwidths. However, the spatial frequencies of BTEs 102 and 104 can be different, specially in conjunction with monochromatic light sources.

Alternatively, front surface 110 and rear surface 118 can be coated by a reflective coating, consisting for example of a set of discrete alternative index dielectric coatings (i.e., a set of discrete dielectric coatings having different dielectric indices, and alternately located, referred to as interference coating)—not shown, continuously varying refractive index (dielectric) coatings (also referred to as rugate coatings) having index profiles such as sinusoidal, trapezoidal, triangular, and the like, reflective BTE, and the like. In this case, air gap 112 can be eliminated. The reflective coating is applied to front surface 110 and rear surface 118, except to those regions which include input BTE 102 and output BTE 104. This reflective coating reflects the image of a scene and also causes partial internal reflection of light beams to take place within the light guide.

Since dielectric coatings reflect the light by interference and do not absorb the incident light, the losses are lower than in the case of conventional reflective surfaces (i.e., metallic). These dielectric coatings can be applied by physical vapor deposition, chemical vapor deposition, sputtering, plasma enhanced deposition, and the like.

These reflective coatings may be applied to the light guiding substrate either before or after the manufacture of the BTEs on the substrate. In case the surface area of device 100 is large, and light guide 106 and scene-image reflector 108 are separated by the peripheral spacer, the mid-regions of light guide 106 and scene-image reflector 108 can make contact and reduce the TIR effect. In order to prevent contact between light guide 106 and scene-image reflector 108, air gap 112 is filled with minute separation particles, such as glass beads (i.e., microsphere), plastic beads, and the like, and the periphery of light guide 106 and scene-image reflector 108 is sealed. The diameter of the microspheres is equal to air gap 112. This type of filling provides the air gap necessary for TIR to take place.

The groove depth of input BTE 102 is uniform. However, if input BTE 102 is significantly larger than the diameter of the pupil of an eye (not shown), then the groove depth of input BTE 102 can be non-uniform.

The internal angle of diffraction of incident light beam 116 relative to a normal of the to light guide 106, should be greater than the critical angle of light guide 106, for incident light beam 124 (i.e., “+1 order”) to propagate through light guide 106 by TIR. Among a plurality of light beams directed by the image projector toward the input BTE, the smallest angle of diffraction is greater than the critical angle for the TIR condition to take place.

Eyes 130 of a moving observer (not shown) are located in front of device 100, facing front surface 110. Since the incident projected image undergoes a multiplication in two dimensions, as described herein above, eyes 130 detect the entire output decoupled image (not shown), through the entire aperture (not shown) of an exit pupil (not shown) of device 100.

Decoupled light beam 126A emerges out of device 100 at an output angle β₁. Decoupled light beam 126B emerges out of device 100 at an output angle β₂. The properties (e.g., the shape of gratings, spatial frequency, and the microscopic pattern of BTE) of input BTE 102 and output BTE 104 are identical. Thus,
β₁=β₂=α (3)

Eyes 130 located at a point I relative to device 100, detect the output decoupled image by receiving decoupled light beam 126A from device 100. When eyes 130 move to point II, they detect the same output decoupled image, by receiving decoupled light beam 126B from device 100.

An object 134 (i.e., a scene) is located in front of device 100 facing front-surface 110. Scene-image reflector 108 receives a light beam 132A from object 134, and scene-image reflector 108 reflects light beam 132A as a light beam 132B, by specular reflection, at a viewing angle (i.e., reflected scene-image angle) θ₁, through at least a portion of output BTE 104 and light guide 106. Scene-image reflector 108 receives a light beam 136A from object 134 and reflects light beam 136A as a light beam 136B, at a viewing angle θ₂, through at least a portion of output BTE 104 and light guide 106.

When eyes 130 are at point I, they detect the output decoupled image (by receiving decoupled light beam 126A) against a reflected image of object 134 (by receiving light beam 132B). When eyes 130 are at point II, they detect the same output decoupled image (by receiving decoupled light beam 126B) against a reflected image of object 134 (by receiving light beam 136B).

When the moving observer is viewing a conventional image located in a relatively short range, such as that of a printed page or a cathode ray tube display, during movements of the head she has to move her eyeballs according to the movements of the head, in order to keep viewing the conventional image. Hence, the eyes of the moving observer viewing a conventional image from short range, are readily fatigued. These head movements are present for example, when the moving observer is traveling in a vehicle on a rough road.

On the other hand, a moving observer who is viewing a relatively remote object, such as a house located far away, she does not have to move her eyeballs in order to keep viewing the remote object. This is due to the fact that the light beam reaching the moving observer from the remote object, are parallel (as if the remote object was located at infinity) and in form of plane waves. This type of viewing is the least stressing to the eyes, and it is herein below referred to as “biocular viewing”.

As the head (not shown) of the moving observer moves relative to device 100, eyes 130 detect the output decoupled image which is transformed by output BTE 104 at a region of output BTE 104, corresponding to the new location of the observer relative to device 100. Hence, during movements of the head, the eyeballs (not shown) of eyes 130 do not have to move in order to keep viewing the output decoupled image, and the eyeballs are minimally stressed. Thus, device 100 provides the moving observer, a biocular view of an image representing the incident projected image, against the reflected image of object 134. The spatial frequency of input BTE 102 and output BTE 104 is such that the moving observer perceives a stationary and continuous view of the output decoupled image, with no jitters or gaps in between.

When a stationary observer views a conventional image from short range, the perceived image is somewhat distorted (i.e., aberrations are present). This is due to the fact that the light beams emerging from the conventional image, reach each of the two eyes in a different angle. Since the light beams reaching the two eyes are not parallel, a parallax error is present in the observed view.

On the other hand, the light beams emerging from a device similar to device 100 are in form of plane waves (i.e., parallel) and they reach the two eyes at the same angle. In this case, no parallax error is present and the observed view is biocular.

Image projector 114 can produce incident light beam 116, such that the focal point of the output decoupled images, respective of light beams 126A and 126B which are decoupled by output BTE 104, is located at a selected point relative to eyes 130. For example, image projector 114 can produce incident light beam 116, such that the focal point of each of the output decoupled images, is located at the same point as that of the reflected image of object 134. Thus, eyes 130 do not have to refocus while looking back and forth on the output decoupled image and on the reflected image of object 134, and hence eyes 130 are minimally stressed.

As illustrated in an enlarged view of a portion of output BTE 104 (FIG. 1B), the depth of the individual gratings of BTE 104 is non-uniform (i.e., the depth increases along the direction of arrow 120 ). This is necessary in order for output BTE 104 to decouple light beams 126A and 126B, at equal light intensities. Since at each region of output BTE 104 along the direction of arrow 120, the intensity of coupled light beam 124 (i.e., “+1 order”) attenuates, for an output BTE having uniform depth, the intensity of decoupled light beam 126B would be less than that of decoupled light beam 126A. Since the depth of output BTE 104 is greater in the region of decoupled light beam 126B than in the region of decoupled light beam 126A, the intensity of decoupled light beams 126A and 126B are the same. Likewise, the intensity of all the output decoupled images throughout output BTE 104 is the same.

Light guide 106 is made of a material as described herein above, in form of a layer usually having a thickness of a few millimeters, while the thickness of each of input BTE 102 and output BTE 104 is usually a few hundred micrometers. Thus, light guide 106 together with input BTE 102 and output BTE 104 can be placed for example, in front of a rear view mirror of a vehicle and a biocular view an image representing the incident projected image can be displayed for the driver.

Since image projector 114 can be set to direct incident light beam 116 toward input BTE 102, at a selected incidence angle α, decoupled light beams 126A and 126B likewise emerge from output BTE 104 at output angles β₁ and β₂, respectively, each equal to α, thereby providing off-axis viewing by an observer. For example, for a driver who views a rear view mirror of the vehicle at off-axis, the image projector or other optical elements (as described herein below), can be set such that the decoupled light beams emerge from the output BTE, at an output angle corresponding with the off-axis viewing of the driver. Thus, the driver will not normally see the output decoupled image, from positions other than the usual off-axis viewing position.

Furthermore, image projector 114 projects incident light beam 116 toward input BTE 102 at such ranges of incidence angles, that the output angles of both the output decoupled image and the reflected image of object 134, are approximately equal. For example, as illustrated in FIG. 1B,
β₂=θ₂ (4)

Alternatively, the image projector projects the incident projected image at an incidence angle α equal to zero (i.e., the projection of the incident projected image on the input BTE by the image projector, is on-axis). In this case, the output angle of the output decoupled image is also equal to zero. Device 100 can be incorporated with a rear-view mirror of a vehicle (not shown), such as aircraft (e.g., airplane, helicopter), marine vessel (e.g., ship, submarine), space vehicle, ground vehicle (e.g., automobile, truck), and the like.

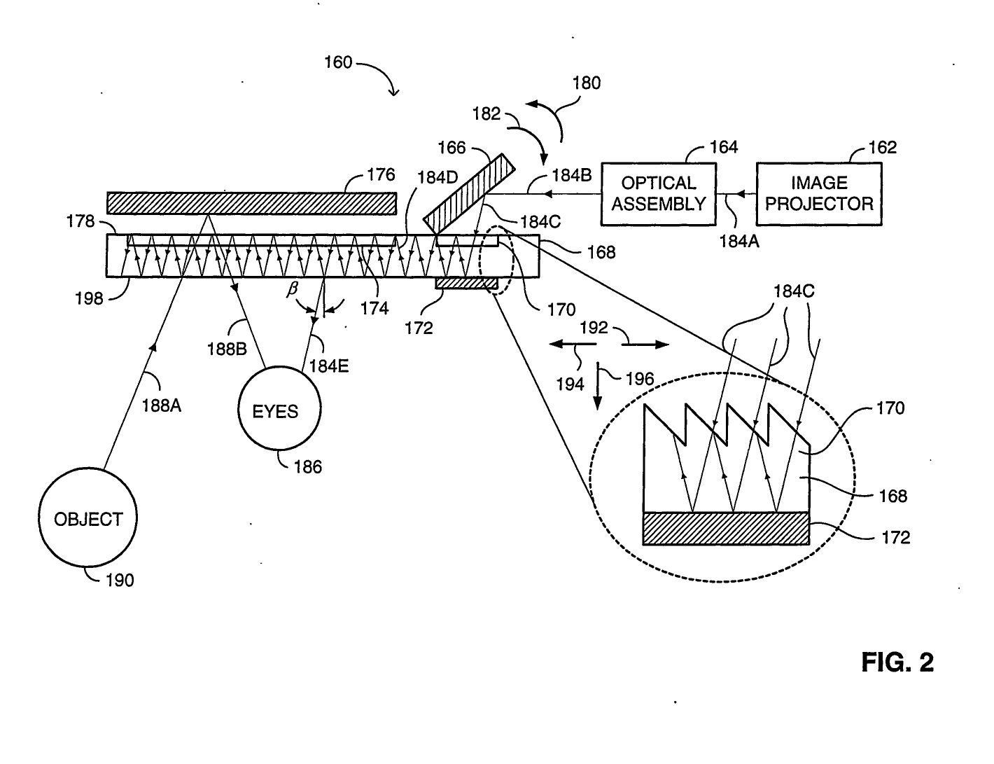

Reference is now made to FIG. 2, which is a schematic illustration of a system for displaying a projected image at a selected output angle; against a reflection of a background scene, generally referenced 160, constructed and operative in accordance with another embodiment of the disclosed technique. System 160 includes an image projector 162, an optical assembly 164, a projected-image reflector 166, a light guide 168, an input BTE 170, an input-element light reflector 172, an output BTE 174 and a scene-image reflector 176.

Scene-image reflector 176 is located behind light guide 168. Input BTE 170 and output BTE 174 are located on a surface 178 of light guide 168, wherein surface 178 is a surface of light guide 168 closest to scene-image reflector 176. Optical assembly 164 is optically coupled with image projector 162 and with projected-image reflector 166. Projected-image reflector 166 is optically coupled with input BTE 170. Projected-image reflector 166 is located on a side of light guide 168, same as scene-image reflector 176. Input BTE 170 is located between projected-image reflector 166 and input-element light reflector 172.

Each of projected-image reflector 166, input-element light reflector 172 and scene-image reflector 176 is constructed similar to the construction of scene-image reflector 108 (FIG. 1A), as described herein above. Alternatively, input-element light reflector 172 is made of a reflective coating as described herein above in connection with FIG. 1B. Input BTE 170 and output BTE 174 are similar to input BTE 102 (FIG. 1A) and output BTE 104, respectively, as described herein above. Scene-image reflector 176 is separated from surface 178 by an air gap, thereby providing mechanical protection to BTE 174 and encapsulating BTE 174. Alternatively, a thin reflective film is evaporated on BTE 174.

Projected-image reflector 166 is free to rotate in directions designated by arrows 180 and 182. The axis of rotation (not shown) of projected-image reflector 166, can be either parallel with surface 178 and perpendicular to drawing page, or located at an oblique angle relative to surface 178.

Image projector 162 directs a light beam 184A respective of an incident projected image (not shown), toward optical assembly 164 and optical assembly 164 directs a light beam 184B according to light beam 184A, toward projected-image reflector 166. Projected-image reflector 166 reflects light beam 184B as an incident light beam 184C, toward input BTE 170, by specular reflection. Input BTE 170 couples incident light beam 184C into a coupled light beam 184D. Coupled light beam 184D propagates within light guide 168 by TIR. Output BTE 174 decouples coupled light beam 184D out of light guide 168, as a decoupled light beam 184E toward eyes 186 of an observer (not shown), at an output angle β. Scene-image reflector 176 receives a light beam 188A respective of an object 190 and scene-image reflector 176 directs a light beam 188B toward eyes 186, by specular reflection. Thus, eyes 186 detect the incident projected image against a reflected image of object 190.

Light beams deflected by input BTE 170 in directions designated by arrows 192, 194 and 196, are herein below referred to as the “−1 order” light beams, “+1 order” light beams, and zero order light beams, respectively. Since input BTE 170 is asymmetric, the intensity of the “−1 order” light beams is much less than that of the “+1 order” light beams. Input-element light reflector 172 reflects the zero order light beams toward input BTE 170, by specular reflection, as illustrated in an enlarged view of a portion of input BTE 170 and input-element light reflector 172. It is noted that coupled light beam 184D is a combination of incident light beam 184C and the zero order light beams. In this manner, input-element light reflector 172 returns the zero order light beams which would otherwise be wasted, back to light guide 168 (i.e., input-element light reflector 172 couples the zero order light beams into light guide 168). Thus, the coupling efficiency of system 160 is greater that of device 100 and the intensity of the output decoupled image detected by eyes 186 is greater than the one detected by eyes 130 (FIG. 1A).

Projected-image reflector 166 can be rotated in directions 180 and 182 to display the incident projected image at a selected output angle β. Alternatively, the optical assembly can direct the projected-image light beams respective of the incident projected image to the input BTE, such that the output BTE displays the output decoupled image at the selected output angle β.

Optical assembly 164 can include an image focal-point location changer (not shown) for changing the location of the focal point of the incident projected image, thereby changing the focal point of the output decoupled image, relative to eyes 186. Such an image focal-point location changer can be a variable focal-length lens (not shown), a lens whose location is physically changed (e.g., by an electric motor), and the like. The image focal-point location changer changes the location of the focal point of an image, according to an electric signal received from a controller (not shown). The variable focal-length lens changes the location of the focal point, for example, by changing the refractive index of a fluid or a liquid crystal. The variable focal-length lens can be purchased for example, under the trade name “Variable focal lens KP45”, from Varioptic, 46 allee d'Italie 69007, Lyon, France.

The controller can direct the image focal-point location changer to change the focal length of the output decoupled image, for example, according to the current focal length of the reflected image of the scene. The controller can direct the image focal-point location changer to vary the location of the focal point of the output decoupled image continuously, in an oscillating manner (i.e., back and forth about a selected value). In this manner, the observer can obtain a three-dimensional perception of the output decoupled image.

In accordance with another aspect of the disclosed technique, a plurality of different incident light beams, respective of different incident projected images, are projected by respective image projectors on an input BTE. The input BTE couples each of the incident light beams into respective coupled light beams, into a light guide. The output BTE, decouples each of the coupled light beams into respective decoupled light beams, out of the light guide, thereby forming a set of output decoupled images. Each of the output decoupled images is a pupil expanded representation of the incident projected images.

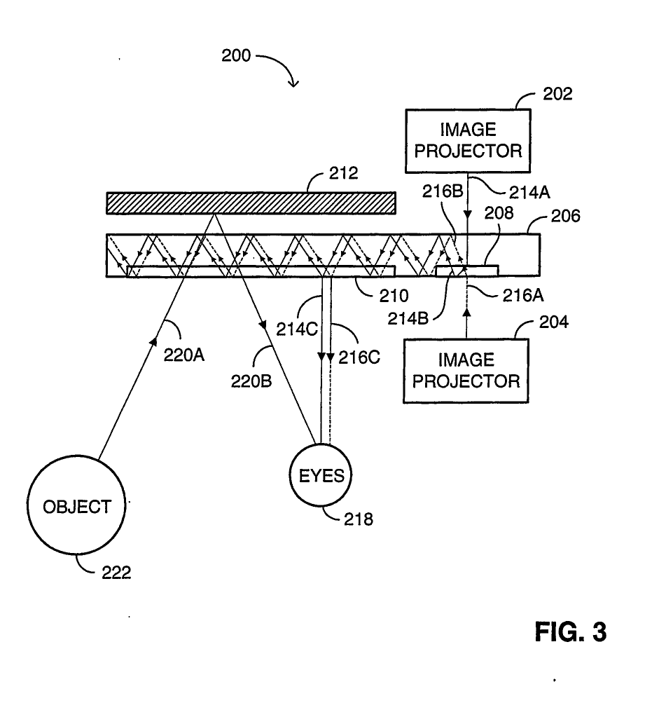

Reference is now made to FIG. 3, which is a schematic illustration of a system for displaying a combination of two projected images, against a reflection of a background scene, generally referenced 200, constructed and operative in accordance with a further embodiment of the disclosed technique. System 200 includes image projectors 202 and 204, a light guide 206, an input BTE 208, an output BTE 210 and a scene-image reflector 212. Input BTE 208 is a diffraction light beam transformer. Image projectors 202 and 204 are optically coupled with input BTE 208. Input BTE 208 and output BTE 210 are incorporated with light guide 206 (i.e., either located on a surface of the light guide or embedded there within). Scene-image reflector 212 is located behind light guide 206. In the example set forth in FIG. 3, input BTE 208 and output BTE 210 are located on the same surface of light guide 206. Alternatively, the input BTE can be located on one surface of the light guide and the output BTE on an opposite surface of the light guide.

Image projectors 202 and 204 are incorporated with a first image source (not shown) and a second image source (not shown), respectively. The first image source and the second image source can be either coupled with image projector 202 and 204, respectively, or be a part thereof (e.g., in case of a slide projector). The first image source is associated with a first range of wavelengths and the second image source is associated with a second range of wavelengths, different than the first range of wavelengths. Alternatively, each of image projectors 202 and 204 can be incorporated with more than one image source.

The first image source sends information respective of a first incident projected image (not shown), to image projector 202. The second image source sends information respective of a second incident projected image (not shown) to image projector 204. Each of the first image source and the second image source sends the respective incident projected image information, to image projector 202 and image projector 204, respectively, either optically, electronically, or a combination thereof. Image projector 202 directs an incident light beam 214A respective of the first incident projected image toward input BTE 208. Image projector 204 directs an incident light beam 216A respective of the second incident projected image toward input BTE 208. Further alternatively, each of the first image source and the second image source, directs the incident light beam respective of the first incident projected image and the second incident projected image, respectively, directly toward the input BTE, in which case, the image projectors are disposed of.

Input BTE 208 couples incident light beam 214A into a coupled light beam 214B, and coupled light beam 214B propagates within light guide 206 by TIR. Input BTE 208 couples incident light beam 216A into a coupled light beam 216B, and coupled light beam 216B propagates within light guide 206 by TIR.

Coupled light beams 214B and 216B propagate through light guide 206 by TIR and reach output BTE 210. Output BTE 210 decouples coupled light beams 214B and 216B, to decoupled light beams 214C and 216C, respectively, out of system 200 toward eyes 218 of an observer (not shown). Decoupled light beams 214C and 216C coalesce within eyes 218 and the observer detects a superimposed image of the first incident projected image and the second incident projected image. This superimposed image is herein below referred to as a “sensor fused image”. Decoupled light beam 214C is respective of a first set of output decoupled images, wherein each of this first set represents the first incident projected image. Similarly, decoupled light beam 216C is respective of a second set of output decoupled images, wherein each of this second set represents the second incident projected image. Thus, a moving observer obtains a biocular view of the sensor fused image. System 200 is referred to as an “image fusion system”.

Scene-image reflector 212 receives a light beam 220 A respective of an object 222 and reflects a light beam 220B toward eyes 218 by specular reflection, through at least a portion of light guide 206 and output BTE 210. Thus, eyes 218 detect a biocular view the of sensor fused image against a reflected image of object 222. It is noted that other image projectors in addition to image projectors 202 and 204 can be incorporated with a system similar to system 200, in order to project additional incident projected images to the input BTE. This arrangement can be implemented for example, by employing one or more beam splitters, or other sensor fusion methods known in the art. In addition, a system similar to system 200 can include an optical assembly coupled with an image projector, wherein the optical assembly directs an incident projected image from the image projector toward the input BTE. The optical assembly can be coupled with more than one image projector, to direct a combined image from the image projectors toward the input BTE.

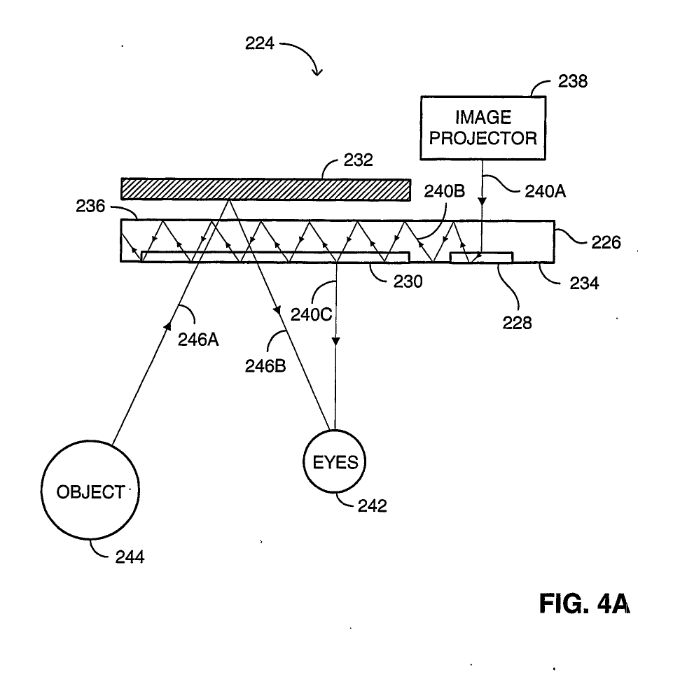

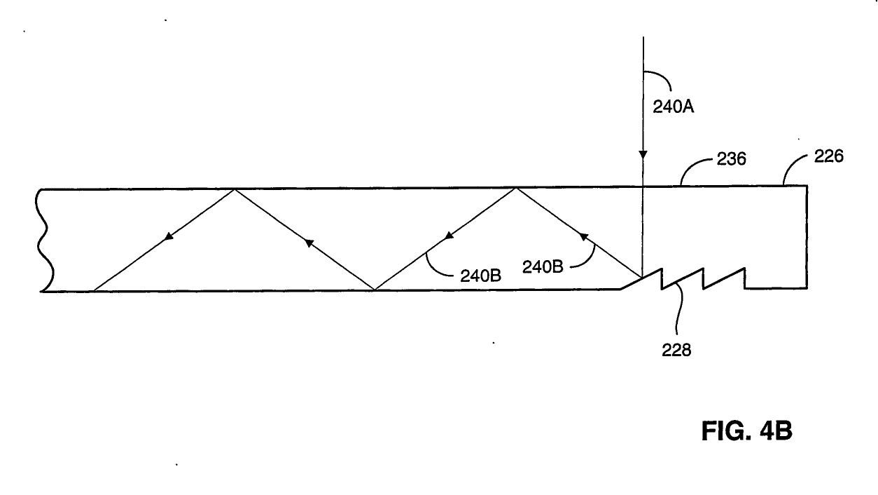

Reference is now made to FIGS. 4A and 4B. FIG. 4A is a schematic illustration of a system for displaying a projected image, against a reflection of a background scene, generally referenced 224, constructed and operative in accordance with another embodiment of the disclosed technique. FIG. 4B is a schematic illustration of a detailed view of the input BTE of the system of FIG. 4A, coupling an incident light beam into the light guide of the system, in a reflective mode.

System 224 includes a light guide 226, an input BTE 228, an output BTE 230 and a scene-image reflector 232. Input BTE 228 is a refraction light beam transformer. Input BTE 228 and output BTE 230 are incorporated with light guide 226. Input BTE 228 and output BTE 230 are located on a front surface 234 of light guide 226. Scene-image reflector 232 is located behind light guide 226, facing a rear surface 236 opposite to front surface 234.

An image projector 238 is located behind light guide 226, facing rear surface 236. Image projector 238 directs an incident light beam 240A respective of an incident projected image (not shown) toward input BTE 228. Incident light beam 240A represents the principle ray respective of the incident projected image. In the example set forth in FIGS. 4A and 4B, incident light beam 240A is normal to rear surface 236. However, it is noted that the image projector can direct an incident projected image toward the input BTE, wherein the incidence angle of the input principle ray, is different from zero (i.e., not normal to the rear surface). This situation is possible, as long as the incidence angle of the input principle ray is within the input field of view.

Input BTE 228 couples incident light beam 240A into light guide 226 by TIR, as a coupled light beam 240B, toward output BTE 230. Output BTE 230 decouples coupled light beam 240B as a decoupled light beam 240C, out of light guide 226 toward eyes 242 of an observer (not shown), who faces front surface 234. Decoupled light beam 240C emerges light guide 226 at an output angle (not shown) relative to front surface 234, equal to the angle of incidence of incident light beam 240A relative to rear surface 236.

An object 244 is located in front of system 224, facing front surface 234. Scene-image reflector 232 receives a light beam 246A respective of object 244 and reflects a light beam 246B toward eyes 242 by specular reflection, through at least a portion of light guide 226 and output BTE 230. Thus, eyes 242 detect a biocular view of an image representing the incident projected image, against a reflected image of object 244.

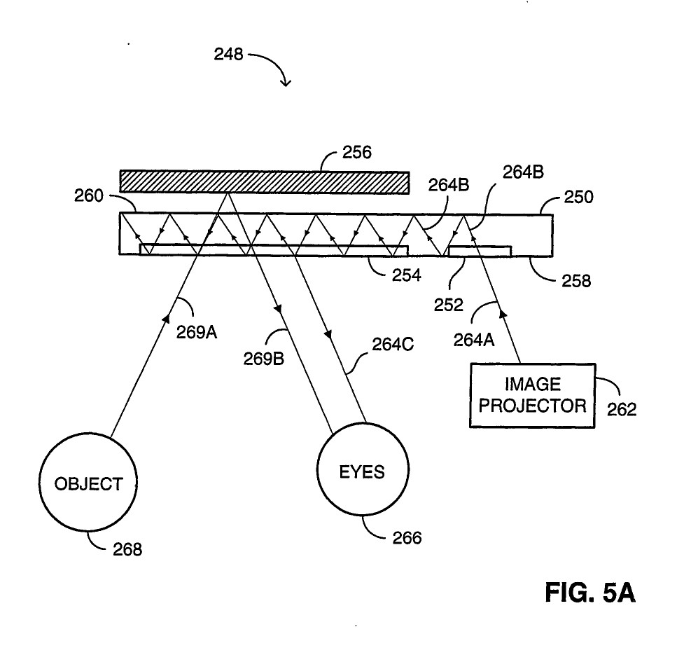

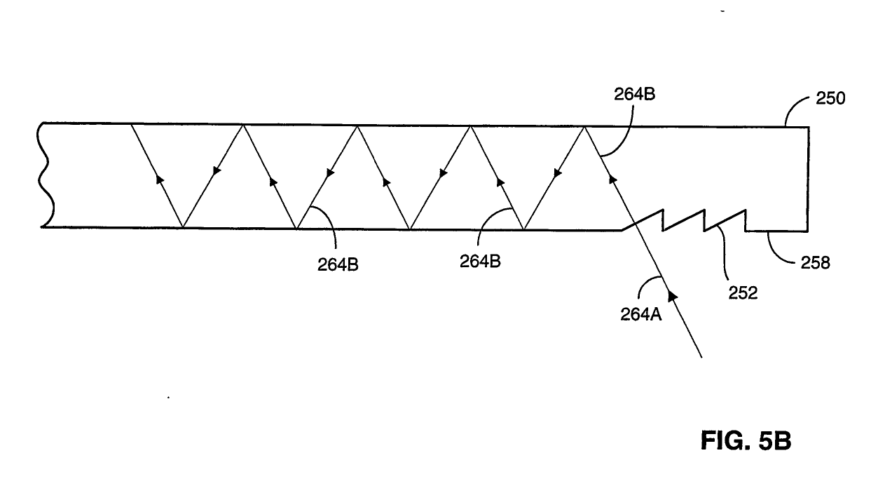

Reference is now made to FIGS. 5A and 5B. FIG. 5A is a schematic illustration of a system for displaying a projected image, against a reflection of a background scene, generally referenced 248, constructed and operative in accordance with a further embodiment of the disclosed technique. FIG. 5B is a schematic illustration of a detailed view of the input BTE of the system of FIG. 5A, coupling an incident light beam into the light guide of the system, in a transmissive mode.

System 248 includes a light guide 250, an input BTE 252, an output BTE 254 and a scene-image reflector 256. Input BTE 252 is a refraction light beam transformer. Input BTE 252 and output BTE 254 are incorporated with light guide 250. Input BTE 252 and output BTE 254 are located on a front surface 258 of light guide 250. Scene-image reflector 256 is located behind light guide 250, facing a rear surface 260 opposite to front surface 258.

An image projector 262 is located in front of light guide 250, facing front surface 258. Image projector 262 directs an incident light beam 264A respective of an incident projected image (not shown) toward input BTE 252. Incident light beam 264A is projected toward input BTE 252 at an angle of incidence, for incident light beam 264A to enter light guide 250 through input BTE 252 by refraction.

Input BTE 252 couples incident light beam 264A into light guide 250 by TIR, as a decoupled light beam 264B, toward output BTE 254. Output BTE 254 decouples coupled light beam 264B out of light guide 250, as a decoupled light beam 264C, toward eyes 266 of an observer (not shown), who faces front surface 258. Decoupled light beam 264C emerges light guide 250 at an output angle (not shown) relative to front surface 258, equal to the angle of incidence of incident light beam 264A relative to front surface 258.

An object 268 is located in front of system 248, facing front surface 258. Scene-image reflector 256 receives a light beam 269A respective of object 268 and reflects a light beam 269B toward eyes 266 by specular reflection, through at least a portion of light guide 250 and output BTE 254. Thus, eyes 266 detect a biocular view of an image representing the incident projected image, against a reflected image of object 268.

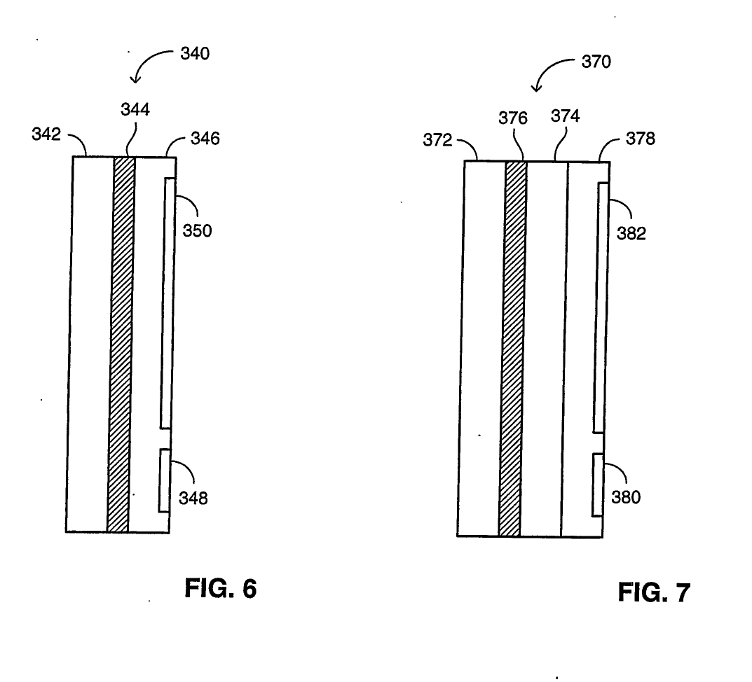

Reference is now made to FIG. 6, which is a schematic illustration of a front-coated device, generally referenced 340, for displaying a projected image against a reflection of a background scene, constructed and operative in accordance with another embodiment of the disclosed technique. Device 340 includes a protective element 342, a scene-image reflector 344, a light guide 346, an input BTE 348 and output BTE 350.

Input BTE 348 and output BTE 350 are incorporated with light guide 346. Scene-image reflector 344 is located between protective element 342 and light guide 346. Protective element 342 is made of a material similar to light guide 346. In case scene-image reflector 344 is a dielectric film, scene-image reflector 344 is separated from light guide 346 by an air gap, as described herein above in connection with FIG. 1A. Alternatively, in case scene-image reflector 344 is a dielectric film, no air gap exists between scene-image reflector 344 and light guide 346. In case scene-image reflector 344 is in form of a metallic coating, no air gap is necessary.

Reference is now made to FIG. 7, which is a schematic illustration of a back-coated device, generally referenced 370, for displaying a projected image against a reflection of a background scene, constructed and operative in accordance with a further embodiment of the disclosed technique. Device 370 includes protective elements 372 and 374, a scene-image reflector 376, a light guide 378, an input BTE 380 and an output BTE 382. Each of protective elements 372 and 374 is similar to protective element 342 (FIG. 6), as described herein above. Protective element 372 can also be in form of a polymer or a coating of a pigment. Scene-image reflector 376 is located between protective elements 372 and 374. Protective element 374 is located between scene-image reflector 376 and light guide 378. Input BTE 380 and output BTE 382 are incorporated with light guide 378. Scene-image reflector 376 is a metallic reflector. Protective element 374 and light guide 378 are made same of the same material and glued together with an index matched adhesive. Scene-image reflector 376 allows TIR, and the thickness of each of protective element 374 and light guide 378 is designed such that their total thickness is equal to the designed light guide thickness.

In accordance with a further aspect of the disclosed technique, one input BTE, a left intermediate BTE, a right intermediate BTE, a left output BTE and a right output BTE, are incorporated with a light guide, together forming a projected-image displaying device. An image projector projects an incident projected image on the input BTE. The input BTE couples into the light guide, equal portions of incident light beams respective of the incident projected image, to the left intermediate BTE and to the right intermediate BTE. Each of the left intermediate BTE and the right intermediate BTE spatially transforms the coupled light beams, into a set of coupled light beams, to the left output BTE and to the right output BTE, respectively.

Each of the left output BTE and the right output BTE decouples the set of coupled light beams, respective of the left intermediate BTE and right intermediate BTE, respectively, out of the light guide, as decoupled light beams, toward the left eye and the right eye of an observer, respectively, depending on the current position of the observer relative to the device. The decoupled light beams form a set of output decoupled images, wherein each of the output decoupled images represents the incident projected image. Thus, the observer obtains a split biocular view of an image which is a pupil expanded representation of the incident projected image.

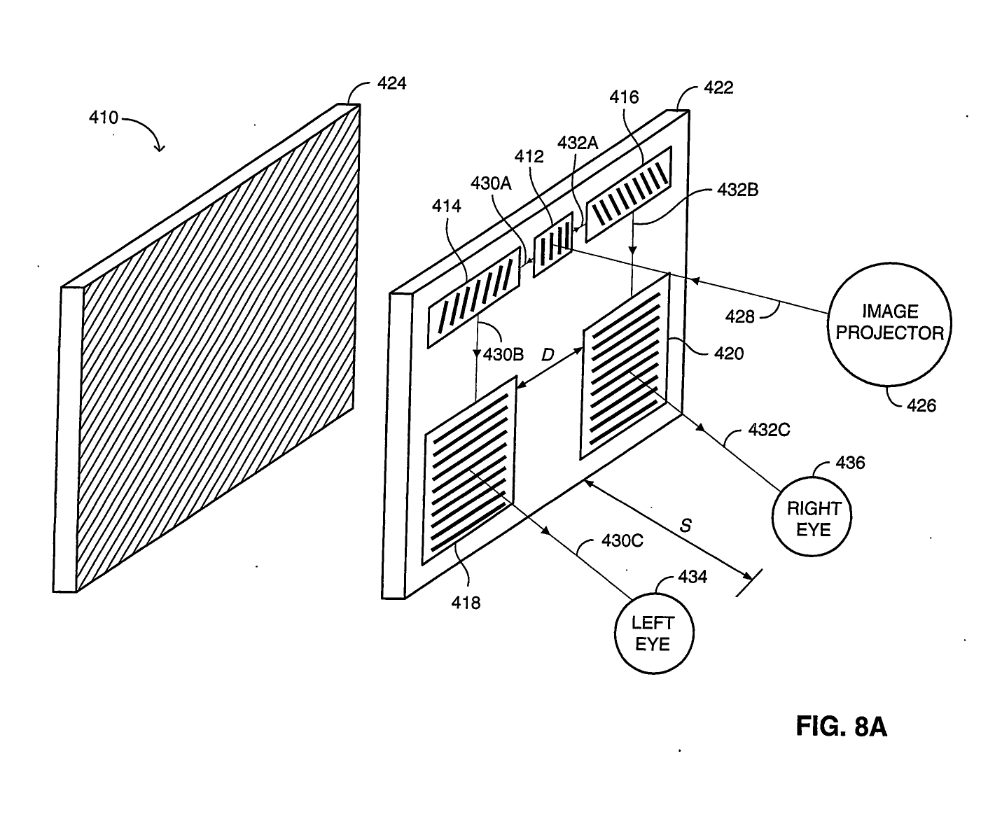

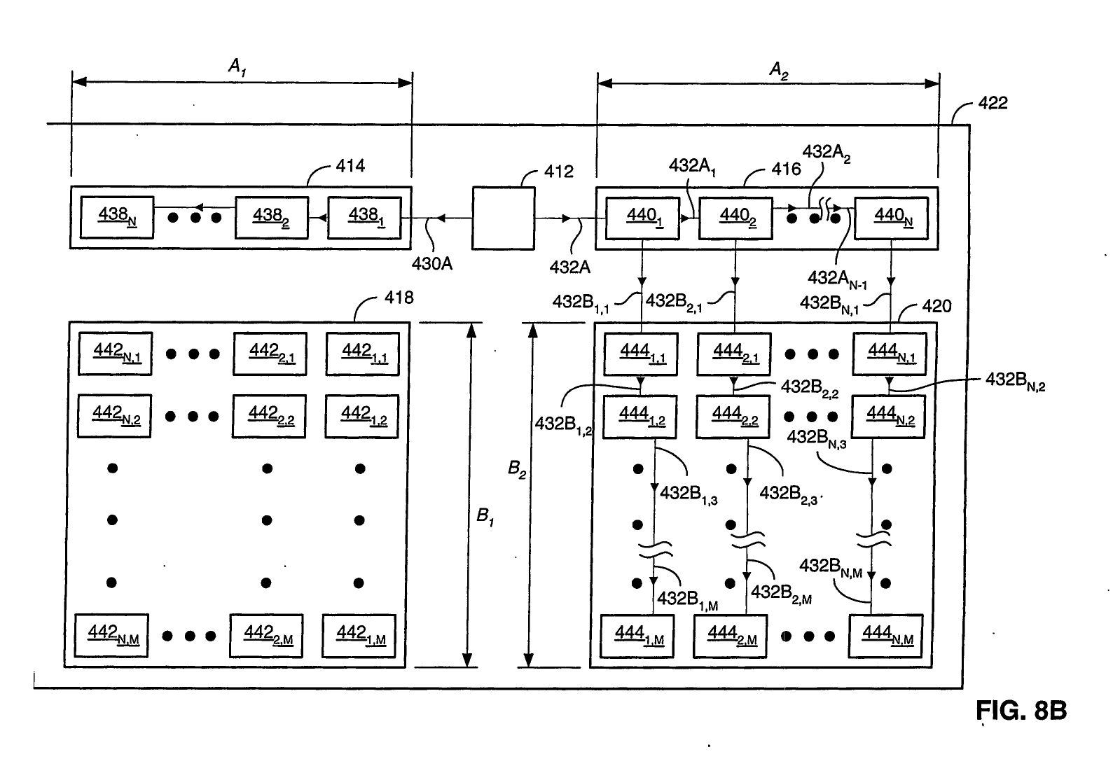

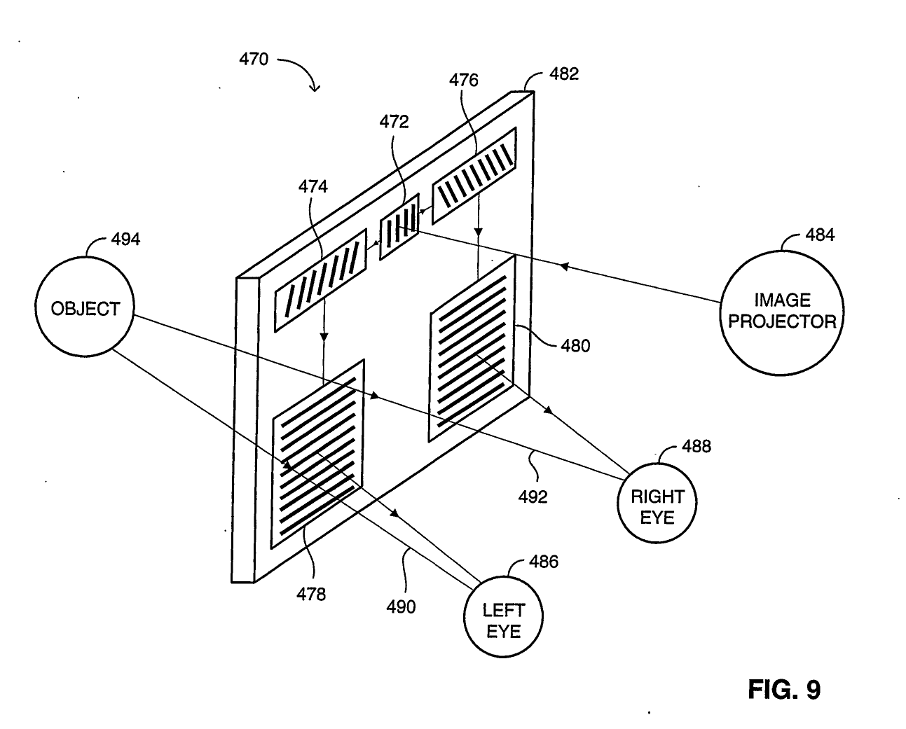

Reference is now made to FIGS. 8A and 8B. FIG. 8A is a schematic illustration of a device, generally referenced 410, for displaying a projected image against an opaque coating, constructed and operative in accordance with another embodiment of the disclosed technique. FIG. 8B is a schematic illustration of the light paths within the light guide, the input BTE, the left intermediate BTE, the right intermediate BTE, the left output BTE and the right output BTE of the device of FIG. 8A.

With reference to FIG. 8A, device 410 includes an input BTE 412, a left intermediate BTE 414, a right intermediate BTE 416, a left output BTE 418, a right output BTE 420, a light guide 422 and an opaque shield 424. Input BTE 412, left intermediate BTE 414, right intermediate BTE 416, left output BTE 418 and right output BTE 420 are incorporated with light guide 422.

Input BTE 412 is located between left intermediate BTE 414 and right intermediate BTE 416. This arrangement of input BTE 412, left intermediate BTE 414, right intermediate BTE 416, left output BTE 418 and right output BTE 420, is herein below referred to as “quintuple”.

Input BTE 412, left intermediate BTE 414, right intermediate BTE 416, left output BTE 418 and right output BTE 420 are located on the same plane (not shown). Input BTE 412, left intermediate BTE 414 and right intermediate BTE 416 are located along a first axis (not shown). Left intermediate BTE 414 and left output BTE 418 are located along a second axis (not shown), normal to the first axis. Right intermediate BTE 416 and right output BTE 420 are located along a third axis (not shown), normal to the first axis.

The relation between the spatial frequency f₁ of input BTE 412, the spatial frequency f₂ of each of left intermediate BTE 414 and right intermediate BTE 416 and the angle γ, is given by,
f₂=f₁/cos(γ/2) (5)
Thus, the spatial frequency f₂ of each of left intermediate BTE 414 and right intermediate BTE 416 has to be larger than the spatial frequency f₁ of input BTE 412, by a factor of,
1/cos(γ/2) (6)
For the special case of γ=90 degrees, according Equation (6), this factor corresponds to 1/cos(45) or to √2. Similarly, the spatial frequency f₂ of each of left intermediate BTE 414 and right intermediate BTE 416 has to be larger than the spatial frequency of each of left output BTE 418 and right output BTE 420.

Opaque shield 424 is made of an opaque material, such as opaque glass, metal, plastic, and the like, having a dark hue, such as black, dark blue, dark brown, dark green, dark red, and the like. Opaque shield 424 can be painted, anodized in a dark hue, and the like. Opaque shield 424 is located behind light guide 422. Opaque shield 424 is separated from light guide 422 by an air gap (not shown) in order to allow the light beams to propagate within light guide 422 by TIR.

The depth of the gratings of each of left intermediate BTE 414 and right intermediate BTE 416 is non-uniform. The spatial frequency of each of intermediate BTE 414 and intermediate BTE 416 is larger than that of input BTE 412 by a factor of √2.

Each of left output BTE 418 and right output BTE 420 is an asymmetric BTE. Alternatively, each of left output BTE 418 and right output BTE 420 is a symmetric BTE.

An image projector 426 projects an incident light beam 428 respective of an incident projected image (not shown), toward input BTE 412, in a direction normal to input BTE 412 (i.e., on-axis projection). Alternatively, image projector 426 projects incident light beam 428 in directions other than normal (i.e., off-axis projection). The groove depth of input BTE 412 is uniform. Alternatively, the groove depth of input BTE 412 is non-uniform. Input BTE 412 is a symmetric BTE for on-axis projection. In other cases image projector 426 projects incident light beam 428 at an oblique angle relative to input BTE 412 (i.e., an off-axis projection), and input BTE 412 is asymmetric. Alternatively, input BTE 412 is an asymmetric BTE. Each of left intermediate BTE 414 and right intermediate BTE 416 is a symmetric BTE. Alternatively, each of left intermediate BTE 414 and right intermediate BTE 416 is an asymmetric BTE.

With further reference to FIG. 8B, the method for obtaining a pupil representation of the incident projected image, such as in connection with FIG. 3 herein above, is described herein below. The lateral dimensions of left intermediate BTE 414 and right intermediate BTE 416 along the first axis, is A₁ and A₂ , respectively. Left output BTE 418 is a rectangle having a side A₁ and another side B₁. Right output BTE 420 is a rectangle having a side A₂ and another side B₂. Each of left intermediate BTE 414, right intermediate BTE 416, left output BTE 418 and right output BTE 420 is divided into discrete sub-regions, as described herein below. It is noted that these sub-regions, which are schematically shown in FIG. 8B as separate entities, are in practice either directly adjacent or even continuously varying.

Left intermediate BTE 414 includes a row of a plurality of left intermediate regions 438₁, 438₂ and 438_{N}. Right intermediate BTE 416 includes another row of a plurality of right intermediate regions 440₁, 440₂ and 440_{N}. Left output BTE 418 includes a matrix of a plurality of left output regions 442_{1,1}, 442_{2,1}, 442_{N,1}, 442_{1,2}, 442_{2,2}, 442_{N,2}, 442_{1,M}, 442_{2,M} and 442_{N,M}, where the index N designates the column of the matrix and the index M designates the row of the matrix. Right output BTE 420 includes a matrix of a plurality of right output regions 444_{1,1}, 444_{2,1}, 444_{N,1}, 444_{1,2}, 444_{2,2}, 444_{N,2}, 444_{1,M}, 444_{2,M} and 444_{N,M}. It is noted that the row of each of left intermediate BTE 414 and right intermediate BTE 416 includes two or more elements (i.e., regions) and that the matrix of each of left output BTE 418 and right output BTE 420 includes two or more rows and two or more columns (i.e., four or more regions).

Input BTE 412 couples incident light beam 428 into light guide 422 by TIR, as a coupled light beam 430A (i.e., “+1 order”), toward left intermediate BTE 414, along the first axis. Input BTE 412 couples incident light beam 428 into light guide 422 by TIR, as a coupled light beam 432A (i.e., “−1 order”), toward right intermediate BTE 416, along the first axis. Coupled light beam 432A propagates within light guide 422 by TIR, until it strikes right intermediate region 440₁. Coupled light beam 430A propagates within light guide 422 by TIR, until it strikes left intermediate region 438₁.

Right intermediate BTE 416 deflects a portion 432B_{1,1} of coupled light beam 432A, from right intermediate region 440₁, toward right output region 444_{1,1} and transmits the remaining portion 432A₁ toward right intermediate region 440₂. Right intermediate BTE 416 deflects a portion 432B_{2,1} of coupled light beam 432A₁, from right intermediate region 440₂, toward right output region 444_{2,1} and transmits the remaining portion 432A₂ toward right intermediate region 440₃ (not shown). Right intermediate BTE 416 deflects a portion 432B_{N,1} of a coupled light beam 432A_{N-1}, from right intermediate region 440_{N}, toward right output region 444_{N,1}. In this manner, right intermediate BTE 416 expands the input pupil of the incident projected image by the length A₂ along the first axis. In this manner, right intermediate BTE 416 spatially transforms coupled light beam 432A (FIG. 8A) within light guide 422, to coupled light beam 432B (FIG. 8A).

Right output BTE 420 decouples a portion of light beam 432B_{1,1} from right output region 4441,1 as a decoupled light beam being a portion of the decoupled light beam 432C (FIG. 8A), toward a right eye 436 of an observer (not shown), at the same angle as the angle of incidence (FOV—not shown) of incident light beam 428. Right output BTE 420 transmits the remaining portion 432B_{1,2} of light beam 432B_{1,1}, from right output region 444_{1,1} toward right output region 444_{1,2}. Right output BTE 420 decouples a portion of light beam 432B_{1,2}, from right output region 444_{1,2,} into another decoupled light beam (not shown) being a further portion of decoupled light beam 432C (FIG. 8A), toward right eye 436. Right output region 4441,2 transmits an attenuated portion 432B_{1,3} of light beam 432B_{1,2}, toward a right output region 444_{1,3} (not shown). Right output region 444_{1,M} decouples an attenuated portion 432B_{1,M} into another decoupled light beam (not shown) being a further portion of the decoupled light beam 432C (FIG. 8A), toward right eye 436.

In a similar manner, each of right output regions 444_{2,1}, 444_{2,2} and 444_{2,M} decouple attenuated light beams 432B_{2,1}, 432B_{2,2}, 432B_{2,3} and 432B_{2,M} into further decoupled light beams (not shown) being further portions of the decoupled light beam 432C (FIG. 8A), toward right eye 436, and transmit the remaining portions of attenuated light beams 432B_{2,1}, 432B_{2,2}, 432B_{2,3} and 432B_{2,M} to the corresponding next sub-region. In a similar manner, each of right output regions 444_{N,1}, 444_{N,2} and 444_{N,M} decouple attenuated light beams 432B_{N,1}, 432B_{N,2}, 432B_{N,3} and 432B_{N,M} and into further decoupled light beams (not shown) being further portions of the decoupled light beam 432C (FIG. 8A), toward right eye 436, and transmit the remaining portions of attenuated light beams 432B_{N,1}, 432B_{N,2}, 432B_{N,3} and 432B_{N,M} to the corresponding next sub-region. In this manner, right eye 436 detects an image respective of the incident projected image, via decoupled light beam 432C, emerging from one of right output regions 444_{1,1}, 444_{2,1}, 444_{N,1}, 444_{1,2}, 444_{2,2}, 444_{N,2}, 444_{1,M}, 444_{2,M} and 444_{N,M}, depending on the current position of right eye 436 relative to device 410. It is noted that in this manner, right output BTE 420 expands the input pupil of the incident projected image by the length B₂ along the third axis, in an addition to the expansion which is performed by right intermediate BTE 416 by the length A₂ along the first axis. Thus, right eye 436 detects an image representative of the incident projected image, through an exit pupil which is expanded by dimensions A₂ and B₂ in two directions.

It is noted that right intermediate BTE 416 can be constructed such that the intensity of light beams 432B_{1,1}, 432B_{2,1} and 432B_{N,1} (i.e., deflected light beams), is the same. Likewise, right output BTE 420 can be constructed such that the intensity of decoupled light beams similar to decoupled light beam 432C decoupled by right output BTE 420, from right output regions 444_{1,1}, 444_{2,1}, 444_{N,1}, 444_{1,2}, 444_{2,2}, 444_{N,2}, 444_{1,M}, 444_{2,M} and 444_{N,M}, is the same.

In a similar manner, left intermediate BTE 414 deflects coupled light beam 430A as a coupled light beam 430B toward left output BTE 418. Left output BTE 418 decouples coupled light beam 430B to a decoupled light beam 430C toward a left eye 434 of the observer.

If image projector 426 projects incident light beam 428 in a direction normal (and around normal—not shown) to light guide 422 (i.e., on-axis projection), then left output BTE 418 and right output BTE 420 decouple coupled light beams 430B and 432B, respectively, to decoupled light beams 430C and 432C, respectively, in a direction normal to light guide 422. Likewise, if image projector 426 projects incident light beam 428 at a non-zero incidence angle (i.e., off-axis projection), then left output BTE 418 and right output BTE 420 decouple coupled light beams 430B and 432B, respectively, to decoupled light beams 430C and 432C, respectively, out of light guide 422, in the same off-axis direction. This is so, because the spatial frequency of each of left output BTE 418 and right output BTE 420 is chosen to be closely identical to that of input BTE 412. Alternatively, the spatial frequency of each of left output BTE 418 and right output BTE 420 is different than that of input BTE 412.

Decoupled light beam 430C is respective of an output decoupled image among a plurality of output decoupled images which left output BTE 418 decouples. Similarly, decoupled light beam 432C is respective of an output decoupled image among a plurality of output decoupled images which right output BTE 420 decouples. Decoupled light beams 430C and 432C respective of the output decoupled images, decoupled by each of left output BTE 418 and right output BTE 420 represent the incident projected image which image projector 426 projects toward input BTE 412. Furthermore, the microgroove direction of each of left output BTE 418 and right output BTE 420, relative to that of input BTE 412, is such that decoupled light beams 430C and 432C exit light guide 422, at the same angle which incident light beam 428 enters light guide 422.

The microgroove direction of left intermediate BTE 414 relative to that of input BTE 412, determines the relative orientation of coupled light beams 430A and 430B. The microgroove direction of right intermediate BTE 416 relative to that of input BTE 412, determines the relative orientation of coupled light beams 432A and 432B. The microgroove direction of left output BTE 418 relative to that of left intermediate BTE 414, determines the relative orientation of coupled light beam 430B and decoupled light beam 430C. The microgroove direction of right output BTE 420 relative to that of right intermediate BTE 416, determines the relative orientation of coupled light beam 432B and decoupled light beam 432C.

In order for the assembly of input BTE 412, left intermediate BTE 414, right intermediate BTE 416, left output BTE 418, right output BTE 420 and light guide 422 preserve the input imaging characteristics (i.e. operate as an assembly without intrinsic optical power, the following conditions have to be satisfied. These conditions are necessary also for maintaining the angular, spectral, or phase characteristics.

First, the spatial frequencies of input BTE 412, left output BTE 418 and right output BTE 420 have to be identical. Second, as one of the main functions of an intermediate BTE is to rotate the first optical axis by an angle γ, the microgroove direction of input BTE 412 relative to that of left output BTE 418 has to be identical with the same angle γ. Similarly, the microgroove direction of input BTE 412 relative to that of right output BTE 420 has to be identical with the same angle γ. Third, the microgroove direction of each of left intermediate BTE 414 and right intermediate BTE 416 has to be γ/2 relative to that of input BTE 412.

Hence, the microgroove direction of input BTE 412 is perpendicular to the first axis. The microgroove direction of left intermediate BTE 414 is 45 degrees clockwise relative to the microgroove direction of input BTE 412. The microgroove direction of right intermediate BTE 416 is 45 degrees counterclockwise relative to the microgroove direction of input BTE 412. The microgroove direction of each of left output BTE 418 and right output BTE 420 is normal to the microgroove direction of input BTE 412.

A distance D between left output BTE 418 and right output BTE 420 and a distance S between light guide 422 and the observer, are set such that left eye 434 perceives an output decoupled image decoupled by left output BTE 418 and right eye 436 perceives the same output decoupled image as decoupled by right output BTE 420.

Thus, the observer obtains a split biocular view of an image which represents the incident projected image, against a dark background. This is similar to viewing an image on a display, such as a cathode ray tube (CRT), and the like, except that the observer obtains a split biocular view of an image which represents the incident projected image. This arrangement can be used for example, in conjunction with a night vision system to prevent the observer to be seen by another observer, or in a situation where the external light is distracting to the observer. It is noted that the left eye can be replaced by two eyes (not shown) of a first observer (not shown), and the right eye can be replaced by two eyes (not shown) of a second observer (not shown).

In this case, the distances D and S can be set, such that the first observer obtains a biocular view of the output decoupled image emerging out of an output BTE similar to left output BTE 418, and the second observer obtains a biocular view of the same output decoupled image, emerging out of another output BTE similar to right output BTE 420.

It is noted that device 410 uses both the “+1 order” light beam and the “−1 order” light beam of the incident projected image, in order to transform the incident projected image, whereas device 100 uses only the “+1 order” light beam in order to transform the incident projected image, and the “−1 order” light beam is wasted. Hence, the intensity of the incident projected image projected toward device 410, can be less than that of device 100, in order to display an incident projected image at a given intensity. It is further noted, that the surface area of input BTE 412 is much smaller than that of left output BTE 418 and right output BTE 420. Hence, image projector 426 can project an incident projected image much smaller than the incident projected images decoupled by each of left output BTE 418 and right output BTE 420.

The coupling efficiency of device 410 can be further improved, by employing an input-element light reflector similar to input-element light reflector 172 (FIG. 2). In this manner, the zero order light beam (not shown), which otherwise would have escaped out of light guide 422, is now reflected back to input BTE 412, wherein input BTE 412 couples a portion of the reflected zero order light beam into the light guide 422. This portion of the reflected zero order light beam, in addition to the “+1 order” and the “−1 order”, is used to transform the incident projected image.

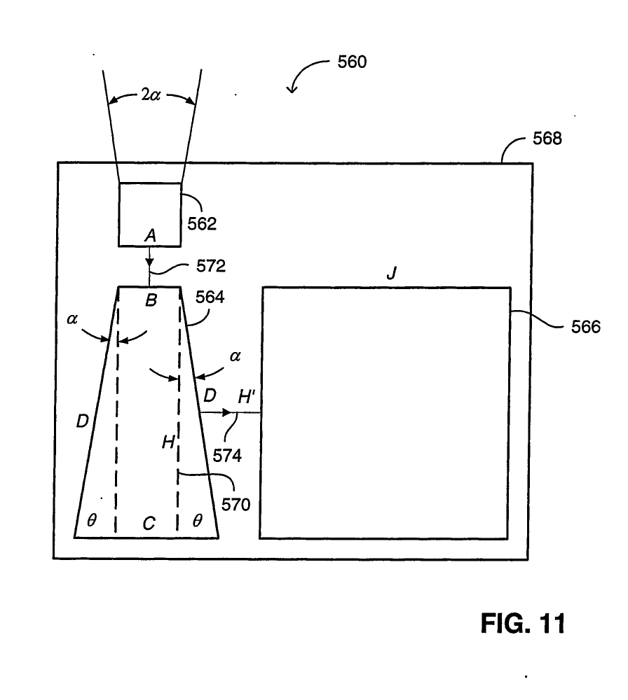

It is noted that to provide the same viewing properties, the lateral dimensions of output BTE 104 (FIG. 1A), have to be greater than that of each of left output BTE 418 and right output BTE 420. Furthermore, it is more difficult to construct a relatively large BTE than a small one, to produce a homogeneous (i.e., uniform) image, at a given output field of view. Thus, the construction of left output BTE 418 and right output BTE 420 is less difficult than that of output BTE 104. Furthermore, it is noted that the throughput efficiency of the quintuple arrangement of system 410 is larger than that of both the doublet arrangement of device 100 and the triplet arrangement of device 560 (as described herein below in connection with FIG. 11), for the same exit pupils.

Reference is now made to FIG. 9, which is a schematic illustration of a device for displaying a projected image against a background scene, generally referenced 470, constructed and operative in accordance with a further embodiment of the disclosed technique. Device 470 includes an input BTE 472, a left intermediate BTE 474, a right intermediate BTE 476, a left output BTE 478, a right output BTE 480 and a light guide 482.

The construction and operation of device 470 is similar to that of device 410, except that device 470 does not include any opaque shield similar to opaque shield 424. An image projector 484 projects an incident projected image on input BTE 472, and left output BTE 478 and right output BTE 480 decouple light beams respective of identical projected images to be viewed by a left eye 486 and a right eye 488 of an observer (not shown), respectively, in split biocular manner. Left eye 486 and right eye 488 receive light beams 490 and 492, respectively, through at least a portion of left output BTE 478, right output BTE 480 and light guide 482, respective of an object 494. Thus, the observer obtains a split biocular view of the an image representing the incident projected image, against the image of object 494 (e.g., a scene). Device 470 can be incorporated with a windshield of a vehicle, such as aircraft (e.g., airplane, helicopter), marine vessel (e.g., ship, submarine), space vehicle, ground vehicle (e.g., motorcycle, automobile, truck), and the like.

Alternatively, a variable transmitter (not shown) is located between object 494 and device 470. The variable transmitter varies the intensity of light beams 490 and 492, thereby enabling to vary the contrast between the set of output coupled projected images and an image (not shown) of object 494, as detected by left eye 486 and right eye 488. The variable transmitter is similar to the variable transmitter described in PCT application number PCT/IL03/00111 which is herein incorporated by reference, and the like. It is noted that the left eye can be replaced by two eyes (not shown) of a first observer (not shown), and the right eye can be replaced by two eyes (not shown) of a second observer (not shown).

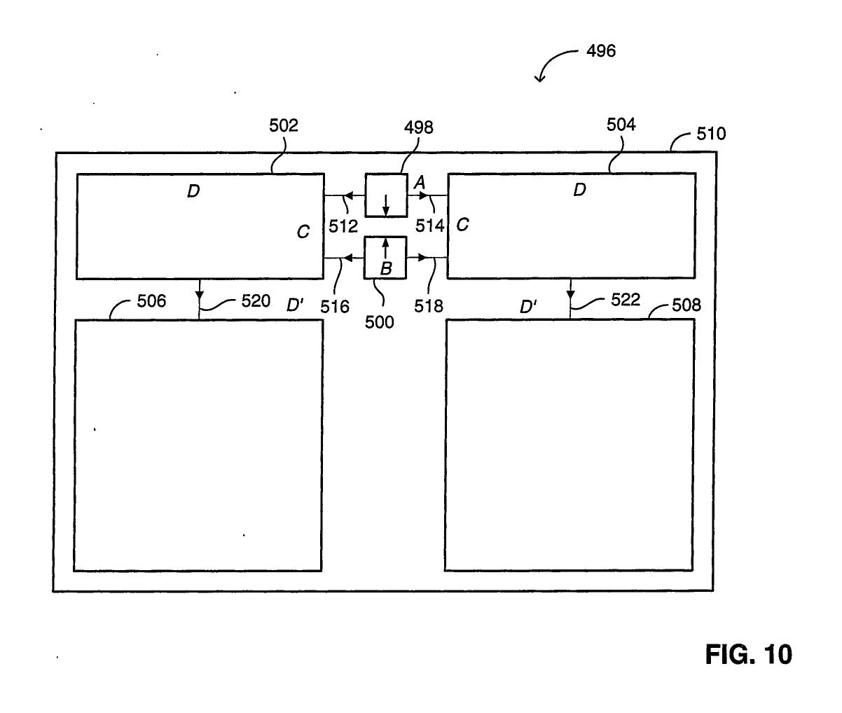

Reference is now made to FIG. 10, which is a schematic illustration of a device, generally referenced 496, for displaying a superimposition of a plurality of images, constructed and operative in accordance with another embodiment of the disclosed technique. Device 496 is an image fusion device. Device 496 includes an input BTE 498, an input BTE 500, a left intermediate BTE 502, a right intermediate BTE 504, a left output BTE 506, a right output BTE 508 and a light guide 510. Device 496 is similar to device 470 (FIG. 9), except that input BTE 472 is replaced by input BTE 498 and input BTE 500.

Each of input BTE 498, input BTE 500, left intermediate BTE 502, and right intermediate BTE 504, is symmetric. Alternatively, each of input BTE 498, input BTE 500, left intermediate BTE 502, and right intermediate BTE 504, is asymmetric. Each of left output BTE 506 and right output BTE 508 is asymmetric. Alternatively, each of left output BTE 506 and right output BTE 508 is symmetric.

The groove depth of each of input BTE 498 and input BTE 500 is uniform. Alternatively, the groove depth of each of input BTE 498 and input BTE 500 is non-uniform. The groove depth of each of left intermediate BTE 502, right intermediate BTE 504, left output BTE 506 and right output BTE 508 is non-uniform. The spatial frequencies and the grating shapes of input BTE 498, input. BTE 500, left output BTE 506 and right output BTE 508 are identical. Alternatively, the spatial frequencies and the grating shapes of input BTE 498, input BTE 500, left output BTE 506 and right output BTE 508 are different. However, the frequency of each of left intermediate BTE 502 and right intermediate BTE 504 is larger than that of input BTE 502 and input BTE 504, by a factor of √2.

Input BTE 498, input BTE 500, left intermediate BTE 502, right intermediate BTE 504, left output BTE 506 and right output BTE 508 are located on the same plane. Alternatively, each of input BTE 498, input BTE 500, left intermediate BTE 502, right intermediate BTE 504, left output BTE 506 and right output BTE 508 are located on opposite planes (not shown). Input BTE 498 and input BTE 500 are located along a first axis (not shown) and separated by a gap B. Input BTE 498, input BTE 500, left intermediate BTE 502 and right intermediate BTE 504 are located along a second axis (not shown) perpendicular to the first axis.

The lateral dimension of each of input BTE 498 and input BTE 500 in a direction along the first axis is A. The contour of each of left intermediate BTE 502 and right intermediate BTE 504 is a rectangle having a width C, and a length D, where,
C≧2A+B (7)

The contour of each of left output BTE 506 and right output BTE 508 is a rectangle whose side (adjacent to left intermediate BTE 502 and right intermediate BTE 504, respectively) is equal to D′, where,
D′≧D (8)

Left intermediate BTE 502 and left output BTE 506 are located along a third axis (not shown), perpendicular to the second axis. Right intermediate BTE 504 and right output BTE 508 are located along a fourth axis (not shown), perpendicular to the second axis.

The microgroove direction of each of input BTE 498 and input BTE 500 is along the first axis. The microgroove direction of left intermediate BTE 502 is 45 degrees clockwise, relative to the microgroove direction of each of input BTE 498 and input BTE 500. The microgroove direction of right intermediate BTE 504 is 45 degrees counterclockwise relative to the microgroove direction of each of input BTE 498 and input BTE 500. The microgroove direction of each of left output BTE 506 and right output BTE 508 is normal to the microgroove direction of each of input BTE 498 and input BTE 500.

A first image projector (not shown) projects a first incident light beam (not shown) respective of a first incident projected image (not shown), toward input BTE 498. A second image projector (not shown) projects a second incident light beam (not shown) respective of a second incident projected image (not shown), toward input BTE 500. Input BTE 498 couples the first incident light beam into light guide 510, as coupled light beams 512 and 514 respective of the first image, which propagate by TIR toward left intermediate BTE 502 and right intermediate BTE 504, respectively. Input BTE 500 couples the second incident light beam into light guide 510, as coupled light beams 516 and 518 respective of the second image, which propagate by TIR toward left intermediate BTE 502 and right intermediate BTE 504, respectively. Left intermediate BTE 502 spatially transforms coupled light beams 512 and 516 within light guide 510, as a coupled light beam 520, which propagates by TIR toward left output BTE 506. Right intermediate BTE 504 spatially transforms coupled light beams 514 and 518 within light guide 510, as a coupled light beam 522, which propagates by TIR toward right output BTE 508. Left output BTE 506 decouples coupled light beam 520 out of light guide 510, as a decoupled light beam (not shown) respective of a sensor fused image of the first incident projected image and the second incident projected image. Right output BTE 508 decouples coupled light beam 522 out of light guide 510, as a decoupled light beam (not shown) respective of a sensor fused image of the first incident projected image and the second incident projected image.

It is noted that additional input BTE units similar to input BTE 498 and input BTE 500, can be arranged along the first axis. In this case, each one of the image projectors projects a respective incident light beam toward the respective input BTE. Each input BTE couples the respective incident light beam, into respective coupled light beams, toward the left intermediate BTE and the right intermediate BTE, respectively. Each of the left intermediate BTE and right intermediate BTE spatially transforms the respective coupled light beams, into other coupled light beams toward the left output BTE and right output BTE, respectively. The coupled light beams reaching the left output BTE and the right output BTE, include information respective of all the incident light beams. Each of the left output BTE and the right output BTE, then decouples the respective coupled light beams to a set of decoupled light beams, out of the light guide. The decoupled light beams are respective of a sensor fused image, wherein the sensor fused image is respective of the incident projected images. It is further noted that an opaque shield similar to opaque shield 424 (FIG. 9), can be incorporated with device 496.

Alternatively, input BTE 498 and input BTE 500 can be replaced by a single input BTE (not shown), similar to either one of input BTE 498 or input BTE 500. Further alternatively, the contour of each of the right intermediate BTE and the left intermediate BTE can be a trapezoid (e.g., equilateral trapezoid, right angle trapezoid, or irregular trapezoid) which tapers out from a base equal to a side of the input BTE, as described herein below in connection with FIG. 11.

Reference is now made to FIG. 11, which is a schematic illustration of a device, generally referenced 560, for displaying an image constructed and operative in accordance with a further embodiment of the disclosed technique. Device 560 includes an input BTE 562, an intermediate BTE 564, an output BTE 566 and a light guide 568. Input BTE 562, intermediate BTE 564 and output BTE 566 are incorporated with light guide 568. Input BTE 562, intermediate BTE 564 and output BTE 566 are located on a plane (not shown). Input BTE 562 and intermediate BTE 564 are located on a first axis (not shown). Intermediate BTE 564 and output BTE 566 are located on a second axis (not shown). For convenience, the second axis is perpendicular to the first axis. This arrangement of input BTE 562, intermediate BTE 564 and output BTE 566, is herein below referred to as “triplet”.

The contour of input BTE 562 is a rectangle having a lateral dimension (adjacent to intermediate BTE 564) of A. The contour of intermediate BTE 564 is an equilateral trapezoid having a short base B, a long base C, two equal sides D, and a height H, where,
B≧A (9)

A rectangle within intermediate BTE 564 of width B and length H is referenced 570. The angle between each of the two sides D and the long base C, is referenced θ. Input BTE 562 and intermediate BTE 564 are located in such positions, that the short base B of intermediate BTE 564 is closest to side A of input BTE 562. The contour of output BTE 566 is a rectangle having sides H′ and J, where,
H′≧H (10)

Input BTE 562 is asymmetric, the groove depth thereof is uniform and the spatial frequency thereof is of such a value to allow a coupled light beam 572 to propagate within light guide 568 toward intermediate BTE 564 by TIR. Alternatively, input BTE 562 is symmetric and the groove depth thereof is non-uniform. Intermediate BTE 564 is symmetric, the groove depth thereof is non-uniform and the spatial frequency thereof is greater than that of input BTE 562 by a factor typically of 42. Alternatively, intermediate BTE 564 is asymmetric and the groove depth thereof is uniform. Output BTE 566 is asymmetric, the groove depth thereof is non-uniform and the spatial frequency thereof is identical with that of input BTE 562. Alternatively, output BTE 566 is symmetric, the groove depth thereof is uniform and the spatial frequency thereof is different than that of input BTE 562.

The microgroove direction of input BTE 562 is along the first axis. The microgroove direction of intermediate BTE 564 is 45 degrees counterclockwise relative to the microgroove direction of input BTE 562. The microgroove direction of output BTE 566 is normal to the microgroove direction of input BTE 562.

An image projector (not shown) projects an incident light beam respective of an incident projected image (not shown) toward input BTE 562. The input FOV of this incident projected image is represented by a total angle of 2α, where,
θ=90 −α (11)

Input BTE 562 couples the incident light beam into light guide 568, as coupled light beam 572. Intermediate BTE 564 spatially transforms coupled light beam 572 into a coupled light beam 574, toward output BTE 566. If the contour of the intermediate BTE was similar to rectangle 570, then those portions of coupled light beam 572 which propagate along the intermediate BTE within angle α from each side H of rectangle 570, would not be included in coupled light beam 574 and hence would be wasted. The trapezoidal contour of intermediate BTE 564 having the parameters described herein above, allows intermediate BTE 564 to collect the entire power of coupled light beam 572 (i.e., including those portions which would otherwise be wasted) and to deflect all portions of coupled light beam 572, as coupled light beam 574, to output BTE 566. It is noted that either a scene-image reflector similar to scene-image reflector 108 (FIG. 1A) or an opaque shield similar to opaque shield 424 (FIG. 9), can be incorporated with device 560.

The trapezoidal contour of intermediate BTE 564 allows a more efficient light beam collection and transformation mechanism, than for example, in the case of either intermediate BTE's 414 and 416 (FIG. 8A). Hence, an image display source or an image projector having a substantially wide field of view, can be employed with device 560. Thus, in the embodiments of the disclosed technique described herein above or herein below, it is possible to employ an intermediate BTE whose contour is trapezoidal or another contour which allows an efficient light beam collection.

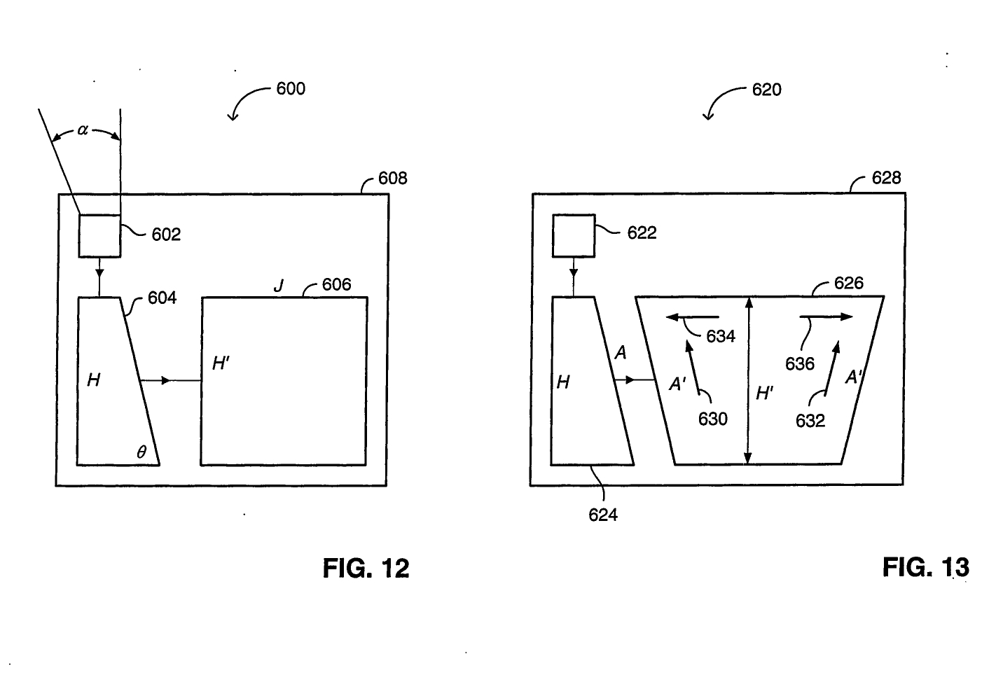

Reference is now made to FIG. 12, which is a schematic illustration of a device, generally referenced 600, for displaying an image constructed and operative in accordance with another embodiment of the disclosed technique. Device 600 includes an input BTE 602, an intermediate BTE 604, an output BTE 606 and a light guide 608. Device 600 is similar to device. 560 (FIG. 11), except that the contour of intermediate BTE 604 is a right angle trapezoid having a height H. Thus, the contour of intermediate BTE 604 can be in form of a square, rectangle, equilateral trapezoid, right angle trapezoid, irregular trapezoid, as well as ellipse, and the like. The contour of output BTE 606 is a rectangle whose sides are equal to H′ by J, where,
H′≧H (12)

An image projector (not shown) projects an incident light beam (not shown) respective of an incident projected image (not shown) toward input BTE 602. Part of the incident light beam are normal to input BTE 602 (i.e., projected at zero angle of incidence) and other parts of the incident light beam are projected at a non-zero incidence angle α. The angle between the sloping leg of intermediate BTE 604 and the long base thereof,
θ=90 −α (13)

Input BTE 602 couples the incident light beam into a coupled light beam (not shown) toward intermediate BTE 604. Intermediate BTE 604 collects those portions of the coupled light beam respective of those portions of the incident light beam which are projected toward input BTE 602 at incidence angle α. Intermediate BTE 604 also collects those portions of the coupled light beam respective of those portions of the incident light beam, which are projected toward input BTE 602 at zero angle of incidence. Intermediate BTE 604 spatially transforms the coupled light beams into other coupled light beams toward output BTE 606.

It is noted that the configuration of device 600 is chosen such as to allow an efficient packaging of input BTE 602, intermediate BTE 604 and output BTE 606 on light guide 608, so as to minimize the overall area of light guide 608. It is noted that either a scene-image reflector similar to scene-image reflector 108 (FIG. 1A) or an opaque shield similar to opaque shield 424 (FIG. 9), can be incorporated with device 600.

Reference is now made to FIG. 13, which is a schematic illustration of a device, generally referenced 620, constructed and operative in accordance with a further embodiment of the disclosed technique. Device 620 includes an input BTE 622, an intermediate BTE 624, an output BTE 626 and a light guide 628. Device 620 is similar to device 600 (FIG. 12), except that the contour of output BTE 626 is an equilateral trapezoid. Alternatively, the output BTE can be in form of any irregular trapezoid.

The contour of intermediate BTE 624 is a right angle trapezoid having a sloping leg A, and a height H. Each of the two legs of output BTE 626 is A′, and the height thereof is H′, where,
A′≧A (14)
and
H′≧H (15)

Intermediate BTE 624 and output BTE 626 are located in such positions, that the sloping leg of intermediate BTE 624 is parallel or closely parallel with one leg of output BTE 626. It is noted that the configuration of device 620 is chosen such as to allow an efficient packaging of input BTE 622, intermediate BTE 624 and output BTE 626 on light guide 628, so as to minimize the overall area of light guide 628.

The operation of input BTE 622 and intermediate BTE 624 are similar to those of input BTE 602 (FIG. 12) and intermediate BTE 604, respectively, as described herein above. The lateral dimensions of output BTE 626 is greater than that of output BTE 606 (FIG. 12), and this with or without a minimal increase of the lateral dimensions of light guide 628 as compared to light guide 608 (FIG. 12). Hence, the range of movements of an observer moving relative to device 620 is larger than that of device 600 (FIG. 12), in directions referenced by arrows 630, 632, 634 and 636. Furthermore, output BTE 626 decouples coupled light beams out of light guide 628, respective of additional output decoupled images, in the directions of arrows 630, 632, 634 and 636. It is noted that either a scene-image reflector similar to scene-image reflector 108 (FIG. 1A) or an opaque shield similar to opaque shield 424 (FIG. 9), can be incorporated with device 620.

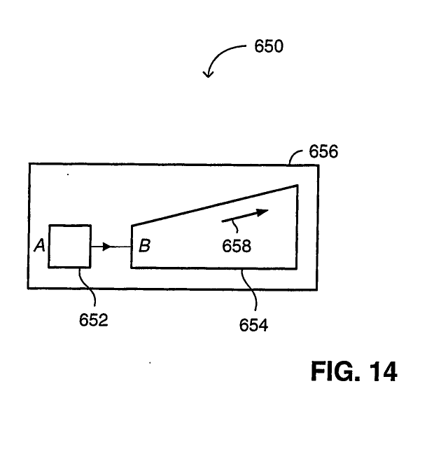

Reference is now made to FIG. 14, which is a schematic illustration of a device, generally referenced 650, for displaying an image constructed and operative in accordance with another embodiment of the disclosed technique. Device 650 includes an input BTE 652, an output BTE 654 and a light guide 656. Device 650 is similar to device 100 (FIG. 1A), except that the contour of output BTE 654 is a right angle trapezoid. Hence, output BTE 654 collects additional portions of the set of coupled light beams which input BTE 652 couples into light guide 656 toward output BTE 654, in directions different from a central axis (not shown) between input BTE 652 and output BTE 654. The contour of input BTE 652 is a rectangle of a side A. A short base of output BTE 654 is B, where,
B≧A (16)

The range of movements of an observer (not shown) moving in a direction referenced by an arrow 658, is greater than that of device 100. It is noted that either a scene-image reflector similar to scene-image reflector 108 (FIG. 1A) or an opaque shield similar to opaque shield 424 (FIG. 9), can be incorporated with device 650.

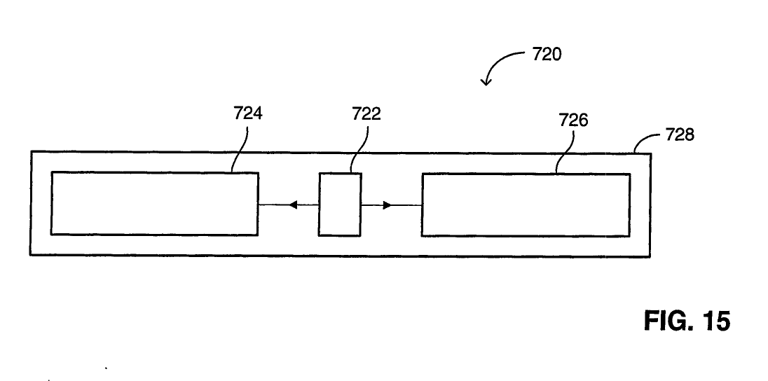

Reference is now made to FIG. 15, which is a schematic illustration of a device, generally referenced 720, for displaying an image constructed and operative in accordance with a further embodiment of the disclosed technique. Device 720 includes an input BTE 722, a left output BTE 724, a right output BTE 726 and a light guide 728. The shape of the microgrooves of input BTE 722 is symmetric, so as to distribute the intensity of the displayed image equally between right output BTE 726 and left output BTE 724. Alternatively, the shape of the microgrooves of input BTE 722 is asymmetric. Each of right output BTE 726 and left output BTE 724 is asymmetric while the respective microgroove depth varies along the optical axis. Alternatively, each of right output BTE 726 and left output BTE 724 is symmetric.

The arrangement illustrated in FIG. 15, allows a first observer (not shown) and a second observer (not shown), to obtain biocular views of an image representing the same incident projected image, by looking simultaneously at left output BTE 724 and right output BTE 726, respectively. Alternatively, by setting the distance between left output BTE 724 and right output BTE 726, and the distance between device 720 and the observer, appropriately, it is possible for only one observer to obtain a split biocular view of an image representing the incident projected image. It is noted that an opaque shield similar to opaque shield 424 (FIG. 9), can be incorporated with device 720. Further alternatively, the contour of each of the right output BTE and the left output BTE can be a trapezoid (e.g., equilateral trapezoid, right angle trapezoid, or irregular trapezoid).

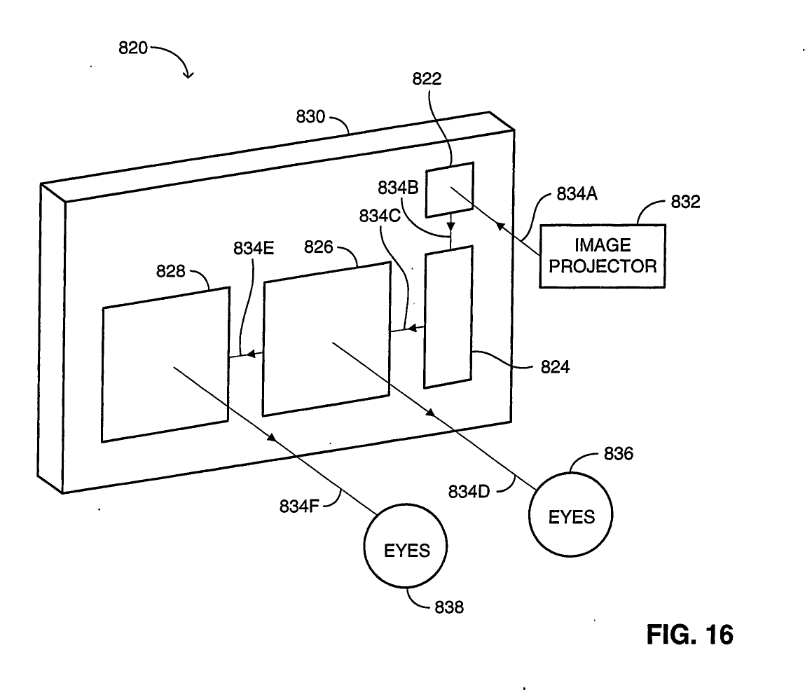

Reference is now made to FIG. 16, which is a schematic illustration of a device, generally referenced 820, for displaying an image, constructed and operative in accordance with another embodiment of the disclosed technique. Device 780 includes an input BTE 822, an intermediate BTE 824, a right output BTE 826, a left output BTE 828 and a light guide 790.

Input BTE 822, intermediate BTE 824, right output BTE 826 and left output BTE 828 are incorporated with light guide 830. Input BTE 822, intermediate BTE 824, right output BTE 826 and left output BTE 828 are located on a plane (not shown). Input BTE 822 and intermediate BTE 824 are located along a first axis (not shown). Intermediate BTE 824, right output BTE 826 and left output BTE 828 are located along a second axis (not shown), perpendicular to the first axis. Right output BTE 826 is located between intermediate BTE 824 and left output BTE 828. This arrangement of input BTE 822, intermediate BTE 824, right output BTE 826 and left output BTE 828, is herein below referred to as “tetra formation”.

The microgroove direction of input BTE 822 is along the first axis. The microgroove direction of intermediate BTE 824 is 45 degrees clockwise relative to the microgroove direction of input BTE 822. The microgroove direction of each of right output BTE 826 and left output BTE 828 is normal to the microgroove direction of input BTE 562.

An image projector 832 projects an incident light beam 834A respective of an incident projected image (not shown), toward input BTE 822. Input BTE 822 couples incident light beam 834A as a coupled light beam 834B, toward intermediate BTE 824, through light guide 830 by TIR.

Intermediate BTE 824 spatially transforms coupled light beam 834B into a coupled light beam 834C toward right output BTE 826, through light guide 830 by TIR. Right output BTE 826 decouples part of coupled light beam 834C as a decoupled light beam 834D out of light guide 830, toward eyes 836 of a first observer (not shown). Right output BTE 826 transmits another portion of coupled light beam 834C as a coupled light beam 834E, toward left output BTE 828, through light guide 830, by TIR. Left output BTE 828 decouples coupled light beam 834E as a decoupled light beam 834F, out of light guide 830 toward eyes 838 of a second observer (not shown). Thus, each of the first observer and the second observer simultaneously obtains a biocular view of an image representing the incident projected image, by looking at right output BTE 826 and left output BTE 828, respectively.

Alternatively, eyes 836 and 838 can represent the eyes (not shown) of one observer (not shown). In this case, the distance (not shown) between right output BTE 826 and left output BTE 828, and the distance (not shown) between device 820 and the observer can be set, for the observer to obtain a split biocular view of an image representing the incident projected image. It is noted that an opaque shield similar to opaque shield 424 (FIG. 9); can be incorporated with device 820. It is further noted that the right output BTE and the left output BTE can be regarded as two regions of a single output BTE.

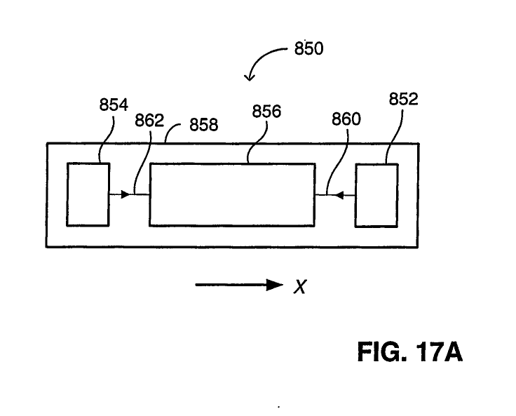

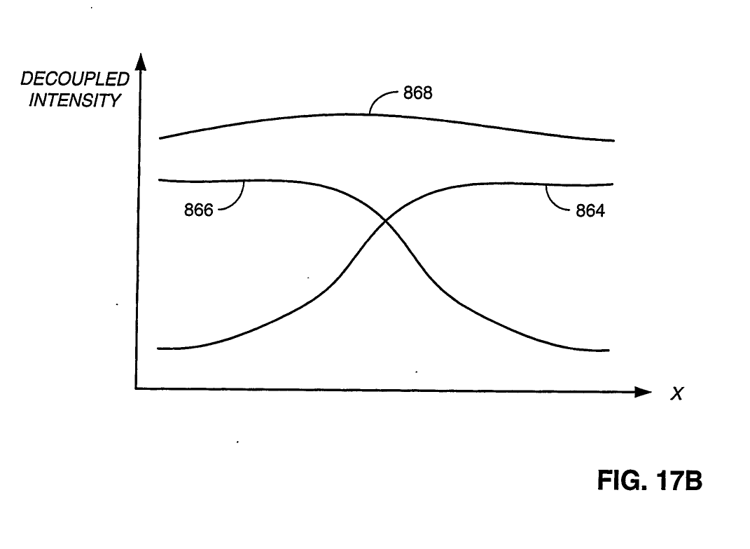

Reference is now made to FIGS. 17A and 17B. FIG. 17A is a schematic illustration of a device, generally referenced 850, for displaying a superimposition of two images, constructed and operative in accordance with a further embodiment of the disclosed technique. FIG. 17B is a schematic illustration of a graph of the variation of decoupled intensities of the output BTE of the device of FIG. 17A, respective of two counter-propagating light beams within the light guide of the device of FIG. 17A, along the output BTE. Device 850 is an image fusion device.

With reference to FIG. 17A, device 850 includes an input BTE 852, an input BTE 854, an output BTE 856 and a light guide 858. Each of input BTE 852 and input BTE 854 is an asymmetric BTE. Alternatively, each of input BTE 852 and input BTE 854 is a symmetric BTE. Output BTE 856 is a symmetric BTE. Alternatively, output BTE 856 is an asymmetric BTE. The groove depth of each of input BTE 852 and input BTE 854 is uniform. The groove depth of output BTE 856 is non-uniform. The spatial frequencies of input BTE 852, input BTE 854 and output BTE 856 are identical. Alternatively, the spatial frequencies of input BTE 852, input BTE 854 and output BTE 856 are different.

Input BTE 852, input BTE 854 and output BTE 856 are located on the same plane (not shown) and along the same axis (not shown). Alternatively, each of input BTE 852, input BTE 854 and output BTE 856 are located on opposite planes (not shown). Input BTE 852 is located at one side of output BTE 856 and input BTE 854 is located at the other side of output BTE 856. A first image projector (not shown) projects a first incident light beam (not shown) respective of a first incident projected image (not shown), toward input BTE 852. A second image projector. (not shown) projects a second incident light beam (not shown) respective of a second incident projected image (not shown), toward input BTE 854.

Input BTE 852 couples the first incident light beam into light guide 858 by TIR, as a coupled light beam 860, toward output BTE 856. Input BTE 854 couples the second incident light beam into light guide 858 by TIR, as a coupled light beam 862, toward output BTE 856. Since coupled light beams 860 and 862 propagate within light guide 858 in opposite directions, they form a set of counter-propagating coupled light beams. Output BTE 856 decouples coupled light beams 860 and 862 out of light guide 858, as decoupled light beams (not shown), at output angles corresponding to each of the incidence angles of the first incident light beam and the second incident light beam, respectively. Thus, an observer (not shown) obtains a biocular view of a sensor fused image of the first incident projected image and the second incident projected image.

Generally, the first incident projected image and the second incident projected image are different. For example, the first incident projected image can be an image of a scene, while the second incident projected image is that of a number. In this case, the observer obtains a binocular view of the first incident projected image and the second incident projected image. In case the first incident projected image and the second incident projected image are images of the same object looking from different directions, the observer obtains a stereoscopic view of the object, which is a special case of binocular view. In the discussion herein below, the term local diffraction efficiency (DE) refers to the ratio of the amount of light which exits a BTE at a certain location, and the amount of light which enters the BTE at this location.

With reference to FIG. 17B, a curve 864 is a plot of the variation of the decoupled intensity of output light along the X axis of output BTE 856, originating from coupled light beam 860. A curve 866 is a plot of the variation of the decoupled intensity of output light along the X axis of output BTE 856, originating from coupled light beam 862. A curve 868 represents the sum of curves 864 and 866 along output BTE 856 (i.e., curve 868 represents the variation of the total light intensity detected by the eyes—not shown—of an observer), along the X axis. Thus, the eyes detect an image whose intensity is substantially uniform across all regions of output BTE 856. The local diffraction efficiency along the X axis of output BTE 856 increases towards the center of output BTE 856, and decreases towards the edges of output BTE 856. Thus, either a binocular or a stereoscopic image is obtained. It is noted that either a scene-image reflector similar to scene-image reflector 108 (FIG. 1A) or an opaque shield similar to opaque shield 424 (FIG. 9), can be incorporated with device 850.

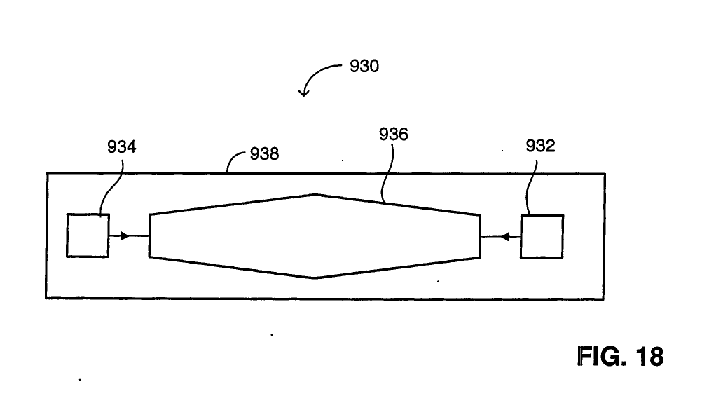

Reference is now made to FIG. 18, which is a schematic illustration of a device, generally referenced 930, for displaying a superimposition of two images constructed and operative in accordance with another embodiment of the disclosed technique. Device 930 is an image fusion device. Device 930 includes an input BTE 932, an input BTE 934, an output BTE 936 and a light guide 938. Device 930 is similar to device 850 (FIG. 17A), except that the contour of output BTE 936 is in form of an elongated hexagon (i.e., a six sided polygon). Alternatively, the contour of the output BTE can be an octagon (i.e., eight sided polygon). It is noted that either a scene-image reflector similar to scene-image reflector 108 (FIG. 1A) or an opaque shield similar to opaque shield 424 (FIG. 9), can be incorporated with device 930.

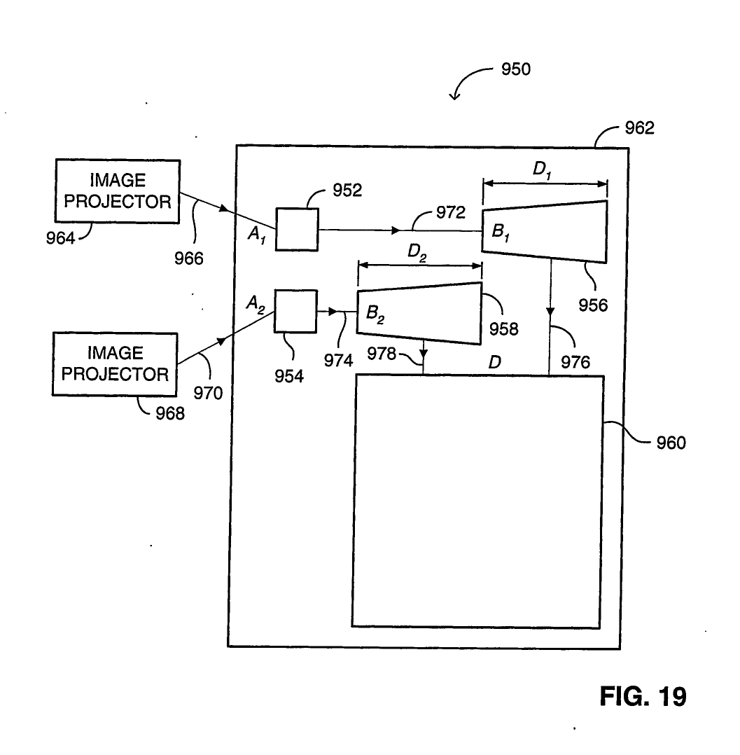

Reference is now made to FIG. 19, which is a schematic illustration of a device, generally referenced 950, for displaying a superimposition of a plurality of images, constructed and operative in accordance with a further embodiment of the disclosed technique. Device 950 is an image fusion device. Device 950 includes an input BTE 952, an input BTE 954, a right intermediate BTE 956, a left intermediate BTE 958, an output BTE 960 and a light guide 962.

Each of input BTE 952, input BTE 954 and output BTE 960 is asymmetric. Alternatively, each of input BTE 952, input BTE 954 and output BTE 960 is symmetric. The groove depth of each of input BTE 952 and input BTE 954 is uniform. The groove depth of each of right intermediate BTE 956, left intermediate BTE 958 and output BTE 960 is non-uniform. The spatial frequencies of input BTE 952, input BTE 954 and output BTE 960 are identical. Alternatively, the spatial frequencies of input BTE 952, input BTE 954 and output BTE 960 are different. The spatial frequency of each of right intermediate BTE 956 and left intermediate BTE 958 is larger than that of input BTE 952, input BTE 954 and output BTE 960, by a factor of √2.

Input BTE 952, input BTE 954, right intermediate BTE 956, left intermediate BTE 958 and output BTE 960 are located on the same plane. Alternatively, each of input BTE 952, input BTE 954, right intermediate BTE 956, left intermediate BTE 958 and output BTE 960 are located on opposite planes (not shown). The contour of input BTE 952 is a rectangle of a side A₁. The contour of input BTE 954 is a rectangle of a side A₂. The contour of right intermediate BTE 956 is a trapezoid having a short base B₁ and a height D₁, where,
B₁≧A₁ (17)
The contour of left intermediate BTE 958 is a trapezoid having a short base B₂ and a height D₂, where,
B₂≧A₂ (18)

Input BTE 952 and input BTE 954 are located along a first axis (not shown). Input BTE 952 and right intermediate BTE 956 are located along a second axis (not shown) perpendicular to the first axis. Input BTE 954 and left intermediate BTE 958 are located along a third axis (not shown) perpendicular to the first axis. Alternatively, input BTE 952 and input BTE 954 are not located along the first axis, as long as input BTE 952 and right intermediate BTE 956 are located along the second axis, and input BTE 954 and left intermediate BTE 958 are located along the third axis.

The contour of output BTE 960 is a rectangle whose side adjacent to right intermediate BTE 956 and left intermediate BTE 958 is equal to D. The lengths of D₁ and D₂ and their relative positions are chosen such that their total or overlapping length is equal to or smaller than D. Right intermediate BTE 956 and output BTE 960 are located along a fourth axis (not shown). Left intermediate BTE 958 and output BTE 960 are located along a fifth axis (not shown). The fourth axis and the fifth axis are parallel to each other, but respectively perpendicular to the second axis and the third axis.

The microgroove direction of each of input BTE 952 and input BTE 954 is along the first axis. The microgroove direction of each of right intermediate BTE 956 and left intermediate BTE 958 is 45 degrees counterclockwise relative to the microgroove direction of each of input BTE 952 and input BTE 954. The microgroove direction of output BTE 960 is normal to the microgroove direction of each of input BTE 952 and input BTE 954.

An image projector 964 projects an incident light beam 966 respective of a first incident projected image (not shown), toward input BTE 952. An image projector 968 projects an incident light beam 970 respective of a second incident projected image (not shown), toward input BTE 954. Input BTE 952 and input BTE 954 couple incident light beams 966 and 970, respectively, into coupled light beams 972 and 974, respectively, toward right intermediate BTE 956 and left intermediate BTE 958, respectively. Right intermediate BTE 956 spatially transforms coupled light beam 972 into a coupled light beam 976, toward output BTE 960. Left intermediate BTE 958 spatially transforms coupled light beam 974 into a coupled light beam 978, toward output BTE 960.

Right intermediate BTE 956 collects information respective of those portions of incident light beam 966, which image projector 964 projects toward input BTE 952, at zero angle of incidence, as well at non-zero angles of incidence. Left intermediate BTE 958 collects information respective of those portions of incident light beam 970, which image projector 968 projects toward input BTE 954, at zero angle of incidence, as well at non-zero angles of incidence.

Output BTE 960 decouples coupled light beam 976 and 978 out of light guide 962, as a decoupled light beam (not shown), toward the eyes (not shown) of an observer (not shown). Thus, the observer can perceive a sensor fused image of the first incident projected image and the second incident projected image (i.e., a biocular image, binocular image or a stereoscopic image).

It is noted that additional input BTE units similar to input BTE 952 and input BTE 954, can be arranged along the first axis. Similarly, additional intermediate BTE units similar to right intermediate BTE 956 and left intermediate BTE 958 can be arranged in the same manner with respect to the input BTE units and the output BTE. In this case, each one of other image projectors similar to image projectors 964 and 968, projects a respective incident light beam toward the respective input BTE. Each input BTE couples the respective incident light beam to a respective coupled light beam to the respective additional intermediate BTE. Each of the additional intermediate BTEs spatially transforms the respective coupled light beam, into another respective coupled light beam, toward the output BTE. The output BTE decouples the coupled light beams out of the light guide, as a decoupled light beam respective of a sensor fused image, wherein the sensor fused image is respective of the incident projected images. It is further noted that either a scene-image reflector similar to scene-image reflector 108 (FIG. 1A) or an opaque shield similar to opaque shield 424 (FIG. 9), can be incorporated with device 950.

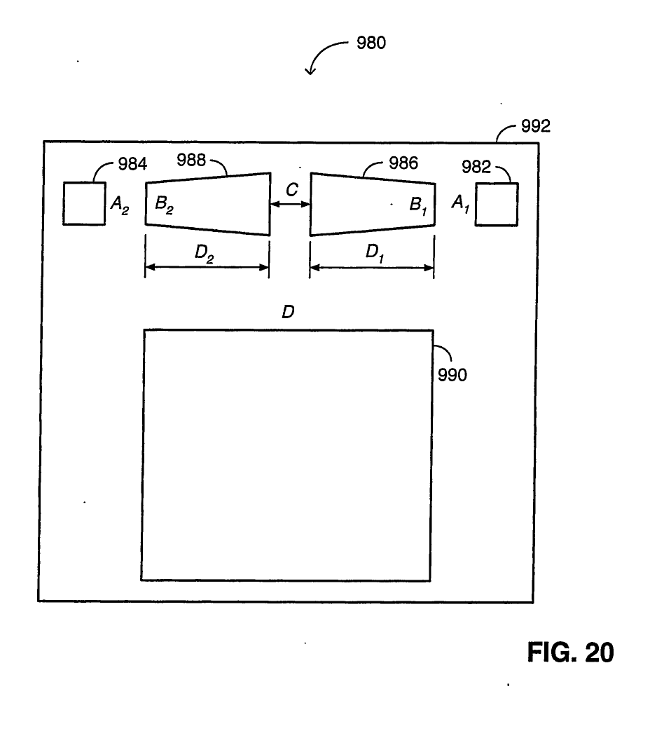

Reference is now made to FIG. 20, which is a schematic illustration of a device, generally referenced 980, for displaying a superimposition of a plurality of images, constructed and operative in accordance with another embodiment of the disclosed technique. Device 980 is an image fusion device. Device 980 includes a right input BTE 982, a left input BTE 984, a right intermediate BTE 986, a left intermediate BTE 988, an output BTE 990 and a light guide 992.

Right input BTE 982, left input BTE 984, right intermediate BTE 986, left intermediate BTE 988 and output BTE 990 are incorporated with light guide 992. Right input BTE 982, left input BTE 984, right intermediate BTE 986, left intermediate BTE 988 and output BTE 990 are located on the same plane. Alternatively, each of right input BTE 982, left input BTE 984, right intermediate BTE 986, left intermediate BTE 988 and output BTE 990 are located on opposite planes (not shown).

Right input BTE 982, left input BTE 984, right intermediate BTE 986 and left intermediate BTE 988 are located along a first axis. Alternatively, right input BTE 982, left input BTE 984, right intermediate BTE 986 and left intermediate BTE 988 are not located along the first axis. In this case, right input BTE 982 and right intermediate BTE 986 are located along a mutual axis, and left input BTE 984 and left intermediate BTE 988 are located along another mutual axis.

The contour of right input BTE 982 is a rectangle having a side A₁. The contour of right intermediate BTE 986 is a trapezoid, having a short base B₁ and a height D₁, where,
B₁≧A₁ (19)
The contour of left input BTE 984 is a rectangle having a side A₂. The contour of left intermediate BTE 988 is a trapezoid, having a short base B₂ and a height D₂, where,
B₂≧A₂ (20)

Right intermediate BTE 986 is located between right input BTE 982 and left intermediate BTE 988, such that the short base B₁ of right intermediate BTE 986 is adjacent to the side Al of right input BTE 982. Left intermediate BTE 988 is located between left input BTE 984 and right intermediate BTE 986, such that the short base B₂ of left intermediate BTE 988 is adjacent to the side A₂ of left input BTE 984.

The microgroove direction of each of right input BTE 982 and left input BTE 984 is perpendicular to the first axis. The microgroove direction of right intermediate BTE 986 is 45 degrees clockwise relative to the microgroove direction of right input BTE 982. The microgroove direction of left intermediate BTE 988 is 45 degrees counterclockwise relative to the microgroove direction of left input BTE 984. The microgroove direction of output BTE 990 is normal to the microgroove direction of each of right input BTE 982 and left input BTE 984.

Right intermediate BTE 986 and output BTE 990 are located along a second axis perpendicular to the first axis. Left intermediate BTE 988 and output BTE 990 are located along a third axis perpendicular to the first axis and parallel with the second axis. Right intermediate BTE 986 and left intermediate BTE 988 are separated by a gap C, where C can be zero. The contour of output BTE 990 is a rectangle having a side D, where,
D≧D₁+D₂+C (21)

Except the relative locations of right input BTE 982, left input BTE 984, right intermediate BTE 986, left intermediate BTE 988 and output BTE 990, device 980 is similar to device 950 (FIG. 19) and operates in a similar manner as described herein above. Hence, an observer (not shown) can obtain a sensor fused image biocular view, a binocular view, or a stereoscopic view, of a plurality of incident projected images, depending on the nature of the incident projected images. It is noted that either a scene-image reflector similar to scene-image reflector 108 (FIG. 1A) or an opaque shield similar to opaque shield 424 (FIG. 9), can be incorporated with device 980.

In accordance with a further aspect of the disclosed technique, a first input BTE and a first output BTE are incorporated with a first light guide and a second input BTE and a second output BTE are incorporated with a second light guide, together forming a projected-image displaying device. The first light guide is placed on the second light guide, such that the first input BTE and the second input BTE overlap, the first output BTE is located to one side of the first input BTE and the second input BTE, and the second output BTE is located to the other side of the first input BTE and the second input BTE.

When an image projector projects an incident light beam respective of a projected image on the first input BTE, the first input BTE couples a portion of the incident light beam into a first set of coupled light beams toward the first output BTE. The first input BTE transmits another portion of the incident light beam to the second input BTE. The second input BTE couples the remaining portion of incident light beam into a second set of coupled light beams toward the second output BTE.

The first output BTE and the second output BTE decouples the first set of the coupled light beams and the second set of the coupled light beams, respectively, out of the light guide toward a first observer and a second observer, respectively, depending on the position of the first observer and the second observer relative to the device. Thus, each of the first observer and the second observer simultaneously obtains a biocular view of an image representing the incident projected image, from the first output BTE and the second output BTE, respectively.

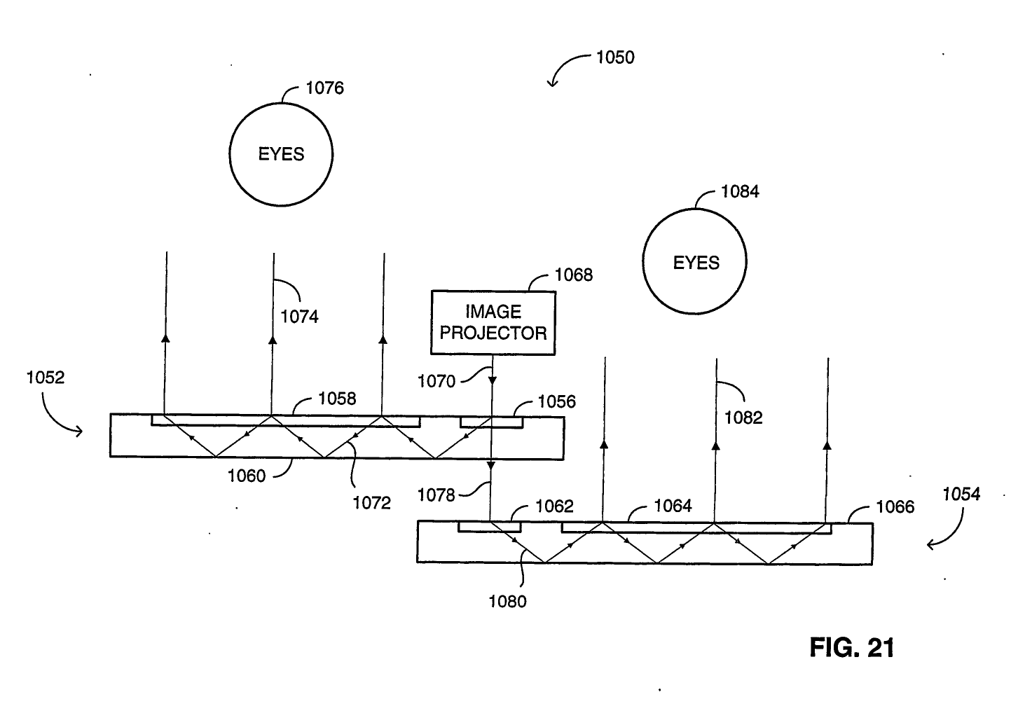

Reference is now made to FIG. 21, which is a schematic illustration of a device, generally referenced 1050, for displaying an image for two observers, constructed and operative in accordance with a further embodiment of the disclosed technique. Device 1050 includes a left displaying module 1052 and a right displaying module 1054. Left displaying module 1052 includes a first input BTE 1056, a left output BTE 1058, and a left light guide 1060. Right displaying module 1054 includes a second input BTE 1062, a right output BTE 1064 and a right light guide 1066. First input BTE 1056 and left output BTE 1058 are incorporated with left light guide 1060. Second input BTE 1062 and right output BTE 1064 are incorporated with right light guide 1066.

Each of first input BTE 1056 and second input BTE 1062 is asymmetric and the groove depth thereof is uniform. Each of left output BTE 1058 and right output BTE 1064 is asymmetric and the depth thereof is non-uniform. The spatial frequencies of first input BTE 1056 and left output BTE 1058 are identical. The spatial frequencies of second input BTE 1062 and right output BTE 1064 are identical.

First input BTE 1056 and left output BTE 1058 are located on a first plane (not shown) along a first axis (not shown). Second input BTE 1062 and right output BTE 1064 are located on a second plane (not shown) along a second axis (not shown). Left light guide 1060 is located on top of right light guide 1066, such that first input BTE 1056 overlaps second input BTE 1062. Left output BTE 1058 is located on one side of first input BTE 1056 and second input BTE 1062, and right output BTE 1064 is located on the other side of first input BTE 1056 and second input BTE 1062.

Left light guide 1060 and right light guide 1066 are separated by an air gap. Alternatively, left light guide 1060 and right light guide 1066 are directly attached to each other only in the region of first input BTE 1056 and second input BTE 1062, such that light beams can propagate, without disturbance, through each of left light guide 1060 and right light guide 1066 by TIR. In case the input BTE and the output BTE of a light guide similar to right light guide 1066, are located on a plane opposite to the second plane, it is possible to attach the left light guide and the right light guide directly, without any air gap there between.

An image projector 1068 is located in front of device 1050, facing the first plane. Image projector 1068 projects an incident light beam. 1070 respective of an incident projected image (not shown) toward first input BTE 1056. First input BTE 1056 couples part of incident light beam 1070 into a coupled light beam 1072, toward left output BTE 1058, through left light guide 1060 by TIR. Left output BTE 1058 decouples coupled light beam 1072 out of left light guide 1060, as a decoupled light beam 1074 respective of a left output decoupled image (not shown), toward eyes 1076 of a left side observer (not shown). The left output decoupled image represents the incident projected image.

First input BTE 1056 transmits another part of incident light beam 1070 as a light beam 1078 toward second input BTE 1062. Second input BTE 1062 couples light beam 1078 into a coupled light beam 1080 toward right output BTE 1064, through right light guide 1066 by TIR. Right output BTE 1064 decouples coupled light beam 1080 out of right light guide 1066, as a decoupled light beam 1082 respective of a right output decoupled image (not shown), toward eyes 1084 of a second observer (not shown). The right output decoupled image represents the incident projected image. Thus, each of the first observer and the second observer simultaneously obtains a biocular view of an image representing the incident projected image.

Alternatively, eyes 1076 represent the right eye (not shown) of an observer (not shown) and eyes 1082 represent the left eye (not shown) of the observer. In this case, the gap between left output BTE 1058 and right output BTE 1064, and the distance between device 1050 and the observer, are set such that the observer can obtain a split biocular view of an image which represents the incident projected image. It is noted, that beam transforming elements in addition to the input BTE and the output BTE in each displaying module can be incorporated with the respective light guide, thereby incorporating the beam transforming elements with the respective light guide, in a doublet, or a triplet arrangement.

In the example set forth in FIG. 21, image projector 1068 projects the incident light beam respective of the incident projected image toward device 1050 on-axis. Alternatively, the image projector projects the incident light beam off-axis.

Further alternatively, a device similar to device 1050 includes more than one image projector, wherein the device is an image fusion device. For example, in addition to an image projector similar to image projector 1068, a second image projector can be located behind the device, thereby projecting a respective incident light beam toward the second input BTE. It is noted that a scene-image reflector similar to scene-image reflector 108 (FIG. 1A), can be incorporated with a displaying module similar to displaying module 1054, such that the scene-image reflector overlaps with a right output BTE similar to right output BTE 1064. It is further noted that an opaque shield similar to opaque shield 424 (FIG. 9), can be incorporated with device 1050.

In accordance with another aspect of the disclosed technique, a first output BTE of a first width and a first input BTE are incorporated with a first light guide, and a second output BTE of a second width and a second input BTE are incorporated with a second light guide, together forming a projected-image displaying device. The first light guide is placed over the second light guide, such that the first input BTE and the second input BTE overlap, and the first output BTE and the second output BTE partially overlap, such that the first output BTE and the second output BTE together form an extended width, which is greater than each of the first width and the second width alone.

When an image projector projects an incident light beam respective of an incident projected image on the first input BTE, the first input BTE couples a portion of the incident light beam into a first set of coupled light beams, into the first light guide, toward the first output BTE. The first input BTE further transmits another portion of the incident light beam to the second input BTE. The second input BTE couples the remaining portion of the incident light beam into a second set of coupled light beams, into the second light guide, toward the second output BTE.

The first output BTE and the second output BTE decouple the first set of coupled light beams and the second set of coupled light beams, respectively, into a first set of decouple light beams and a second set of decoupled light beams, respectively, out of the first light guide and the second light guide, respectively, toward the eyes of an observer. The first set of decoupled light beams and the second set of decoupled light beams, are respective of a first set of output decoupled images and a second set of output decoupled images, respectively. Each of the first set of output decoupled image and the second set of output decoupled image represents the incident projected image. The first output BTE and the second output BTE are aligned, such that the observer obtains a biocular view of either one of the first set of output decoupled images or the second set of output decoupled images, depending on the position of the observer relative to the device, while moving in a direction parallel to the device, within the range of the extended width.

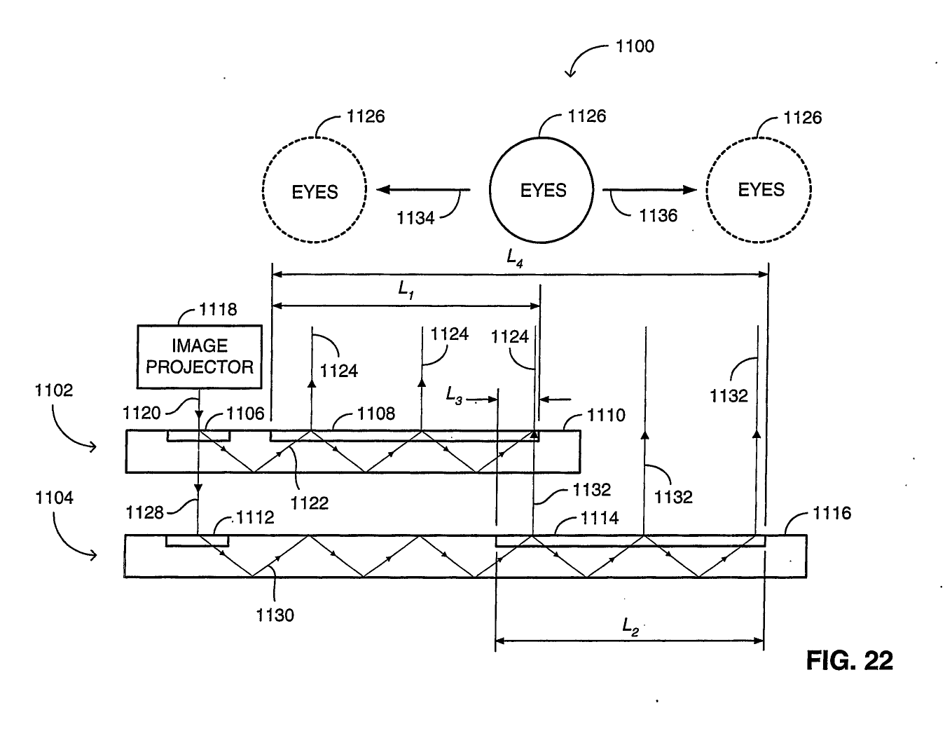

Reference is now made to FIG. 22, which is a schematic illustration of a device, generally referenced 1100, for displaying an image for an observer whose range of movement is substantially large, constructed and operative in accordance with another embodiment of the disclosed technique. Device 1100 includes displaying modules 1102 and 1104. Displaying module 1102 includes an input BTE 1106, an output BTE 1108 and a light guide 1110. Displaying module 1104 includes an input BTE 1112, an output BTE 1114 and a light guide 1116.

Each of input BTE 1106, input BTE 1112, output BTE 1108 and output BTE 1114 is asymmetric. Alternatively, each of input BTE 1106, input BTE 1112, output BTE 1108 and output BTE 1114 is symmetric. The groove depth of each of input BTE 1106 and input BTE 1112 is uniform. The groove depth of each of output BTE 1108 and output BTE 1114 is non-uniform. The spatial frequencies of input BTE 1106 and input BTE 1112 are identical. Alternatively, the spatial frequencies of input BTE 1106 and input BTE 1112 are different. The frequencies of input BTE 1106 and output BTE 1108 are identical. The frequencies of input BTE 1112 and output BTE 1114 are identical.

Input BTE 1106 and output BTE 1108 are incorporated with light guide 1110. Input BTE 1112 and output BTE 1114 are incorporated with light guide 1116. Input BTE 1106 and output BTE 1108 are located on a first plane (not shown) and along a first axis (not shown). Input BTE 1112 and output BTE 1114 are located on a second plane (not shown) and along a second axis (not shown). Output BTE 1108 has a lateral dimension of L₁, and output BTE 1114 has a lateral dimension of L₂. Furthermore, a portion of output BTE 1108 overlaps another portion of output BTE 1114, with the overlap length denoted by L₃.

Light guide 1110 is located on top of light guide 1116, such that the first plane is parallel with the second plane, and the first axis is parallel with the second axis. Light guides 1110 and 1116 are separated by an air gap. Alternatively, light guides 1110 and 1116 are directly attached to each other only in the region of input BTE 1106 and input BTE 1112, as described herein above in connection with left light guide 1060 (FIG. 21) and right light guide 1066.

An image projector 1118 is located in front of device 1100 facing the first plane. Image projector 1118 projects an incident light beam 1120 respective of an incident projected image (not shown) toward input BTE 1106. Input BTE 1106 couples a portion of incident light beam 1120 into light guide 1110, as a coupled light beam 1122, toward output BTE 1108. Output BTE 1108 decouples coupled light beam 1122 out of light guide 1110, as a decoupled light beam 1124, respective of a first set of output decoupled image (not shown), toward eyes 1126 of an observer (not shown).

Input BTE 1106 transmits another portion of incident light beam 1120 as a light beam 1128 toward input BTE 1112. Input BTE 1112 couples light beam 1128 into light guide 1116, as a coupled light beam 1130, toward output BTE 1114. Output BTE 1114 decouples coupled light beam 1130 out of light guide 1116, as a decoupled light beam 1132, respective of a second set of decoupled light beams (not shown), toward eyes 1126. The first set of decoupled light beams and the second set of decoupled light beams are respective of a first set of output decoupled images and a second set of output decoupled images, respectively. Thus, the observer obtains a biocular view of the first set of output decoupled images and the second set of output decoupled images, while moving in directions referenced by arrows 1134 and 1136, within the range L₄. Therefore, the useful region of head motion L₄, which is given by
L₄=L₁+L₂−L₃ (22)
is achieved.

Output BTE 1108 and output BTE 1114 are aligned such that decoupled light beams 1124 and 1132 are in the same angular direction. It is noted, that beam transforming elements in addition to the input BTE and the output BTE in each displaying module can be incorporated with the respective light guide, thereby incorporating the beam transforming elements with the respective light guide, in a doublet, triplet or quintuple arrangement.

In the example set forth in FIG. 22, image projector 1118 projects the incident light beam toward device 1100 on-axis. Alternatively, the image projector projects the incident light beam off-axis.

Further alternatively, a device similar to device 1100 includes more than one image projector, wherein the device is an image fusion device. For example, in addition to an image projector similar to image projector 1118, a second image projector can be located behind the device, thereby projecting a respective incident light beam, respective of a second incident projected image, toward an input BTE similar to input BTE 1112. It is noted that an opaque shield similar to opaque shield 424 (FIG. 9), can be incorporated with device 1100. It is noted that additional displaying modules similar to displaying modules 1102 and 1104, can be incorporated with a device similar to device 1100, in order to further extend the range of movements of the observer.

In accordance with a further aspect of the disclosed technique, a first input BTE and a first output BTE are incorporated with a first light guide, thereby forming a first displaying module. A second input BTE and a second output BTE are incorporated with a second light guide, thereby forming a second displaying module. The first displaying module and the second displaying module together form a projected-image displaying device.

When an incident light beam respective of an incident projected image, is projected on the first input BTE within a first range of incidence angles (i.e., a first partial input FOV), the first output BTE decouples light beams respective of a first set of output decoupled images at a first partial output FOV. The first set of output decoupled images is respective of the incident projected image, at the first partial input FOV.

When the incident light beam is projected on the second input BTE within a second range of incidence angles (i.e., a second partial input FOV), the second output BTE decouples light beams respective of a second set of output decoupled images, at a second partial output FOV. The second set of output decoupled images is respective of the incident projected image, at the second partial input FOV.

The first displaying module is placed on the top of the second displaying module and aligned in such a manner, that when the incident light beam is projected on the device at a total input FOV equal to the sum of the first partial input FOV and the second partial input FOV, the device transforms the incident light beam, at a total output FOV equal to the sum of the first partial input FOV and the second partial input FOV. Thus, an observer obtains a biocular view of an image representing the incident projected image, at a field of view greater than that provided by each of the first displaying module and the second displaying module alone.

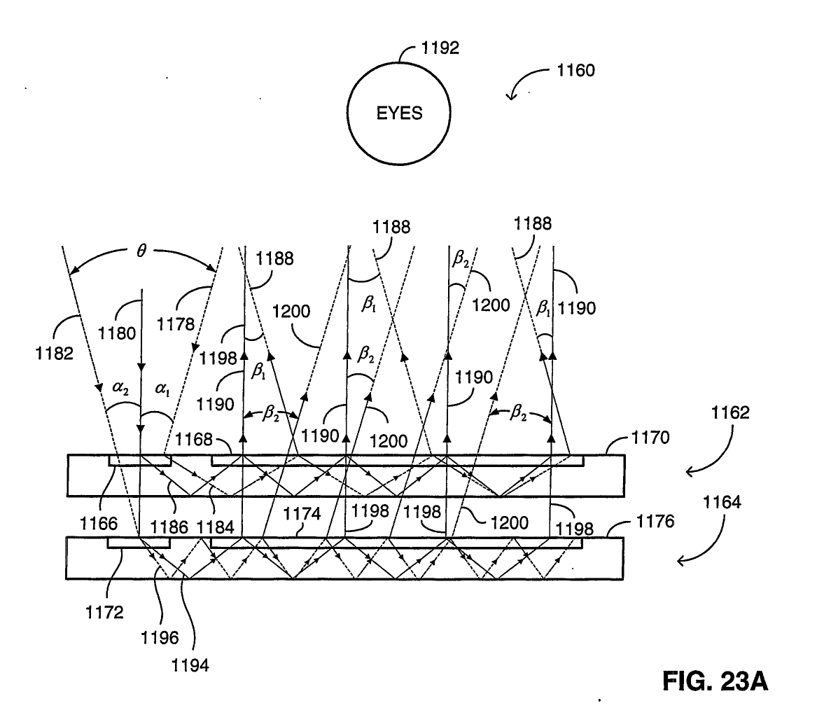

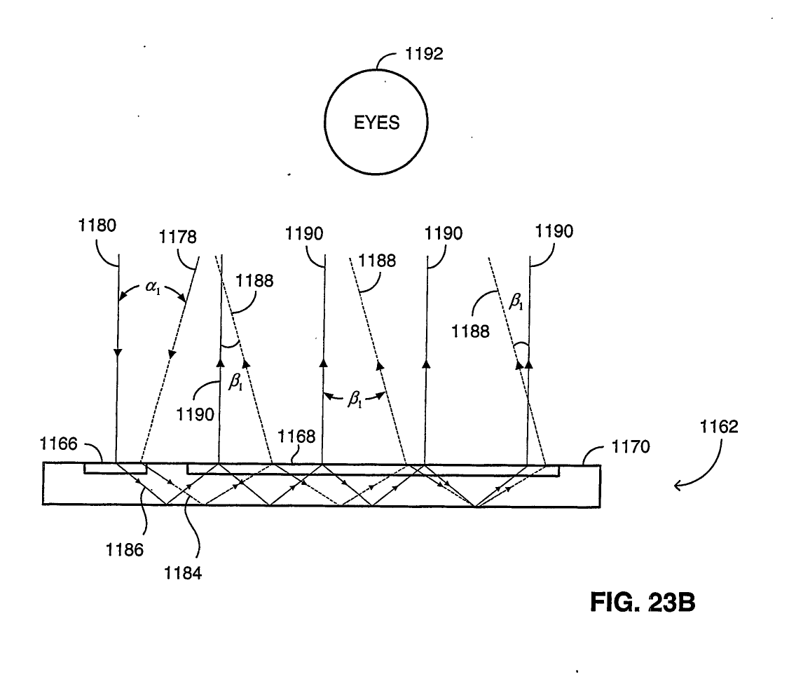

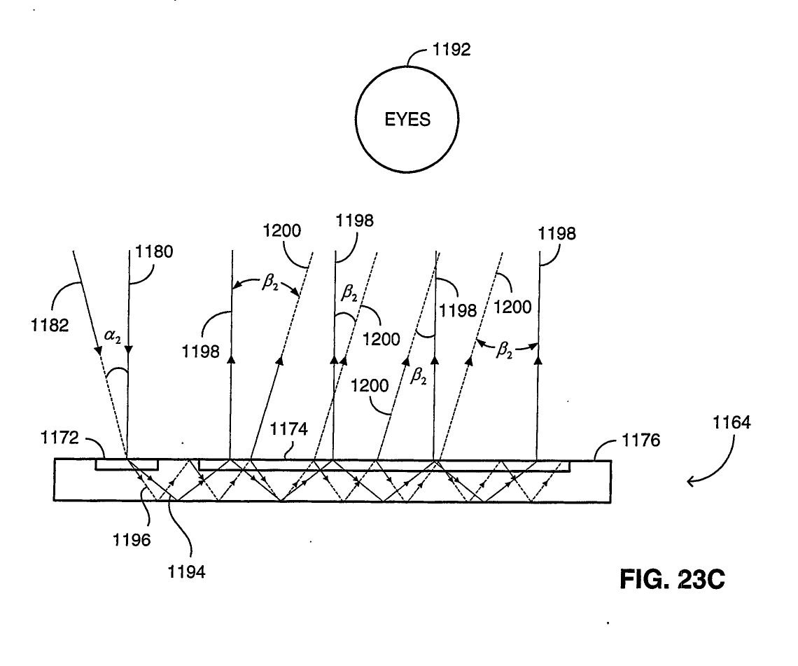

Reference is now made to FIGS. 23A, 23B and 23C. FIG. 23A is a schematic illustration of a device, generally referenced 1160, for displaying an image at an extended field of view (EFOV), constructed and operative in accordance with a further embodiment of the disclosed technique. FIG. 23B is a schematic illustration of light beams entering and emerging out of a first displaying module of the two displaying modules of the device of FIG. 23A. FIG. 23C is a schematic illustration of light beams entering and emerging out of a second displaying module of the two displaying modules of the device of FIG. 23A.

Device 1160 includes a first displaying module 1162 and a second displaying module 1164. First displaying module 1162 includes an input BTE 1166, an output BTE 1168 and a light guide 1170. Second displaying module 1164 includes an input BTE 1172, an output BTE 1174 and a light guide 1176. Input BTE 1166 and output BTE 1168 are incorporated with light guide 1170. Input BTE 1172 and output BTE 1174 are incorporated with light guide 1176.

The properties (such as the groove depth, spatial frequency, grating shape and the microscopic pattern gratings) of input BTE 1166, output BTE 1168, are identical. Alternatively, the properties of input BTE 1166, output BTE 1168, are different. Similarly, the properties of input BTE 1172 and output BTE 1174 are identical. Alternatively, the properties of input BTE 1172 and output BTE 1174 are different.

Input BTE 1166 and output BTE 1168 are located on a first plane (not shown) and along a first axis (not shown). Input BTE 1172 and output BTE 1174 are located on a second plane (not shown) and along a second axis (not shown).

First displaying element 1162 is located on top of second displaying element 1164, such that the first plane and the second plane are parallel. Light guides 1170 and 1176 are separated by an air gap, or covered by a reflective coating, except for the region of the input BTE 1166 and input BTE 1172, as described herein above in connection with Figure IA, such that light beams can propagate through each of light guides 1170 and 1176 by TIR.

An image projector (not shown) is located in front of device 1160 facing the first plane. The image projector projects an incident projected image (not shown), represented by incident light beams 1178 and 1182 and an input principle ray 1180, toward input BTE 1166. The EFOV of the incident projected image is referenced θ. Input principle ray 1180 represents the principle ray of the EFOV. Incident light beams 1178 and 1182 represent the boundaries of the EFOV. The incidence angles of incident light beams 1178 and 1182 are α₁ and α₂, respectively, such that,
α₁+α₂=θ (23)
Generally, the incidence angle of input principle ray 1180 is zero (i.e., the image projector projects the incident projected image on-axis), and
α₁=α₂ (24)
Alternatively, the incidence angle of input principle ray 1180 is different from zero (i.e., the image projector projects the incident projected image off-axis).

First displaying module 1162 is constructed to transform and convey a plurality of incident projected images (not shown), each most efficiently at a partial input FOV represented by α₁, when an incident projected image having a maximum projection angle (EFOV) of θ is projected to first displaying module 1162, as described herein below. Second displaying module 1164 is constructed to transform and convey a plurality of incident projected images (not shown), each at a partial input FOV represented by α₂, when the incident projected image having an EFOV of θ is projected to second displaying module 1164, as described herein below.

Input BTE 1166 is constructed to input couple and deflect light beams having angles of incidence between zero and α₁, toward output BTE 1168 through light guide 1170 by TIR. Input BTE 1166 is also constructed to transmit a portion of light beams having a zero angle of incidence, toward output BTE 1168 through light guide 1170 by TIR, and to transmit another portion of light beams having a zero angle of incidence, to input BTE 1172. Input BTE 1166 is also constructed to transmit to input BTE 1172, most of the light beams having incidence angles between zero and α₂. Input BTE 1172 is constructed to input couple and deflect light beams most efficiently having incidence angles between zero and α₂, to output BTE 1174 through light guide 1176 by TIR.

Input BTE 1166 couples incident light beam 1178 and input principle ray 1180, into light guide 1170, as coupled light beams 1184 and 1186, respectively, toward output BTE 1168 by TIR. Output BTE 1168 decouples coupled light beam 1184 out of light guide 1170, as a decoupled light beam 1188 at an output angle of β₁ from a normal to the first plane, toward eyes 1192 of an observer (not shown) wherein,
β₁=−α₁ (25)
Output BTE 1168 decouples coupled light beam 1186 into an output decoupled principle ray 1190 at an output angle normal to the first plane, out of light guide 1170 toward eyes 1192.

Incident light beam 1182 and input principle ray 1180 reach input BTE 1172 through input BTE 1166. Input BTE 1172 couples input principle ray 1180 and incident light beam 1182, into light guide 1176, as coupled light beams 1194 and 1196, respectively, toward output BTE 1174 by TIR. Output BTE 1174 decouples coupled light beam 1194 into an output principle ray 1198 at an output angle normal to the second plane toward eyes 1192, out of light guide 1176, through at least a portion of output BTE 1168 and light guide 1170. Output BTE 1174 decouples coupled light beam 1196 out of light guide 1176, as a decoupled light beam 1200 at an output angle of β₂ from a normal to the second plane toward eyes 1192, through at least a portion of output BTE 1168 and light guide 1170, wherein,
β₂=−α₂ (26)

Displaying module 1162 transforms that portion of the incident projected image within the incidence angle of α₁, into a partial output FOV β₁, and displaying module 1164 transforms the other portion of the incident projected image within the incidence angle of α₂, into a partial output FOV β₂. Thus, device 1160 (i.e., the combination of displaying modules 1162 and 1164), allows the observer to obtain a biocular view of an image which represents the incident projected image, at an extended field of view θ=β₁+β₂.

A device similar to device 1160 can include additional displaying modules similar to displaying module 1162, located below displaying module 1164, and aligned there between as described herein above in connection with displaying modules 1162 and 1164. Each of these additional displaying modules is constructed to transform the incident projected image at a different partial output FOV. Thus, together these displaying modules provide an image to the observer, representing the incident projected image, at a total output FOV much larger than a single one of these displaying modules would provide by itself. It is noted, that beam transforming elements in addition to the input BTE and the output BTE in each displaying module can be incorporated with the respective light guide, thereby incorporating the beam transforming elements with the respective light guide, in a doublet (FIG. 1A), triplet (FIG. 11), tetra (FIG. 16), quintuple (FIG. 8A) or hexane (FIG. 10) arrangement, according above described embodiments or similarly derived configurations.

Generally, if a chromatic image is projected to an input BTE similar to input BTE 1166, the output decoupled image respective of light beams decoupled by an output BTE similar to output BTE 1168 is non-homogenous (i.e., the luminance of the output decoupled image is not uniform at all wavelengths). This is due to the fact that the coupling efficiency is not uniform across the wavelength spectrum.

To improve the homogeneity of the output decoupled image, each of the displaying modules similar to displaying modules 1162 and 1164 is constructed to operate in a predetermined range of wavelengths. For example, a device similar to device 1160 is constructed such that the first displaying module operates in the red range of wavelengths, the second displaying module in the green range and the third in the blue range. A chromatic image is projected on the input BTE of the top displaying module and the device transforms a chromatic projected image, which is more homogeneous than another chromatic projected image produced by either the first, the second or the third displaying modules alone.

Alternatively, a device similar to device 1160 includes more than one image projector, wherein the device is an image fusion device. For example, an additional image projector can be located behind the device, thereby projecting a respective incident light beam respective of another incident projected image, toward an input BTE similar to input BTE 1172.

With reference back to FIG. 21, each of left displaying module 1052 and right displaying module 1054 can be replaced with a device similar to device 1160. In this case, each of the left displaying module and the right displaying module can transform the incident projected image either at a larger total output FOV or at a greater homogeneity, depending on the type of each of the displaying modules similar to displaying modules 1162 and 1164 (i.e., either selective for a predetermined range of incidence angles or a predetermined range of wavelengths).

With reference back to FIG. 23, each of displaying modules 1102 and 1104 can be replaced with a device similar to device 1160. In this case, each of the two displaying modules similar to displaying modules 1102 and 1104, can transform the incident projected image either at a larger total output FOV or at a greater homogeneity, depending on the type of each of the displaying modules similar to displaying modules 1162 and 1164 (i.e., either selective for a predetermined range of incidence angles or a predetermined range of wavelengths). It is noted that either a scene-image reflector similar to scene-image reflector 108 (FIG. 1A) or an opaque shield similar to opaque shield 424 (FIG. 9), can be incorporated with device 1160.

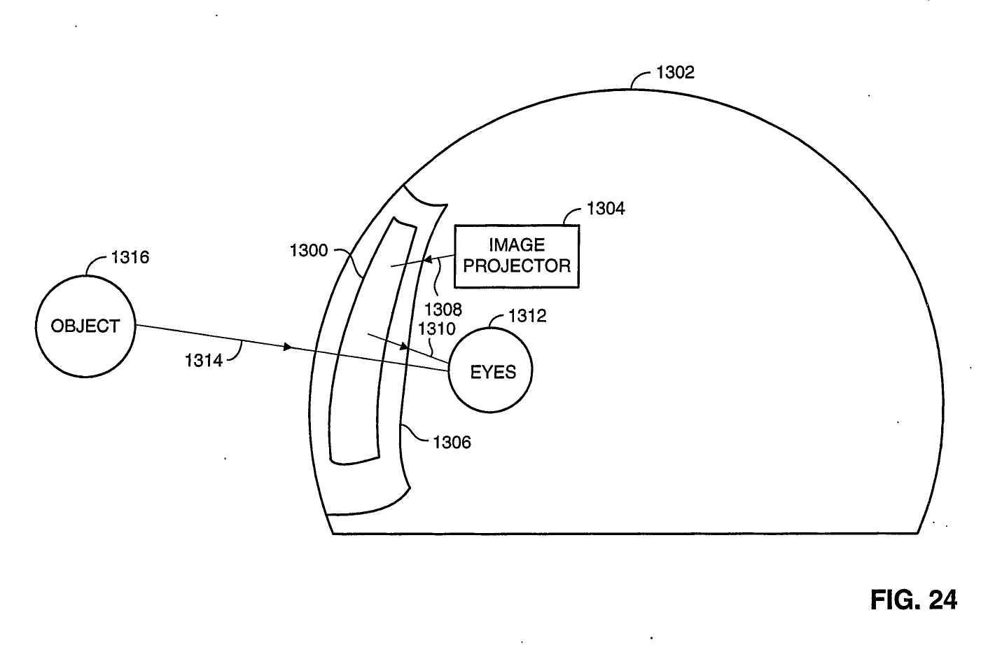

Reference is now made to FIG. 24, which is a schematic illustration of a displaying module, generally referenced 1300, for displaying an image on a visor of a helmet, constructed and operative in accordance with another embodiment of the disclosed technique. Displaying module 1300 is incorporated with a helmet 1302 and an image projector 1304. Helmet 1302 includes a visor 1306. Helmet 1302 is incorporated with a vehicle (not shown), such as aircraft (e.g., airplane, helicopter), marine vessel (e.g., ship, submarine), space vehicle, ground vehicle (e.g., motorcycle, automobile, truck), and the like.

Displaying module 1300 is constructed according to any of the embodiments described herein above, such as for example device 470 (FIG. 9). Hence, displaying module 1300 can include at least one input BTE (not shown), at least one intermediate BTE (not shown) and at least one output BTE (not shown). Displaying module 1300 is incorporated with visor 1306 as a flat module (not shown) in form of an insert (not shown) located on a concave (i.e., inner) side of visor 1306. Image projector 1304 can represent a plurality of image projectors (not shown). Image projector 1304 can be located either within or external to helmet 1302.

Image projector 1304 projects an incident light beam 1308 respective of an incident projected image (not shown) toward an input BTE (not shown) of displaying module 1300 and an output BTE (not shown) of displaying module 1300 decouples a light beam 1310 respective of the incident projected image toward eyes 1312 of an observer (not shown). Eyes 1312 also receive a light beam 1314 of an object 1316 located in front of the observer, through at least a portion of displaying module 1300 and visor 1306. Thus, the observer obtains a biocular view of an image which represents the incident projected image, against an image of object 1316.

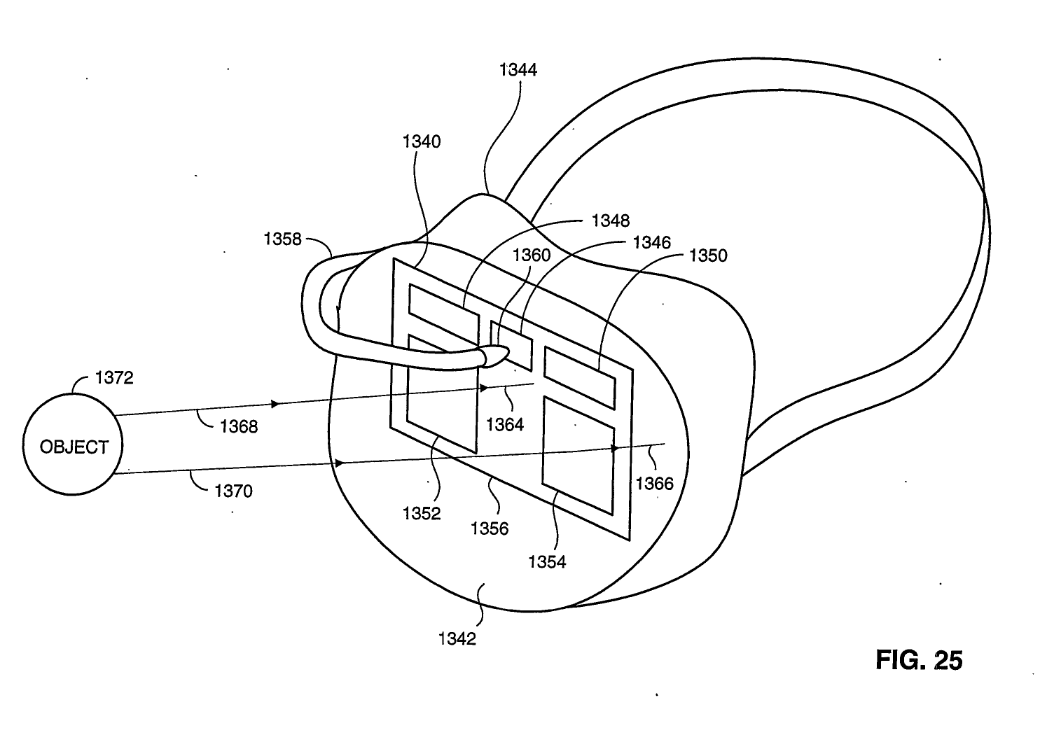

Reference is now made to FIG. 25, which is a schematic illustration of a displaying module, generally referenced 1340, for displaying an image on a viewer of an underwater viewing device, constructed and operative in accordance with a further embodiment of the disclosed technique. Displaying module 1340 is incorporated with a viewer 1342 (i.e., a transparent element) of an underwater viewing device 1344 (i.e., diving mask). In the example set forth in FIG. 25, displaying module 1340 is similar to device 470 (FIG. 9), although displaying module 1340 can be constructed according to other embodiments as described herein above. Displaying module 1340 includes an input BTE 1346, a right intermediate BTE 1348, a left intermediate BTE 1350, a right output BTE 1352, a left output BTE 1354 and a light guide 1356.

Underwater viewing device 1344 includes a data bus 1358 and an image projector 1360. Image projector 1360 can either be enclosed within underwater viewing device 1344, or be attached from the outside directly onto viewer 1342, so as to prevent water and dirt to penetrate between image projector 1360 and the optical path, thereby preventing severe deterioration of the imaging properties.

Data bus 1358 is coupled with underwater viewing device 1344 and with image projector 1360. Image projector 1360 can be coupled (e.g., optically, electrically) with an image generator (not shown), such as processor, and the like. The image generator is coupled with at least one detector (not shown), such as pressure sensor, temperature sensor, and the like. The image generator produces an optical or electric signal according to a signal received from the detector, and image projector 1360 produces a light beam (not shown) according to the signal received from the image generator. Image projector 1360 is located in such position and orientation in front of and close to input BTE 1346, to project an incident light beam (not shown) respective of an incident projected image (not shown), toward input BTE 1346 at a predetermined angle of incidence.

Input BTE 1346 couples the incident light beam into coupled light beams (not shown) toward right intermediate BTE 1348 and left intermediate BTE 1350. Each of right intermediate BTE 1348 and left intermediate BTE 1350 spatially transforms the coupled light beams into other coupled light beams (not shown), toward right output BTE 1352 and left output BTE 1354, respectively. Right output BTE 1352 and left output BTE 1354 decouple the coupled light beams out of light guide 1356, as decoupled light beams 1364 and 1366, respectively, toward eyes (not shown) of an observer (not shown).

Light beams 1368 and 1370 pass through displaying module 1340 and underwater viewing device 1344 from an object 1372 located in front of underwater viewing device 1344, and reach the eyes of the observer. Thus, the observer obtains a biocular view of an image which represents the incident projected image, against an image of object 1372.

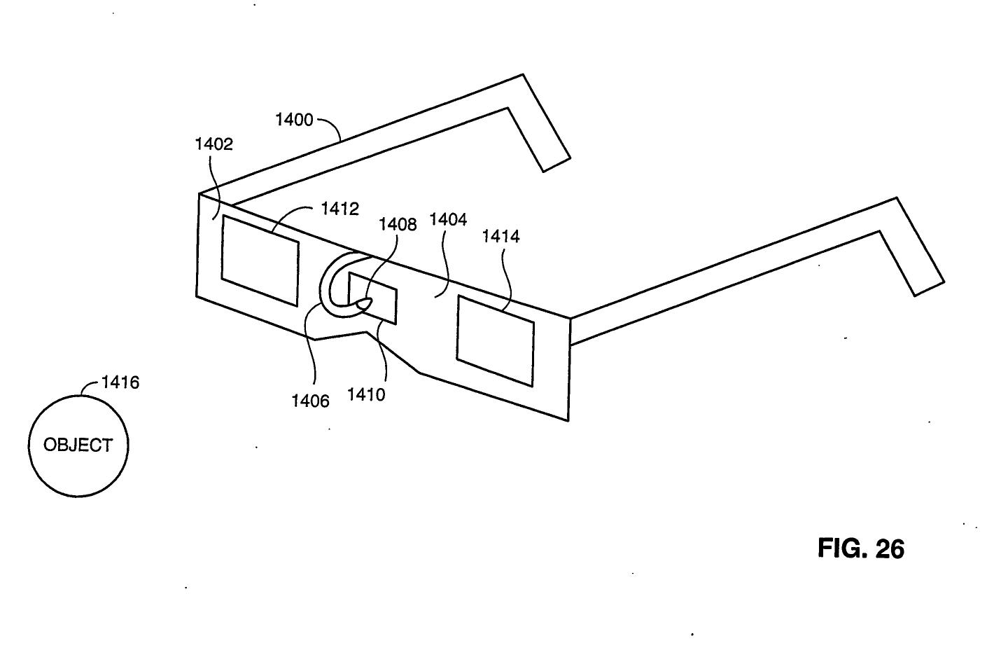

Reference is now made to FIG. 26, which is a schematic illustration of a spectacle, generally referenced 1400, which includes a displaying module for displaying an image against a background scene, constructed and operative in accordance with another embodiment of the disclosed technique. Spectacle 1400 includes a right lens 1402, a left lens 1404, a data bus. 1406, an image projector 1408 and an input BTE 1410. A right displaying BTE assembly 1412 is incorporated with right lens 1402 and a left displaying BTE assembly 1414 is incorporated with left lens 1404.

Input BTE 1410, right displaying BTE assembly 1412 and left displaying BTE assembly 1414 are incorporated with a light guide (not shown). Input BTE 1410, right displaying BTE assembly 1412, left displaying BTE assembly 1414 and the light guide, are similar to input BTE 722 (FIG. 15), left output BTE 724, right output BTE 726 and light guide 728, respectively, as described herein above. Image projector 1408 is located in front of and close to input. BTE 1410. Image projector 1408 operates as described herein above in connection with image projector 1360 (FIG. 25).

Image projector 1408 projects an incident light beam (not shown) respective of an incident projected image (not shown) on input BTE 1410. Input BTE 1410 couples the incident light beam into coupled light beams, into the light guide, toward right displaying BTE assembly 1412 and left displaying BTE assembly 1414. Right displaying BTE assembly 1412 and left displaying BTE assembly 1414, decouple the coupled light beams into a right decoupled light beam (not shown) and a left decoupled light beam (not shown), toward the right eye (not shown) and the left eye (not shown) of a user (not shown), respectively.

The right decoupled light beam is respective of a set of right output decoupled projected beams (not shown), and the left decoupled light beam is respective of a set of left output decoupled projected beams. Each of the set of right output decoupled projected beams and the set of left output decoupled projected beams, represents the incident projected image. Thus, the user perceives a split biocular image which represents the incident projected image, against the image of an object 1416.

Alternatively, the data bus, the image projector, the input BTE, the right displaying BTE assembly and the left displaying BTE assembly is incorporated with a retractable or removable element which is coupled with the spectacle. The retractable element is similar to the one incorporated with regular eyeglasses to impart the characteristics of sunglasses thereto. It is noted that other arrangements of input BTE and displaying BTE assemblies similar to the ones described herein above can be incorporated with the spectacle, such that a stereoscopic, binocular or a biocular image respective of the incident projected image, is displayed for the eyes.

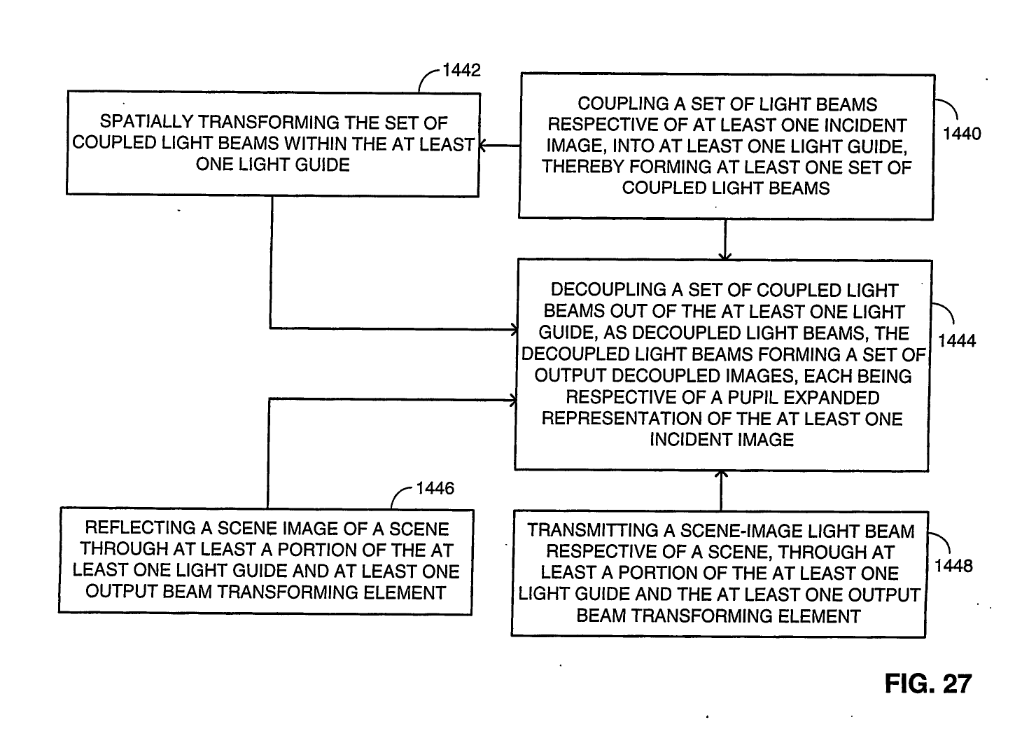

Reference is now made to FIG. 27, which is a schematic illustration of a method for operating a projected-image displaying device, operative in accordance with a further embodiment of the disclosed technique. In procedure 1440, a set of light beams respective of at least one incident image, is coupled into at least one light guide, thereby forming at least one set of coupled light beams.

With reference to FIG. 1B (i.e., a doublet configuration), input BTE 102 couples incident light beam 116 into light guide 106, as coupled light beam 124 (i.e., a set of coupled light beams). Incident light beam 116 is respective of a projected image which image projector 114 projects toward input BTE 102.

With reference to FIG. 3 (i.e., an image fusion device), input BTE 208 couples incident light beams 214A and 216A into coupled light beams 214B and 216B, respectively. Incident light beam 214A is respective of a first incident projected image which image projector 202 projects toward input BTE 208, and incident light beam 216A is respective of a second incident projected image which image projector 204 projects toward input BTE 208.

With reference to FIG. 24 (i.e., an image fusion device), input BTE 1002 couples incident light beams 1014 and 1016 into light guide 1008, as coupled light beam 1026. Similarly, input BTE 1004 couples incident light beams 1022 and 1024 into light guide 1008, as coupled light beam 1028. Incident light beams 1014,1016,1022 and 1024, are respective of a first, a second, a third and a fourth incident projected image, respectively, which image projectors 1010, 1012, 1018 and 1020, respectively, project on light guide 1008.

With reference to FIG. 21 (i.e., a multiple light guide configuration), input BTE 1056 couples incident light beam 1070 into light guide 1060, as coupled light beam 1072, and input BTE 1062 couples light beam 1078 (which is a portion of incident light beam 1070 transmitted by input BTE 1056 to input BTE 1062), into light guide 1066, as coupled light beam 1080. Incident light beam 1070 is respective of an incident projected image, which image projector 1068 projects on input BTE 1056.

In procedure 1442, the set of coupled light beams is spatially transformed within the at least one light guide. With reference to FIG. 11 (i.e., a triplet configuration), intermediate BTE 564 spatially transforms coupled light beam 572 into light guide 568, as coupled light beam 574. With reference to FIG. 8A (i.e., a quintuple configuration), left intermediate BTE 414 and right intermediate BTE 416 spatially transform coupled light beams 430A and 432A, respectively, into light guide 422, as coupled light beams 430B and 432B, respectively. In case the projected-image displaying device is constructed in a doublet configuration (e.g., according to FIG. 1A), procedure 1442 is omitted and the method proceeds directly from procedure 1440 to procedure 1444.

In procedure 1444, a set of coupled light beams is decoupled out of the at least one light guide, as decoupled light beams, the decoupled light beams forming a set of output decoupled images, each being respective of a pupil expanded representation of the at least one incident image. With reference to FIG. 1B (i.e., a doublet configuration), output BTE 104 decouples coupled light beam 124 out of light guide 106, as decoupled light beams 126A and 126B.

Decoupled light beam 126A forms an output decoupled image which eyes 130 detect at position I. Decoupled light beam 126B forms another output decoupled image which eyes 130 detect at position II. Each of these two output decoupled images, is respective of the incident projected image, which image projector projects toward input BTE 102. Furthermore, the output pupil of device 100 (i.e., the aperture through which decoupled light beams 126A and 126B exit output BTE 104), is larger than the input pupil thereof (i.e., the aperture through which incident light beam 116 enters input BTE 102). Hence, each of the output decoupled images at positions I and II, is respective of a pupil expanded representation of the incident projected image.

With reference to FIG. 8A (i.e., a quintuple configuration), left output BTE 418 and right output BTE 420 decouple coupled light beams 430B and 432B, respectively, out of light guide 422, as decoupled light beams 430C and 432C, respectively. Decoupled light beam 430C represents a set of output decoupled images in a pupil expanded system, detected by left eye 434. Likewise, decoupled light beam 432C represents another set of output decoupled images in a pupil expanded system, detected by right eye 436.

With reference to FIG. 24 (i.e., either a doublet, a triplet, or a quintuple configuration), output BTE 1006 decouples coupled light beams 1026 and 1028 out of light guide 1008, as decoupled light beam 1030, toward eyes 1032. Decoupled light beam 1030 is a pupil expanded representation (i.e., a sensor fused image) of the first, the second, the third and the fourth incident projected images, projected by image projectors 1010, 1012, 1018 and 1020, respectively, toward light guide 1008.

With reference to FIG. 21 (i.e., a multiple light guide configuration), left output BTE 1058 decouples coupled light beam 1072 out of light guide 1060, as decoupled light beam 1074, toward eyes 1076. Right output BTE 1064 decouples coupled light beam 1080 out of light guide 1066, as decoupled light beam 1082, toward eyes 1084. Decoupled light beam 1074 is a pupil expanded representation of a set of output decoupled images, respective of the incident projected image which image projector 1068 projects toward input BTE 1056. Likewise, decoupled light beam 1082 is a pupil expanded representation of another set of output decoupled images, respective of the incident projected image which image projector 1068 projects toward input BTE 1056.

In procedure 1446, a scene image of a scene is reflected through at least a portion of the at least one light guide and at least one output beam transforming element. With reference to FIG. 1A (i.e., a doublet configuration), scene-image reflector 108 reflects light beam 136A received from object 134, as light beam 136B toward eyes 130, through at least a portion of light guide 106 and output BTE 104.

With reference to FIG. 23A (i.e., a multiple light guide and either a doublet, triplet or a quintuple device), device 1160 is located between eyes 1192 and an object (not shown) on one side, and a scene-image reflector (not shown) on the other. The scene-image reflector reflects a light beam (not shown) respective of the object, through at least a portion of light guides 1170 and 1176 and through at least a portion of output BTE 1168 and output BTE 1174, toward eyes 1192.

Instead of the scene-image reflector, an opaque shield can be incorporated with the projected-image displaying device. With reference to FIG. 8A, input BTE 412, left intermediate BTE 414, right intermediate BTE 416, left output BTE 418, right output BTE 420 and light guide 422 are located between left eye 434 and right eye 436 on one side, and opaque shield 424 on the other. In this case, each of left eye 434 and right eye 436 detects a set of output decoupled images, against the dark background of opaque shield 424. Procedure 1448 can be performed instead of procedure 1446.

In procedure 1448, a scene-image light beam respective of a scene is transmitted through at least a portion of the at least one light guide and the at least one output beam transforming element. With reference to FIG. 22, displaying modules 1102 and 1104 are located between eyes 1126 and an object (not shown). A scene-image light beam (not shown) respective of the object travels through at least a portion of light guides 1110 and 1116, output BTE 1108 and output BTE 1114.

It is noted that the disclosed technique can be incorporated with apparatus other than those described herein above, such as virtual image projector head-up display (HUD), head mounted display, virtual image mirror, virtual image rear-view mirror, auto-dimming (i.e., anti-glare) virtual image rear-view mirror, biocular display, binocular display, stereoscopic display, spectacles display, wearable display, diving mask (goggles), ski goggles, ground vehicle HUD (e.g., HUDs for automobile, cargo vehicle, bus, bicycle, tank, rail vehicle, armored vehicle, vehicle driven over snow), helmet mounted display (e.g., for motorcycle helmet, racing car helmet, aircraft helmet, rotorcraft helmet, amphibian helmet), aircraft HUD, automotive HUD (e.g., for automobile, cargo vehicle, bus, tank, armored vehicle, rail vehicle, vehicle driven over snow), spacecraft helmet mounted display system, spacecraft helmet mounted see-through display system, marine vehicle (e.g., cargo vessel, resort ship, aircraft carrier, battle ship, submarine, motor boat, sailing boat) helmet mounted display system, marine vehicle helmet mounted see-through display system, virtual display panel for computer applications, virtual display panel for television monitor applications, virtual display periscope, virtual display biocular, virtual display telescope, virtual display reflex camera, virtual display camera viewer, virtual display view finder, device for displaying sensor fused images, virtual display binocular microscope display optics, virtual display biocular microscope display optics, and the like.

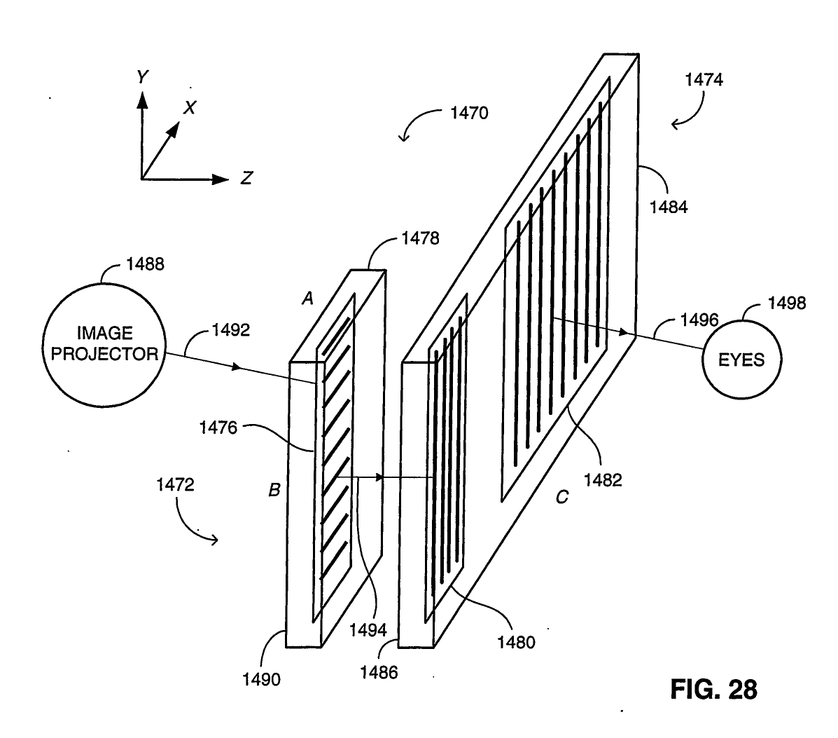

Reference is now made to FIG. 28, which is a schematic illustration in perspective, of a cascaded projected-image displaying device for displaying a projected image, generally referenced 1470, operative in accordance with another embodiment of the disclosed technique. Device 1470 includes an image expander 1472 and a displaying module 1474. Image expander 1472 includes a first input BTE 1476 and an input light guide 1478. First input BTE 1476 is incorporated with input light guide 1478. Displaying module 1474 includes a second input BTE 1480, an output BTE 1482 and an output light guide 1484. Second input BTE 1480, output BTE 1482 and output light guide 1484 are similar to input BTE 102 (FIG. 1A), output BTE 104 and light guide 106, respectively, and arranged in similar configuration. Image expander 1472 is in form of a rectangle having a width A and a height B. Displaying module 1474 is in form of a rectangle having a width C and a height B where,
C>A (27)
Alternatively, displaying module 1474 can be in form of a square, trapezoid or other geometry. The dimensions of first input BTE 1476 can be either identical or smaller than those of second input BTE 1480. Image expander 1472 is located behind displaying module 1474, facing a rear surface 1486 of displaying module 1474.

An image projector 1488 is located behind image expander 1472 facing a rear surface 1490 of image expander 1472. Image projector 1488 directs an incident light beam 1492 respective of an incident projected image (not shown), toward first input BTE 1476. First input BTE 1476 couples part of incident light beam 1492 into a coupled light beam (not shown), through input light guide 1478 by TIR. First input BTE 1476 transmits another part of incident light beam 1492 as a set of expanded light beams 1494 toward second input BTE 1480. Second input BTE 1480 couples set of expanded light beams 1494 into a coupled light beam (not shown), through output light guide 1484 by TIR. Output BTE 1482 decouples the coupled light beam out of output light guide 1484, as a decoupled light beam 1496 respective of an output decoupled image (not shown), toward eyes 1498 of an observer (not shown), as described herein above in connection with FIG. 1A. The output decoupled image represents the incident projected image. Thus, the observer obtains a biocular view of an image representing the incident projected image.

It is noted that first input BTE 1476 expands incident light beam 1492 within input light guide 1478 along the Y xis, while second input BTE 1480 and output BTE 1482 further expand set of expanded light beams 1494 along the X axis. In the example set forth in FIG. 28, image projector 1488 projects incident light beam 1492 toward an edge of first input BTE 1476. In this case, first input BTE 1476 is asymmetric and the groove depth thereof is uniform, in the area of the incident light beam 1492. However, it is noted that within the remainder of the area of BTE 1476, the groove depth is preferably non-uniform and increasing in the direction of beam propagation and expansion. Moreover, the groove depth of second input BTE 1480 is uniform, while the groove depth of output BTE 1482 is non-uniform. However, in case the image projector projects the incident light beam toward a mid-section of the first input BTE, the first input BTE is symmetric. In any case, the symmetries of second input BTE 1480 and output BTE 1482 are preferably identical to that of first input BTE 1476. The spatial frequencies of first input BTE 1476, second input BTE 1480 and output BTE 1482 are identical. The microgroove direction of first input BTE 1476 is parallel with side A (i.e., along an X axis of a Cartesian coordinate system). The microgroove direction of each of second input BTE 1480 and output BTE 1482 is perpendicular to the microgroove direction of first input BTE 1476 (i.e., along the Y axis).

The second input BTE and the output BTE can be merged into a combined BTE whose microgroove direction is along the Y axis. In this case, the groove depth of that portion of the combined BTE which overlaps the first input BTE is uniform, while the groove depth of the remaining portion of the combined BTE is non-uniform.

A device similar to device 1470 can include a scene-image reflector similar to scene-image reflector 108 (FIG. 1A), to reflect an image of an object facing the rear surface of the image expander, through the displaying module, toward the eyes of an observer who is facing the rear surface of the image expander. A device similar to device 1470 can include an opaque shield similar to opaque shield 424 (FIG. 8A), facing the rear surface of the displaying module, in a non-overlapping region of the image expander and the displaying module.

A device similar to device 1470 can include instead of the displaying module, two cascaded displaying modules similar to displaying modules 1052 (FIG. 21) and 1054, and arranged in the same manner as described herein above. Alternatively, a device similar to device 1470 can include instead of the displaying module, two or more cascaded displaying modules similar to displaying modules 1102 (FIG. 22) and 1104, and arranged in the same manner as described herein above. Further alternatively, a device similar to device 1470 can include instead of the displaying module, two or more cascaded displaying modules similar to displaying modules 1162 (FIG. 23A) and 1164, and arranged in the same manner as described herein above.

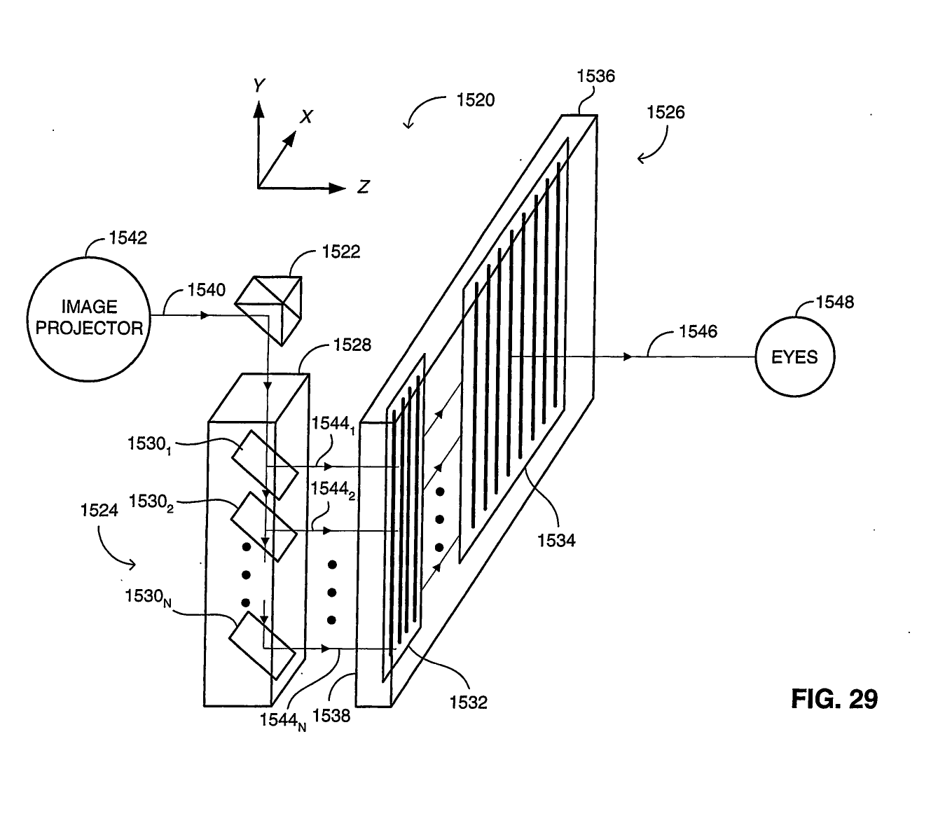

Reference is now made to FIG. 29, which is a schematic illustration in perspective, of a projected-image displaying device for displaying a projected image, generally referenced 1520, operative in accordance with a further embodiment of the disclosed technique. Device 1520 includes a reflector 1522, an image expander 1524 and a displaying module 1526. Image expander 1524 includes a housing 1528 and a plurality of reflective elements 1530₁, 1530₂ and 1530_{N}. Displaying module 1526 includes an input BTE 1532, an output BTE 1534 and a light guide 1536. Reflector 1522 can be in form of a mirror, a prism, and the like, which reflects the incident light beam by specular reflection.

Input BTE 1532, output BTE 1534 and light guide 1536 are similar to input BTE 102 (FIG. 1A), output BTE 104 and light guide 106, respectively. Each of reflective elements 1530₁, 1530₂ and 1530_{N} is in form of a partially reflective element (e.g., beam splitter), which reflects a portion of the incident light beam by specular reflection and transmits another portion of the incident light beam there through. For this purpose, each of reflective elements 1530₁, 1530₂ and 1530_{N} is coated by an appropriate coating. The coating is applied to each of reflective elements 1530₁, 1530₂ and 1530_{N}, such that the reflectance of reflective elements 1530₁, 1530₂ and 1530_{N} are different.

For example, the reflectance of reflective element 1530₂ is greater than that of reflective element 1530₁ and the reflectance of reflective element 1530_{N} is greater than that of reflective element 1530₂. In this manner the greater reflectance of a subsequent reflective element compared to a previous one, compensates for the reduced light intensity which is received by the subsequent reflective element.

Reflective elements 1530₁, 1530₂ and 1530_{N} are located within housing 1528. Housing 1528 is located behind input BTE 1532 facing a rear surface 1538 of displaying module 1526. Each of reflective elements 1530₁, 1530₂ and 1530_{N} is oriented at a slanted angle relative to rear surface 1538 (i.e., to the X-Y plane of a Cartesian coordinate system), in order to reflect the incident light beam toward input BTE 1532. In the example illustrated in FIG. 29, each of reflective elements 1530₁, 1530₂ and 1530_{N} is oriented 45 degrees relative to the X-Y plane. Reflector 1522 is located at such a position relative to housing 1528, in order to reflect an incident light beam toward reflective element 1530₁. In the example illustrated in FIG. 29, the reflective surface of reflector 1522 is oriented at the same angle as that of reflective elements 1530₁, 1530₂ and 1530_{N} (i.e., 45 degrees).

Reflector 1522 reflects an incident light beam 1540 received from an image projector 1542, toward reflective element 1530₁. Reflective elements 1530₁, 1530₂ and 1530_{N} transmit a portion of incident light beam 1540 consecutively there through, and reflect another portion of incident light beam 1540 toward input BTE 1532 as light beams 1544₁, 1544₂ and 1544_{N}, respectively. In this manner, image expander 1524 expands incident light beam 1540 along the Y axis. Input BTE 1532 couples light beams 1544₁, 1544₂ and 1544_{N} into coupled light beam (not shown), through light guide 1536 by TIR. Output BTE 1534 decouples the coupled light beam out of light guide 1536, as a decoupled light beam 1546 respective of an output decoupled image (not shown), toward eyes 1548 of an observer (not shown), as described herein above in connection with FIG. 1A. The output decoupled image represents the incident projected image. Thus, the observer obtains a biocular view of an image representing the incident projected image.

In order to avoid discontinuity in the optical information, such as the appearance of empty stripes in the image, portions of every pair of reflective elements 1530₁, 1530₂ and 1530_{N} are overlapped along the Y axis. Furthermore, in order to compensate for non-uniformities in the output decoupled image, the overlapped region of each of reflective elements 1530₁, 1530₂ and 1530_{N} is coated different than the non-overlapped region thereof. It is noted that device 1520 is similar to device 1470 (FIG. 28), except that image expander 1472 is replaced by image expander 1524. Since image expander 1524 directs light beams 1544₁, 1544₂ and 1544_{N} toward input BTE 1532 by specular reflection and not by diffraction, less light intensity is lost during the light expansion and thus, the output decoupled image of device 1520 is superior compared to that of device 1470.

In order to avoid non-uniformities in the output decoupled image, the overlaps between reflective elements 1530₁, 1530₂ and 1530_{N} can be eliminated, in which case the coating across every single of reflective elements 1530₁, 1530₂ and 1530_{N} can be uniform, however different among reflective elements 1530₁, 1530₂ and 1530_{N}. In this case, in order to avoid discontinuity of optical information (i.e., stripes), which might result due to lack of overlap between reflective elements 1530₁, 1530₂ and 1530_{N}, image expander 1524 oscillates along the Y axis. Therefore, the output decoupled image is complete and contains no discontinuities. Device 1520 can include a moving mechanism (e.g., electric motor, piezoelectric element, integrated circuit motor), in order to impart oscillating motion to image expander 1524.

Alternatively, image expander 1524 can be stationary and instead reflector 1522 can oscillate along the Z axis. Further alternatively, the image expander can include only one reflective element, in which case the stroke of either the image expander or the reflector may have to be greater than in the case of multiple reflective elements.

A device similar to device 1520 can include a scene-image reflector similar to scene-image reflector 108 (FIG. 1A), to reflect an image of an object facing the rear surface of the displaying module, through the displaying module, toward the eyes of an observer who is facing the rear surface of the displaying module. A device similar to device 1470 can include an opaque shield similar to opaque shield 424 (FIG. 8A), facing the rear surface of the displaying module, in a non-overlapping region of the image expander and the displaying module.

A device similar to device 1520 can include instead of the displaying module, two cascaded displaying modules similar to displaying modules 1052 (FIG. 21) and 1054, and arranged in the same manner as described herein above. Alternatively, a device similar to device 1520 can include instead of the displaying module, two or more cascaded displaying modules similar to displaying modules 1102 (FIG. 22) and 1104, and arranged in the same manner as described herein above. Further alternatively, a device similar to device 1520 can include instead of the displaying module, two or more cascaded displaying modules similar to displaying modules 1162 (FIG. 23A) and 1164, and arranged in the same manner as described herein above.

It will be appreciated by persons skilled in the art that the disclosed technique is not limited to what has been particularly shown and described hereinabove. Rather the scope of the disclosed technique-is defined only by the claims, which follow.

1. Incident image displaying device for displaying at least one incident image against a scene image of a scene, the incident image displaying device comprising:
at least one light guide;
at least one input beam transforming element incorporated with a respective one of said at least one light guide, said at least one input beam transforming element receiving incident light beams respective of said at least one incident image from a respective one of at least one image source;
at least one output beam transforming element incorporated with said respective at least one light guide and associated with a respective one of said at least one input beam transforming element; and
a scene image reflector located behind said at least one light guide, said scene image reflector reflecting said scene image through at least a portion of said at least one light guide and of said at least one output beam transforming element,
wherein said at least one input beam transforming element couples said incident light beams into said respective at least one light guide as a set of coupled light beams, said set of coupled light beams is associated with said respective at least one input beam transforming element,
wherein said at least one output beam transforming element receives from said respective at least one light guide and decouples as decoupled light beams, said set of coupled light beams, thereby forming a set of output decoupled images, and
wherein each output decoupled image of said set of output decoupled images is representative of a sensor fused image of said at least one incident image.

2. Incident image displaying device for displaying at least one incident image, the incident image displaying device comprising:
at least one light guide;
at least one input beam transforming element incorporated with a respective one of said at least one light guide, said at least one input beam transforming element receiving incident light beams respective of said at least one incident image from a respective one of at least one image source;
at least one output beam transforming element incorporated with a respective one of said at least one light guide and associated with a respective one of said at least one input beam transforming element; and
an opaque shield located behind said at least one light guide, said opaque shield having a substantially dark hue,
wherein said at least one input beam transforming element couples said incident light beams into said respective at least one light guide as a set of coupled light beams, said set of coupled light beams is associated with said respective at least one input beam transforming element,
wherein said at least one output beam transforming element receives from said respective at least one light guide and decouples as decoupled light beams, said set of coupled light beams, thereby forming a set of output decoupled images, and
wherein each output decoupled image of said set of output decoupled images is representative of a sensor fused image of said at least one incident image.

3. Incident image displaying device for displaying at least one incident image, the incident image displaying device comprising:
at least one light guide;
at least one input beam transforming element incorporated with a respective one of said at least one light guide, said at least one input beam transforming element receiving incident light beams respective of said at least one incident image from a respective one of at least one image source;
a plurality of output beam transforming elements incorporated with said respective at least one light guide; and
at least one intermediate beam transforming element for each of said output beam transforming elements, said at least one intermediate beam transforming element being incorporated with a respective one of said at least one light guide, and associated with a respective one of said at least one input beam transforming element;
wherein said at least one input beam transforming element couples said incident light beams into said respective at least one light guide as a set of coupled light beams, said set of coupled light beams is associated with said respective at least one input beam transforming element,
wherein said at least one intermediate beam transforming element spatially transforms said set of coupled light beams into a set of coupled light beams,
wherein each of said output beam transforming elements receives from said respective at least one light guide and decouples as decoupled light beams, a set of coupled light beams spatially transformed by said at least one intermediate beam transforming element, thereby forming a set of output decoupled images, and
wherein each output decoupled image of said set of output decoupled images is representative of a sensor fused image of said at least one incident image.

4. Incident image displaying device for displaying at least one incident image, the incident image displaying device comprising:
at least one light guide;
a plurality of input beam transforming elements incorporated with a respective one of said at least one light guide, a respective one of said input beam transforming elements receiving incident light beams respective of said at least one incident image from a respective one of at least one image source;
a plurality of intermediate beam transforming elements being incorporated with said respective at least one light guide, and associated with said respective input beam transforming element; and
an output beam transforming element incorporated with said respective at least one light guide, and associated with said intermediate beam transforming elements;
wherein said respective input beam transforming element couples said incident light beams into said respective at least one light guide as a set of coupled light beams, said set of coupled light beams is associated with said respective input beam transforming element,
wherein each of said intermediate beam transforming elements spatially transforms said set of coupled light beams into a set of coupled light beams,
wherein said output beam transforming element receives from said respective at least one light guide and decouples as decoupled light beams, a set of coupled light beams spatially transformed by said intermediate beam transforming elements, thereby forming a set of output decoupled images, and
wherein each output decoupled image of said set of output decoupled images is representative of a sensor fused image of said at least one incident image.

5. Incident image displaying device for displaying at least one incident image against a scene image of a scene, the incident image displaying device comprising:
at least one light guide;
at least one input beam transforming element incorporated with a respective one of said at least one light guide, said at least one input beam transforming element receiving incident light beams respective of said at least one incident image from a respective one of at least one image source; and
at least one output beam transforming element incorporated with said respective at least one light guide and associated with a respective one of said at least one input beam transforming element,
wherein said at least one input beam transforming element includes a first input beam transforming element and a second input beam transforming element,
wherein said at least one output beam transforming element includes a first output beam transforming element and a second output beam transforming element,
wherein said first input beam transforming element and said first output beam transforming element are incorporated with a first light guide of said at least one light guide, thereby forming a first displaying module,
wherein said second input beam transforming element and said second output beam transforming element are incorporated with a second light guide of said at least one light guide, thereby forming a second displaying module,
wherein said second input beam transforming element is located below said first input beam transforming element,
wherein said first output beam transforming element is located on one side of said first input beam transforming element and said second input beam transforming element,
wherein said second output beam transforming element is located on the other side of said first input beam transforming element and said second input beam transforming element,
wherein said first input beam transforming element transmits said incident light beams to said second input beam transforming element,
wherein said at least one input beam transforming element couples said incident light beams into said respective at least one light guide as a set of coupled light beams, said set of coupled light beams is associated with said respective at least one input beam transforming element,
wherein said at least one output beam transforming element receives from said respective at least one light guide and decouples as decoupled light beams, said set of coupled light beams, thereby forming a set of output decoupled images, and
wherein each output decoupled image of said set of output decoupled images is representative of a sensor fused image of said at least one incident image.

6. The incident image displaying device according to any of claims 1, 2, 3, 4 or 5, wherein an output angle of said decoupled light beams, is substantially equal to an incidence angle of a respective one of said incident light beams.

7. The incident image displaying device according to claim 1, wherein an output angle of said decoupled light beams, is substantially equal to a reflected scene image angle of a reflected scene image light beam, reflected by said scene image reflector, through at least a portion of said at least one light guide and of said at least one output beam transforming element.

8. The incident image displaying device according to any of claims 1, 2, or 5, wherein said at least one input beam transforming element and said at least one output beam transforming element are incorporated with said at least one light guide, by soft nanolithography.

9. The incident image displaying device according to claim 3, wherein said at least one input beam transforming element and each of said output beam transforming elements are incorporated with said at least one light guide, by soft nanolithography.

10. The incident image displaying device according to claim 4, wherein said output beam transforming element and each of said input beam transforming elements are incorporated with said at least one light guide, by soft nanolithography.

11. The incident image displaying device according to any of claims 1, 2, or 5, wherein the contour of a respective one of said at least one output beam transforming element, is such that said respective at least one output beam transforming element, collects those portions of said set of coupled light beams, which said respective at least one input beam transforming element couples into said respective at least one light guide toward said respective at least one output beam transforming element, in directions different from a central axis between said respective at least one input beam transforming element and said respective at least one output beam transforming element.

12. The incident image displaying device according to claim 11, wherein said contour is selected from the list consisting of:
rectangle;
square;
trapezoid; and
ellipse.

13. The incident image displaying device according to claim 3, wherein the contour of a respective one of said output beam transforming elements, is such that said respective output beam transforming element, collects those portions of said set of coupled light beams, which said respective at least one input beam transforming element couples into said respective at least one light guide toward said respective output beam transforming element, in directions different from a central axis between said respective at least one input beam transforming element and said respective output beam transforming element.

14. The incident image displaying device according to claim 4, wherein the contour of said output beam transforming element, is such that said output beam transforming element collects those portions of said set of coupled light beams, which said respective input beam transforming element couples into said respective at least one light guide toward said output beam transforming element, in directions different from a central axis between said respective input beam transforming element and said output beam transforming element.

15. The incident image displaying device according to claim 1, further comprising at least one intermediate beam transforming element incorporated with said respective at least one light guide,
wherein said at least one intermediate beam transforming element is associated with said respective at least one input beam transforming element, and with a respective one of said at least one output beam transforming element,
wherein each of a respective one of said at least one intermediate beam transforming element receives a set of coupled light beams associated with said respective at least one intermediate beam transforming element and with said respective at least one input beam transforming element, and
wherein said respective at least one intermediate beam transforming element spatially transforms said set of coupled light beams into said respective at least one light guide, as another set of coupled light beams.

16. The incident image displaying device according to claim 15, wherein at least one of said at least one input beam transforming element, at least one of said at least one intermediate beam transforming element, and at least one of said at least one output beam transforming element, are located on the same side of two substantially parallel sides of said respective at least one light guide

17. The incident image displaying device according to claim 15, wherein the location of at least one of said at least one input beam transforming element, at least one of said at least one intermediate beam transforming element, and at least one of said at least one output beam transforming element, relative to said respective at least one light guide, is selected from the list consisting of:
within said respective at least one light guide; and
on at least one of two substantially parallel surfaces of said respective at least one light guide.

18. The incident image displaying device according to claim 15, wherein the contour of said respective at least one intermediate beam transforming element, is such that said respective at least one intermediate beam transforming element collects those portions of said set of coupled light beams, which said respective at least one input beam transforming element couples into said respective at least one light guide toward said respective at least one intermediate beam transforming element, in directions different from a central axis between said respective at least one input beam transforming element and said respective at least one intermediate beam transforming element.

19. The incident image displaying device according to claim 18, wherein said contour is selected from the list consisting of:
rectangle;
square;
trapezoid; and
ellipse.

20. The incident image displaying device according to claim 15, wherein an intermediate microgroove direction of a respective one of said at least one intermediate beam transforming element, relative to an input microgroove direction of said respective at least one input beam transforming element, and relative to an output microgroove direction of a respective one of said at least one output beam transforming element, is such that said respective at least one intermediate beam transforming element receives said set of coupled light beams from said respective at least one input beam transforming element, and such that said respective at least one output beam transforming element receives said set of coupled light beams, spatially transformed by said respective at least one intermediate beam transforming element.

21. The incident image displaying device according to claim 15, wherein each of said at least one input beam transforming element, said at least one intermediate beam transforming element and said at least one output beam transforming element, is selected from the list consisting of:
refraction light beam transformer; and
diffraction light beam transformer.

22. The incident image displaying device according to claim 21, wherein said refraction light beam transformer is selected from the list consisting of:
prism;
Fresnel lens;
micro prism array;
gradient index lens; and
gradient index micro lens array.

23. The incident image displaying device according to claim 21, wherein said diffraction light beam transformer is a diffraction optical element.

24. The incident image displaying device according to any of claims 1, 2, 3, or 5, wherein said respective at least one input beam transforming element receives said incident light beams from at least one side of said incident image displaying device.

25. The incident image displaying device according to claim 4, wherein said respective input beam transforming element receives said incident light beams from at least one side of said incident image displaying device.

26. The incident image displaying device according to claim 1, wherein said scene image reflector is selected from the list consisting of:
back coated mirror;
dielectric film;
interference coating;
rugate coating;
reflective beam transforming element;
metallic film;
metallic coating; and
variable reflector.

27. The incident image displaying device according to any of claims 1, 2, 3, or 5, further comprising at least one projected image reflector located adjacent to said respective at least one input beam transforming element,
wherein said at least one projected image reflector directs said incident light beams from said respective at least one image source toward said respective at least one input beam transforming element.

28. The incident image displaying device according to claim 4, further comprising at least one projected image reflector located adjacent to said respective input beam transforming element,
wherein said at least one projected image reflector directs said incident light beams from said respective at least one image source toward said respective input beam transforming element.

29. The incident image displaying device according to any of claims 1, 2, 3, or 5, further comprising at least one optical assembly located between said respective at least one image source and said respective at least one input beam transforming element,
wherein said respective at least one optical assembly directs said incident light beams from said respective at least one image source toward said respective at least one input beam transforming element, at a selected incidence angle.

30. The incident image displaying device according to claim 29, wherein said at least one optical assembly comprises:
an image focal point location changer; and
a controller coupled with said image focal point location changer,
wherein said controller directs said image focal point location changer, to vary at least one projected image focal length of a respective one of said at least one incident image.

31. The incident image displaying device according to claim 30, wherein said image focal point location changer is selected from the list consisting of:
variable focal length lens; and
moving lens.

32. The incident image displaying device according to claim 30, wherein said controller directs said image focal point location changer to vary said at least one projected image focal length, in an oscillating manner.

33. The incident image displaying device according to claim 4, further comprising at least one optical assembly located between said respective at least one image source and said respective input beam transforming element,
wherein said respective at least one optical assembly directs said incident light beams from said respective at least one image source toward said respective input beam transforming element, at a selected incidence angle.

34. The incident image displaying device according to any of claims 1, 2, 3, or 5, further comprising at least one input element light reflector, said respective at least one input beam transforming element being located between a respective one of said at least one image source and said respective at least one input element light reflector,
wherein said respective at least one input element light reflector recycles at least a portion of said incident light beams from said respective at least one input beam transforming element into said respective at least one light guide.

35. The incident image displaying device according to claim 4, further comprising at least one input element light reflector, said respective input beam transforming element being located between a respective one of said at least one image source and said respective at least one input element light reflector,
wherein said respective at least one input element light reflector recycles at least a portion of said incident light beams from said respective input beam transforming element into said respective at least one light guide.

36. The incident image displaying device according to any of claims 1, 2, 3, or 5, further comprising at least one beam splitter located adjacent to said at least one input beam transforming element,
wherein said at least one beam splitter directs a first incident light beam received from one of said at least one image source and a second incident light beam received from another one of said at least one image source, toward said respective at least one input beam transforming element.

37. The incident image displaying device according to claim 4, further comprising at least one beam splitter located adjacent to respective input beam transforming element,
wherein said at least one beam splitter directs a first incident light beam received from one of said at least one image source and a second incident light beam received from another one of said at least one image source, toward said respective input beam transforming element.

38. The incident image displaying device according to any of claims 1, 2, 3, or 5, further comprising at least one image projector associated with said at least one image source,
wherein said at least one image source sends information respective of said at least one incident image, to said at least one image projector, and
wherein said at least one image projector projects said incident light beams toward said respective at least one input beam transforming element.

39. The incident image displaying device according to claim 4, further comprising at least one image projector associated with said at least one image source,
wherein said at least one image source sends information respective of said at least one incident image, to said at least one image projector, and
wherein said at least one image projector projects said incident light beams toward said respective input beam transforming element.

40. The incident image displaying device according to any of claims 1, 2, 3, 4, or 5, wherein said at least one image source is selected from the list consisting of:
light emitting diode;
laser;
laser scanner;
fluorescent light element;
incandescent light element;
liquid crystal display;
cathode ray tube display;
flat panel display;
still image projector;
cinematographic image projector;
starlight scope; and
spatial light modulator.

41. The incident image displaying device according to claim 1, wherein a projected image focal length respective of each output decoupled image of said set of output decoupled images, relative to at least one eye of an observer, is substantially equal to a scene image focal length of said scene image, relative to said at least one eye.

42. The incident image displaying device according to any of claims 1, 2, or 5, wherein an input microgroove direction of said respective at least one input beam transforming element, relative to an output microgroove direction of a respective one of said at least one output beam transforming element, is such that said respective at least one output beam transforming element receives said set of coupled light beams, from said respective at least one input beam transforming element.

43. The incident image displaying device according to claim 3, wherein an input microgroove direction of said respective at least one input beam transforming element, relative to an output microgroove direction of a respective one of said output beam transforming elements, is such that said respective output beam transforming element receives said set of coupled light beams, from said respective at least one input beam transforming element.

44. The incident image displaying device according to claim 4, wherein an input microgroove direction of said respective input beam transforming element, relative to an output microgroove direction of said output beam transforming element, is such that said output beam transforming element receives said set of coupled light beams, from said respective input beam transforming element.

45. The incident image displaying device according to any of claims 1, 2, or 5, wherein an output microgroove direction of a respective one of said at least one output beam transforming element, is such that said decoupled light beams are decoupled out of said respective at least one light guide.

46. The incident image displaying device according to claim 3, wherein an output microgroove direction of a respective one of said output beam transforming elements, is such that said decoupled light beams are decoupled out of said respective at least one light guide.

47. The incident image displaying device according to claim 4, wherein an output microgroove direction of said output beam transforming element, is such that said decoupled light beams are decoupled out of said respective at least one light guide.

48. The incident image displaying device according to any of claims 1, 2, 3, 4, or 5, wherein each output decoupled image of said set of output decoupled images, is selected from the list consisting of:
biocular;
split biocular;
binocular; and
stereoscopic.

49. The incident image displaying device according to any of claims 1, 2, or 5, wherein a local diffraction efficiency of said at least one output beam transforming element, increases from two edges thereof toward a midsection thereof.

50. The incident image displaying device according to claim 3, wherein a local diffraction efficiency of each of said output beam transforming element, increases from two edges thereof toward a midsection thereof.

51. The incident image displaying device according to claim 4, wherein a local diffraction efficiency of said output beam transforming element, increases from two edges thereof toward a midsection thereof.

52. The incident image displaying device according to any of claims 1, or 2, wherein said at least one input beam transforming element includes a first input beam transforming element and a second input beam transforming element,
wherein said at least one output beam transforming element includes a first output beam transforming element and a second output beam transforming element,
wherein said first input beam transforming element and said first output beam transforming element are incorporated with a first light guide of said at least one light guide, thereby forming a first displaying module,
wherein said second input beam transforming element and said second output beam transforming element are incorporated with a second light guide of said at least one light guide, thereby forming a second displaying module,
wherein said second input beam transforming element is located below said first input beam transforming element,
wherein said first output beam transforming element is located on one side of said first input beam transforming element and said second input beam transforming element,
wherein said second output beam transforming element is located on the other side of said first input beam transforming element and said second input beam transforming element, and
wherein said first input beam transforming element transmits said incident light beams to said second input beam transforming element.

53. The incident image displaying device according to claim 52, wherein said first displaying module includes a first set of at least two displaying modules located on the top of one another,
wherein said second displaying module includes a second set of at least two displaying modules located on the top of one another,
wherein each displaying module of said first set is associated with a selected input field of view respective of said respective at least one incident image, and each displaying module of said second set is associated with a selected input field of view respective of said respective at least one incident image,
wherein an output field of view respective of each output decoupled image of said set of output decoupled images, respective of said first displaying module is substantially equal to the sum of said selected input field of views, and
wherein an output field of view respective of each output decoupled image of said set of output decoupled images, respective of said second displaying module is substantially equal to the sum of said selected input field of views.

54. The incident image displaying device according to claim 52, wherein said first displaying module includes a first set of displaying modules located on the top of one another,
wherein said second displaying module includes a second set of displaying modules located on the top of one another,
wherein each displaying module of said first set is associated with a selected range of wavelengths, and each displaying module of said second set is associated with a selected range of wavelengths,
wherein each output decoupled image of said set of output decoupled images, respective of said first displaying module includes said selected ranges of wavelengths, and wherein each output decoupled image of said set of output decoupled images, respective of said second displaying module includes said selected ranges of wavelengths.

55. The incident image displaying device according to any of claims 1, 2, or 5, further comprising an image expander located between a selected one of said at least one input beam transforming element and said respective at least one image source, said image expander emitting a set of expanded light beams by expanding said incident light beams in an expansion axis substantially perpendicular to a coupling axis along which said at least one output beam transforming element receives said set of coupled light beams, said image expander transmitting said set of expanded light beams to said selected input beam transforming element.

56. The incident image displaying device according to claim 55, wherein said image expander comprises:
a light guide; and
an input beam transforming element incorporated with said light guide, said input beam transforming element receiving said incident light beams, said input beam transforming element producing said set of expanded light beams, by coupling said incident light beams into said light guide as a set of coupled light beams, and decoupling said set of coupled light beams.

57. The incident image displaying device according to claim 55, wherein said image expander comprises:
a housing; and
a plurality of reflective elements located within said housing along said expansion axis, said reflective elements producing said set of expanded light beams, by receiving said incident light beams from a previous reflective element, and by further reflecting said incident light beams.

58. The incident image displaying device according to claim 57, further comprising a moving mechanism coupled with said image expander, said moving mechanism moving said image expander in an oscillating manner along said expansion axis.

59. The incident image displaying device according to claim 57, further comprising a reflector for reflecting said incident light beams toward said reflective elements.

60. The incident image displaying device according to claim 59, further comprising a moving mechanism coupled with said reflector, wherein said moving mechanism moves said reflector in an oscillating manner, along an incident axis at which said reflector receives said incident light beams from said respective image source.

61. The incident image displaying device according to claim 55, wherein said image expander is in form of a reflective element, said incident image displaying device further comprising a moving element coupled with said reflective element, said moving element moving said reflective element in an oscillating manner along said expansion axis, said image expander producing said set of expanded light beams via the oscillating action of said reflective element.

62. The incident image displaying device according to claim 55, wherein said image expander is in form of a reflective element, said incident image displaying device further comprises:
a reflector for reflecting said incident light beams toward said reflective element; and
a moving mechanism coupled with said reflector, said moving mechanism moving said reflector in an oscillating manner along an incident axis at which said reflector receives said incident light beams from said respective image source, said image expander producing said set of expanded light beams via the oscillating action of said reflector.

63. The incident image displaying device according to claim 2, further comprising at least one intermediate beam transforming element incorporated with said respective at least one light guide,
wherein said at least one intermediate beam transforming element is associated with said respective at least one input beam transforming element, and with a respective one of said at least one output beam transforming element,
wherein each of a respective one of said at least one intermediate beam transforming element receives a set of coupled light beams associated with said respective at least one intermediate beam transforming element and with said respective at least one input beam transforming element, and
wherein said respective at least one intermediate beam transforming element spatially transforms said set of coupled light beams into said respective at least one light guide, as another set of coupled light beams.

64. The incident image displaying device according to claim 3, further comprising an opaque shield located behind said at least one light guide, said opaque shield having a substantially dark hue.

65. The incident image displaying device according to claim 1, wherein said scene image reflector is a variable reflector.

66. The incident image displaying device according to claim 5, further comprising a variable transmitter located in front of said at least one light guide,
wherein said variable transmitter varies the intensity of scene image light beams respective of said scene.

67. The incident image displaying device according to any of claims 2, 3, or, further comprising a variable transmitter located in front of said at least one light guide,
wherein said variable transmitter varies the intensity of scene image light beams respective of a scene located behind said at least one light guide.

68. The incident image displaying device according to any of claims 3, 4, or 5, wherein a projected image focal length respective of each output decoupled image of said set of output decoupled images, relative to at least one eye of an observer, is substantially equal to a scene image focal length of a scene image of a scene, relative to said at least one eye, said scene being located behind said at least one light guide.

69. The incident image displaying device according to claim 3, wherein a first output beam transforming element of said output beam transforming elements, is located between an intermediate beam transforming element of said at least one intermediate beam transforming element, and a second output beam transforming element of said output beam transforming elements.

70. The incident image displaying device according to claim 1, wherein every set of said at least one input beam transforming element, said at least one intermediate beam transforming element, and said at least one output beam transforming element, is incorporated with a different one of at least two light guides, thereby forming a set of at least two displaying modules,
wherein each displaying module of said set of at least two displaying modules is located on the top of another displaying module of said set of at least two displaying modules, and
wherein each of said at least one output beam transforming element at least partially overlaps another one of said at least one output beam transforming element, and wherein each of said at least one input beam transforming element transmits said incident light beams to another one of said at least one input beam transforming element.

71. The incident image displaying device according to claim 70, wherein each of said displaying module and said other displaying module is associated with a selected input field of view respective of said respective at least one incident projected image, and
wherein an output field of view respective of each output decoupled image of said set of output decoupled images, is substantially equal to the sum of said selected input field of views.

72. The incident image displaying device according to claim 70, wherein each of said displaying module and said other displaying module is associated with a selected range of wavelengths, and
wherein each output decoupled image of said set of output decoupled images, includes said selected ranges of wavelengths.

73. The incident image displaying device according to claim 5, wherein said first displaying module includes a first set of at least two displaying modules located on the top of one another,
wherein said second displaying module includes a second set of at least two displaying modules located on the top of one another,
wherein each displaying module of said first set is associated with a selected input field of view respective of said respective at least one incident image, and each displaying module of said second set is associated with a selected input field of view respective of said respective at least one incident image,
wherein an output field of view respective of each output decoupled image of said set of output decoupled images, respective of said first displaying module is substantially equal to the sum of said selected input field of views, and
wherein an output field of view respective of each output decoupled image of said set of output decoupled images, respective of said second displaying module is substantially equal to the sum of said selected input field of views.

74. The incident image displaying device according to claim 5, wherein said first displaying module includes a first set of displaying modules located on the top of one another,
wherein said second displaying module includes a second set of displaying modules located on the top of one another,
wherein each displaying module of said first set is associated with a selected range of wavelengths, and each displaying module of said second set is associated with a selected range of wavelengths,
wherein each output decoupled image of said set of output decoupled images, respective of said first displaying module includes said selected ranges of wavelengths, and wherein each output decoupled image of said set of output decoupled images, respective of said second displaying module includes said selected ranges of wavelengths.

75. Method for displaying at least one incident image against a reflected scene image of a scene, the method comprising the procedures of:
coupling a set of light beams respective of said at least one incident image, into a respective one of at least one light guide, thereby forming at least one set of coupled light beams;
decoupling a set of coupled light beams out of said respective at least one light guide, as decoupled light beams, thereby forming a set of output decoupled images, each output decoupled image of said set of output decoupled images, being respective of a sensor fused image and a pupil expanded representation of said at least one incident image; and
reflecting a scene image of said scene, through at least a portion of said respective at least one light guide and at least one output beam transforming element.

76-115. (canceled)
